(19) United States
(12) Patent Application Publication
(10) Pub. No.: US 2010/0311677 A1
(43) Pub. Date: Dec. 9, 2010

(54) Active Ingredient Combinations Having Insecticidal and Acaricidal Properties

(75) Inventors: Reiner Fischer, Monheim (DE); Wolfram Andersch, Bergisch Gladbach (DE); Heike Hungenberg, Langenfeld (DE)

Correspondence Address: STERNE, KESSLER, GOLDSTEIN & FOX P.L.L.C., 1100 NEW YORK AVENUE, N.W., WASHINGTON, DC, 20005, US

(73) Assignee: Bayer CropScience AG, Monheim (DE)

(21) Appl. No.: 12/679,242

(22) PCT Filed: Sep. 9, 2008
(86) PCT No.: PCT/EP2008/007347

§ 371 Date: Mar. 19, 2010

(30) Foreign Application Priority Data
Sep. 21, 2007 (EP) 07116915.5

(51) Int. Cl. A01N 43/16; A01N 43/38; A01N 43/653; A01N 57/28; A01N 57/16; A01N 43/88; A01N 43/40; A01N 43/78; A01N 43/56; A01N 57/14; A01N 43/707; A01N 43/58; A01N 43/68; A01P 7/02; A01P 7/04

(52) U.S. Cl. 514/30; 514/409; 514/383; 514/125; 514/89; 514/137; 514/229.2; 514/357; 514/365; 514/341; 514/336; 514/28; 514/406; 514/223.8; 514/147; 514/242; 514/84; 514/345; 514/342; 514/247; 514/245; 514/407

(57) ABSTRACT

The novel active compound combinations comprising compounds of the formulae (I) and (II) have very good insecticidal and acaricidal properties.

The present invention relates to novel active compound combinations consisting, of known spiroketal-substituted tetramic acid derivatives and, secondly, of further insecticidally active compounds, which combinations are highly suitable for controlling animal pests such as insects and/or unwanted acarides.

For 3-acylpyrrolidine-2,4-diones pharmaceutical properties have been previously described (S. Suzuki et al. Chem. Pharm. Bull. 15 1120 (1967)). Furthermore, N-phenylpyrrolidine-2,4-diones have been synthesized by R. Schmierer and H. Mildenberger (Liebigs Ann. Chem. 1985, 1095). Biological activity of these compounds has not been described.

EP-A-0 262 399 and GB-A-2 266 888 disclose similarly structured compounds (3-arylpyrrolidine-2,4-diones) for which, however, no herbicidal, insecticidal or acaricidal action has been disclosed. Known compounds with herbicidal, insecticidal or acaricidal action are unsubstituted, bicyclic 3-arylpyrrolidine-2,4-dione derivatives (EP-A-355 599, EP-A-415 211 and JP-A-12-053 670) and also substituted monocyclic 3-arylpyrrolidine-2,4-dione derivatives (EP-A-377 893 and EP-A-442 077).

Additionally known are polycyclic 3-arylpyrrolidine-2,4-dione derivatives (EP-A-442 073) and also 1H-arylpyrrolidinedione derivatives (EP-A-456 063, EP-A-521 334, EP-A-596 298, EP-A-613 884, EP-A-613 885, WO 94/01 997, WO 95/26 954, WO 95/20 572, EP-A-0 668 267, WO 96/25 395, WO 96/35 664, WO 97/01 535, WO 97/02 243, WO 97/36 868, WO 97/43275, WO 98/05638, WO 98/06721, WO 98/25928, WO 99/24437, WO 99/43649, WO 99/48869 and WO 99/55673, WO 01/17972, WO 01/23354, WO 01/74770, WO 03/013249, WO 03/062244, WO 2004/007448, WO 2004/024 688, WO 04/065366, WO 04/080962, WO 04/111042, WO 05/044791, WO 05/044796, WO 05/048710, WO 05/049596, WO 05/066125, WO 05/092897, WO 06/000355, WO 06/029799, WO 06/056281, WO 06/056282, WO 06/089633, WO 07/048,545, WO 07/073,856, WO 07/096,058, WO 07/121,868, WO 07/140,881, DE-A-102006050148, DE-A-102006057036, DE-A-102006057037, DE-A-10205059892). Furthermore known are ketal-substituted 1H-arylpyrrolidine-2,4-diones from WO 99/16748 and (spiro)-ketal-substituted N-alkoxyalkoxy-substituted arylpyrrolidinediones from JP-A-14 205 984 and Ito M. et al., Bioscience, Biotechnology and Biochemistry 67, 1230-1238, (2003). The addition of safeners to ketoenols is also known in principle from WO 03/013249. Moreover, WO 06/024411 discloses herbicidal compositions comprising ketoenols.

However, the acaricidal and/or insecticidal activity and/or activity spectrum and/or the plant compatibility of the known compounds, in particular with respect to crop plants, is/are not always satisfactory.

Furthermore known are mixtures of compounds from WO 98/05638 and WO 04/007448 with other insecticides and/or acaricides: WO 01/89300, WO 02/00025, WO 02/05648, WO 02/17715, WO 02/19824, WO 02/30199, WO 02/37963, WO 05/004603, WO 05/053405, WO 06/089665, WO 08/006,514, WO 08/006,516, WO 08/006,512, WO 08/006,515, WO 08/006,513, WO 08/009,379, DE-A-10342673. However, the activity of these mixtures is not always satisfactory.

It has now been found that active compound combinations comprising at least one compound of the formula (I)

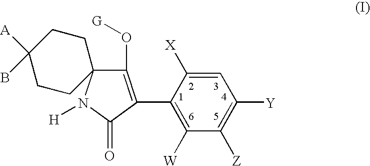

in which
W represents hydrogen, alkyl, alkenyl, alkynyl, halogen, alkoxy, haloalkyl, haloalkoxy or cyano,
X represents halogen, alkyl, alkenyl, alkynyl, alkoxy, haloalkyl, haloalkoxy, nitro or cyano,
Y and Z independently of one another represent hydrogen, alkyl, alkenyl, alkynyl, alkoxy, halogen, haloalkyl, haloalkoxy, cyano or nitro,
A, B and the carbon atom to which they are attached represent five- to seven-membered ketal, thioketal or dithioketal which may optionally be interrupted by a further heteroatom and which is in each case optionally substituted by alkyl, haloalkyl, alkoxy, alkoxyalkyl or optionally substituted phenyl,
G represents hydrogen (a) or represents one of the groups

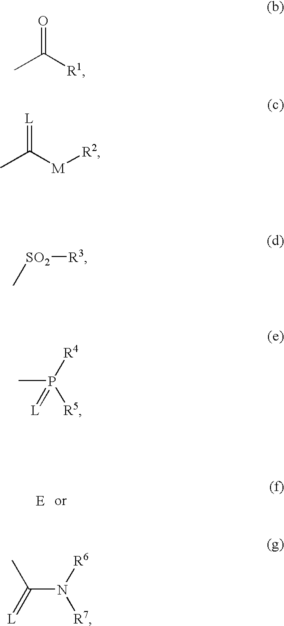

in which
E represents a metal ion or an ammonium ion,
L represents oxygen or sulphur,
M represents oxygen or sulphur,
R¹ represents in each case optionally halogen- or cyano-substituted alkyl, alkenyl, alkoxyalkyl, alkylthioalkyl or polyalkoxyalkyl or represents in each case optionally halogen-, alkyl- or alkoxy-substituted cycloalkyl or heterocyclyl or represents in each case optionally substituted phenyl, phenylalkyl, hetaryl, phenoxyalkyl or hetaryloxyalkyl,
R² represents in each case optionally halogen- or cyano-substituted alkyl, alkenyl, alkoxyalkyl or polyalkoxyalkyl or represents in each case optionally substituted cycloalkyl, phenyl or benzyl,
R³, R⁴ and R⁵ independently of one another represent in each case optionally halogen-substituted alkyl, alkoxy, alkylamino, dialkylamino, alkylthio, alkenylthio or cycloalkylthio or represents in each case optionally substituted phenyl, benzyl, phenoxy or phenylthio,
R⁶ and R⁷ independently of one another represent hydrogen, represent in each case optionally halogen- or cyano-substituted alkyl, cycloalkyl, alkenyl, alkoxy, alkoxyalkyl, represent in each case optionally substituted phenyl or benzyl, or together with the nitrogen atom to which they are attached form an optionally substituted cycle which optionally contains oxygen or sulphur
   and one or more further insecticides and/or acaricides of the formula (II) are highly suitable for controlling animal pests such as insects and/or acarides.

The active compounds of the formula (II) have been classified according to the IRAC Classification (Version 5.3 Jul. 2007) in various classes (1-30) and groups according to their mechanism of action:

### Insecticides/Acaricides/Nematicides:

acetylcholinesterase (AChE) inhibitors H-1
II-1.A carbamates,
   for example alanycarb (II-1.A-1), aldicarb (II-1.A-2), aldoxycarb (II-1.A-3), allyxycarb (II-1.A-4), aminocarb (II-1.A-5), bendiocarb (II-1.A-6), benfuracarb (II-1.A-7), bufencarb (II-1.A-8), butacarb (II-1.A-9), butocarboxim (II-1.A-10), butoxycarboxim (II-1.A-11), carbaryl (II-1.A-12), carbofuran (II-1.A-13), carbosulfan (II-1.A-14), cloethocarb (II-1.A-15), dimetilan (II-1.A-16), ethiofencarb (II-1.A-17), fenobucarb (II-1.A-18), fenothiocarb (II-1.A-19), formetanate (II-1.A-20), furathiocarb (II-1.A-21), isoprocarb (II-1.A-22), metam-sodium (II-1.A-23), methiocarb (II-1.A-24), methomyl (II-1.A-25), metolcarb (II-1.A-26), oxamyl (II-1.A-27), pirimicarb (II-1.A-28), promecarb (II-1.A-29), propoxur (II-1.A-30), thiodicarb (II-1.A-31), thiofanox (II-1.A-32), trimethacarb (II-1.A-33), XMC (II-1.A-34), xylylcarb (II-1.A-35)
II-1.B organophosphates,
   for example acephate (II-1.B-1), azamethiphos (II-1.B-2), azinphos (-methyl, -ethyl) (II-1.B-3), bromophos-ethyl (II-1.B-4), bromfenvinfos (-methyl) (II-1.B-5), butathiofos (II-1.B-6), cadusafos (II-1.B-7), carbophenothion (II-1.B-8), chlorethoxyfos (II-1.B-9), chlorfenvinphos (II-1.B-10), chlormephos (II-1.B-11), chlorpyrifos (-methyl/-ethyl) (II-1.B-12), coumaphos (II-1.B-13), cyanofenphos (II-1.B-14), cyanophos (II-1.B-15), chlorfenvinphos (II-1.B-16), demeton-5-methyl (II-1.B-17), demeton-5-methylsulphone (II-1.B-18), dialifos (II-1.B-19), diazinon (II-1.B-20), dichlofenthion (II-1.B-21), dichlorvos/DDVP (II-1.B-22), dicrotophos (II-1.B-23), dimethoate (II-1.B-24), dimethylvinphos (II-1.B-25), dioxabenzofos (II-1.B-26), disulfoton (II-1.B-27), EPN (II-1.B-28), ethion (II-1.B-29), ethoprophos (II-1.B-30), etrimfos (II-1.B-31), famphur (II-1.B-32), fenamiphos (II-1.B-33), fenitrothion (II-1.B-34), fensulfothion (II-1.B-35), fenthion (II-1.B-36), flupyrazofos (II-1.B-37), fonofos (II-1.B-38), formothion (II-1.B-39), fosmethilan (II-1.B-40), fosthiazate (II-1.B-41), heptenophos (II-1.B-42), iodofenphos (II-1.B-43), iprobenfos isazofos (II-1.B-45), isofenphos (II-1.B-46), isopropyl (II-1.B-47), O-salicylate (II-1.B-48), isoxathion (II-1.B-49), malathion (II-1.B-50), mecarbam (II-1.B-51), methacrifos (II-1.B-52), methamidophos (II-1.B-53), methidathion (II-1.B-54), mevinphos (II-1.B-55), monocrotophos (II-1.B-56), naled omethoate (II-1.B-58), oxydemeton-methyl (II-1.B-59), parathion (-methyl/-ethyl) (II-1.B-60), phenthoate (II-1.B-61), phorate (II-1.B-62), phosalone (II-1.B-63), phosmet (II-1.B-64), phosphamidon (II-1.B-65), phosphocarb (II-1.B-66), phoxim (II-1.B-67), pirimiphos (-methyl/-ethyl) (II-1.B-68), profenofos (II-1.B-69), propaphos (II-1.B-70), propetamphos (II-1.B-71), prothiofos (II-1.B-72), prothoate (II-1.B-73), pyraclofos (II-1.B-74), pyridaphenthion (II-1.B-75), pyridathion (II-1.B-76), quinalphos (II-1.B-77), sebufos (II-1.B-78), sulfotep (II-1.B-79), sulprofos (II-1.B-80), tebupirimfos (II-1.B-81), temephos (II-1.B-82), terbufos (II-1.B-83), tetrachlorvinphos (II-1.B-84), thiometon (II-1.B-85), triazophos (II-1.B-86), triclorfon (II-1.B-87), vamidothion (II-1.B-88)
antagonists of GABA-gated chloride channels II-2
II-2A organochlorines,
   for example camphechlor (II-2A-1), chlordane (II-2A-2), endosulfan (II-2A-3), gamma-HCH (II-2A-4), HCH (II-2A-5), heptachlor (II-2A-6), lindane (II-2A-7), methoxychlor (II-2A-8)
II-2B fiproles (phenylpyrazoles),
   for example acetoprole (II-2B-1), ethiprole (II-2B-2), fipronil (II-2B-3), pyrafluprole (II-2B-4), pyriprole (II-2B-5), vaniliprole (II-2B-6)
sodium channel modulators/blockers of voltage-gated sodium channels II-3
II-3 pyrethroids,
   for example acrinathrin (II-3-1), allethrin (d-cis-trans, d-trans) (II-3-2), beta-cyfluthrin (II-3-3), bifenthrin (II-3-4), bioallethrin (II-3-5), bioallethrin S-cyclopentyl isomer (II-3-6), bioethanomethrin (II-3-7), biopermethrin (II-3-8), bioresmethrin (II-3-9), chlovaporthrin (II-3-10), cis-cypermethrin (II-3-11), cis-resmethrin (II-3-12), cis-permethrin (II-3-13), clocythrin (II-3-14), cycloprothrin (II-3-15), cyfluthrin (II-3-16), cyhalothrin (II-3-17), cypermethrin (alpha-, beta-, theta-, zeta-) (II-3-18), cyphenothrin (II-3-19), deltamethrin (II-3-20), empenthrin (1R isomer) (II-3-21), esfenvalerate (II-3-22), etofenprox (II-3-23), fenfluthrin (II-3-24), fenpropathrin (II-3-25), fenpyrithrin (II-3-26), fenvalerate (II-3-27), flubrocythrinate (II-3-28), flucythrinate (II-3-29), flufenprox (II-3-30), flumethrin (II-3-31), fluvalinate (II-3-32), fubfenprox (II-3-33), gamma-cyhalothrin (II-3-34), imiprothrin (II-3-35), kadethrin (II-3-36), lambda-cyhalothrin (II-3-37), metofluthrin (II-3-38), permethrin (cis-, trans-) (II-3-39), phenothrin (1R-trans isomer) (II-3-40), prallethrin (II-3-41), profluthrin (II-3-42), protrifenbute (II-3-43), pyresmethrin (II-3-44), resmethrin (II-3-45), RU 15525 (II-3-46), silafluofen (II-3-47), tau-fluvalinate (II-3-48), tefluthrin (II-3-49), terallethrin (II-3-50), tetramethrin (−1R isomer) (II-3-51), tralomethrin (II-3-52), transfluthrin (II-3-53), ZXI 8901 (II-3-54), pyrethrin (pyrethrum) (II-3-55), eflusilanate (II-3-56), DDT (II-3-57), methoxychlor (II-3-58),
agonists/antagonists of the nicotinergic acetylcholine receptor II-4
II-4A chloronicotinyls,
   for example acetamiprid (II-4A-1), clothianidin (II-4A-2), dinotefuran (II-4A-3), imidacloprid (II-4A-4), imidaclothiz (II-4A-5), nitenpyram (II-4A-6), nithiazine (II-4A-7), thiacloprid (II-4A-8), thiamethoxam (II-4A-9),

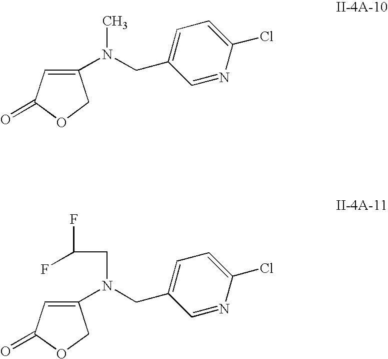

II-4B nicotine (II-4B-1), bensultap (II-4B-2), cartap (II-4B-3), thiosulfap-sodium (II-4B-4), thiocylam (II-4C-4)
allosteric modulators of the acetylcholine receptor (agonists)
II-5 spinosyns,
   for example spinosad (II-5-1), spinetoram (II-5-2)
chloride channel activators
II-6 mectins/macrolides,
   for example abamectin (II-6-1), emamectin (II-6-2), emamectin-benzoate (II-6-3), ivermectin (II-6-4), lepimectin (II-6-5), milbemectin (II-6-6)
II-7A juvenile hormone analogues,
   for example hydroprene (II-7A-1), kinoprene (II-7A-2), methoprene (II-7A-3), epofenonane (II-7A-4), triprene (II-7A-5), fenoxycarb (II-7B-1),
   pyriproxifen (II-7C-1), diofenolan (II-7C-2)
active compounds having unknown or non-specific mechanisms of action
II-8 fumigants,
   for example methylbromide (II-8A-1), chloropicrin (II-8B-1), sulfuryl fluoride (II-8C-1)
II-9 selective antifeedants,
   for example cryolite (II-9A-1), pymetrozine (II-9B-1), NNI0101 (II-9B-2), flonicamid (II-9C-1)
II-10 mite growth inhibitors
   for example clofentezine (II-10A-1), hexythiazox (II-10A-2), etoxazole (II-10B-1)
inhibitors of oxidative phosphorylation, ATP disruptors II-12
II-12A diafenthiuron (II-12A-1)
II-12B organotin compounds,
   for example azocyclotin (II-12B-1), cyhexatin (II-12B-2), fenbutatin oxide (II-12B-3)
II-12C propargite (II-12C-1), tetradifon (II-12C-2)
decouplers of oxidative phosphorylation by interruption of the H-proton gradient II-13
chlorfenapyr (II-13-1)
binapacyrl (II-13-2), dinobuton (II-13-3), dinocap (II-13-4), DNOC (II-13-5)
microbial disruptors of the insect gut membrane
Bacillus thuringiensis strains (II-13-6)
inhibitors of chitin biosynthesis
II-15 benzoylureas,
   for example bistrifluoron (II-15-1), chlorfluazuron (II-15-2), diflubenzuron (II-15-3), fluazuron (II-15-4), flucycloxuron (II-15-5), flufenoxuron (II-15-6), hexaflumuron (II-15-7), lufenuron (II-15-8), novaluron (II-15-9), noviflumuron (II-15-10), penfluoron (II-15-11), teflubenzuron (II-15-12), triflumuron (II-15-13)
II-16 buprofezin (II-16-1)
moulting disruptors cyromazine (II-17-1)
ecdysone agonists/disruptors (II-18)
II-18A diacylhydrazines,
   for example chromafenozide (II-18A-1), halofenozide (II-18A-2), methoxyfenozide (II-18A-3), tebufenozide (II-18A-4), JS-118 (II-18A-5)
   azadirachtin (II-18B-1)
octopaminergic agonists
   for example amitraz (II-19-1)
II-20 site III electron transport inhibitors/site II electron transport inhibitors
   hydramethylnon (II-20A-1)
   acequinocyl (II-20B-1)
   fluacrypyrim (II-20C-1)
   cyflumetofen (II-20D-1), cyenopyrafen (II-20D-2)
electron transport inhibitors
II-21 site I electron transport inhibitors
   from the group of the METI acaricides,
   for example fenazaquin (II-21-1), fenpyroximate (II-21-2), pyrimidifen (II-21-3), pyridaben (II-21-4), tebufenpyrad (II-21-5), tolfenpyrad (II-21-6), rotenone (II-21-7)
II-22 blockers of voltage-gated sodium channels
   for example indoxacarb (II-22A-1)
   for example metaflumizone (BAS 3201) (II-22B-1)
II-23 inhibitors of fatty acid biosynthesis
II-23A tetronic acid derivatives
   for example spirodiclofen (II-23A-1), spiromesifen (II-23A-2)
II-23B tetramic acid derivatives,
   for example spirotetramat (II-23B-1)
II-25 neuronal inhibitors having an unknown mechanism of action
   bifenazate (II-25-1)
ryanodine receptor effectors
II-28 diamides,
   for example flubendiamides (II-28-1),

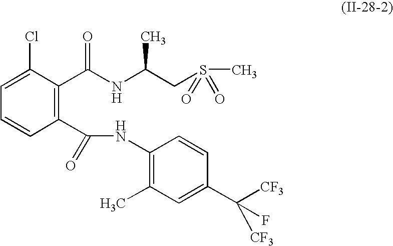

chlorantraniliprole (Rynaxapyr) (II-28-3), Cyazypyr

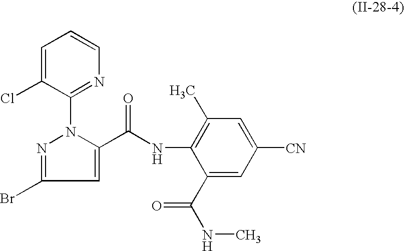

II-29 active compounds having an unknown mechanism of action
   amidoflumet (II-29-1), benclothiaz (II-29-2), benzoximate (II-29-3), bromopropylate (II-29-4), buprofezin (II-29-5), chinomethionat (II-29-6), chlordimeform (II-29-7), chlorobenzilate (II-29-8), clothiazoben (II-29-9), cycloprene (II-29-10), dicofol (II-29-11), dicyclanil (II-29-12), fenoxacrim (II-29-13), fentrifanil (II-29-14), flubenzimine (II-29-15), flufenerim (II-29-16), flutenzin (II-29-17), gossyplure (II-29-18), japonilure (II-29-19), metoxadiazone (II-29-20), petroleum (II-29-21), potassium oleate (II-29-22), pyridalyl (II-29-23), sulfluramid (II-29-24), tetrasul (II-29-25), triarathene (II-29-26), verbutin (II-29-27),

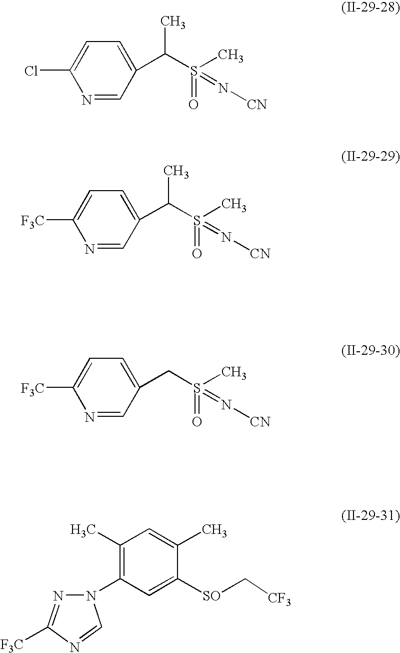

II-30 microbial disruptors of the insect gut membrane
II-30-1 Bacillus thuringiensis strains.

The active compounds referred to in this description by their “common name” are known, for example, from “The Pesticide Manual” 13th Ed., British Crop Protection Council 2003, and the website http://www.alanwood.net/pesticides/.

If, in the context of this description, the short form of the “common name” of an active compound is used, this comprises in each case all customary derivatives, such as the esters and salts, and isomers, in particular optical isomers, especially the commercially available form or forms. If the “common name” refers to an ester or a salt, this in each case also comprises all other customary derivatives, such as other esters and salts, the free acids and neutral compounds, and isomers, in particular optical isomers, especially the commercially available form or forms. The given chemical compound names refer to at least one of the compounds embraced by the “common name”, frequently to a preferred compound.

Depending inter alia on the nature of the substituents, the compounds of the formula (I) may be present as optical isomers or isomer mixtures of varying composition which, if required, can be separated in a customary manner. The present invention provides both the pure isomers and the isomer mixtures, their preparation and use and compositions comprising them. However, for the sake of simplicity, hereinbelow only compounds of the formula (I) are referred to, although what is meant are both the pure compounds and, if appropriate, mixtures having varying proportions of isomeric compounds.

Including the different meanings (a), (b), (c), (d), (e), (f) and (g) of group G, the following principal structures (I-a) to (I-g) result,

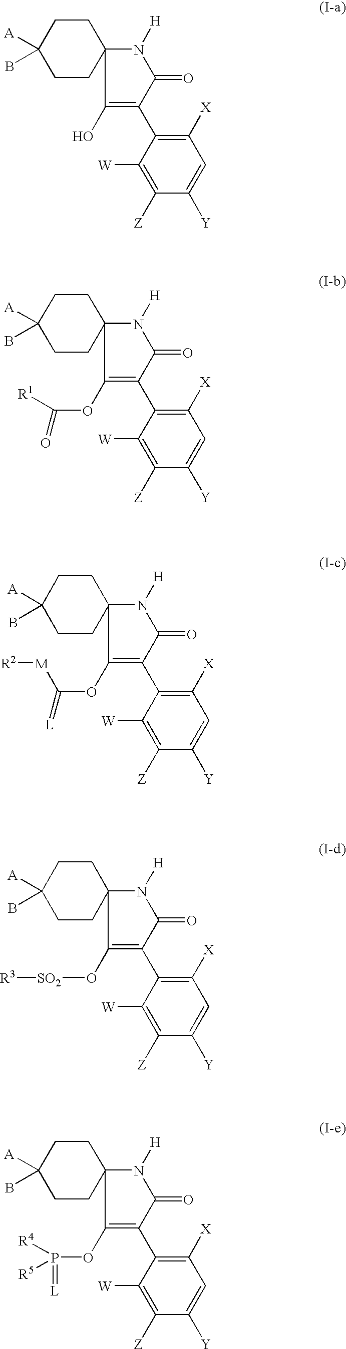

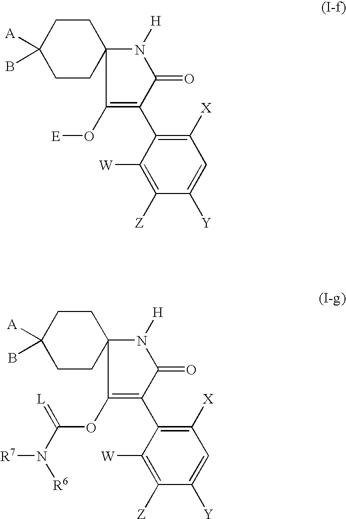

in which
A, B, E, L, M, W, X, Y, Z, R¹, R², R³, R⁴, R⁵, R⁶ and R⁷ have the meanings given above.
W particularly preferably represents hydrogen, chlorine, bromine, C₁-C₄-alkyl, C₁-C₄-alkoxy, C₁-C₂-haloalkyl or C₁-C₂-haloalkoxy,
X particularly preferably represents chlorine, bromine, C₁-C₄-alkyl, C₁-C₄-alkoxy, C₁-C₄-haloalkyl, C₁-C₄-haloalkoxy or cyano,
Y and Z particularly preferably independently of one another represent hydrogen, fluorine, chlorine, bromine, C₁-C₄-alkyl, C₁-C₆-alkoxy, C₁-C₄-haloalkyl, C₁-C₄-haloalkoxy or cyano,
A and B and the carbon atom to which they are attached particularly preferably represent a five-, six- or seven-membered ketal which may optionally be interrupted by a further oxygen atom and which is optionally mono- to trisubstituted by C₁-C₄-alkyl, C₁-C₃-haloalkyl, C₁-C₄-alkoxy or C₁-C₄-alkoxy-C₁-C₂-alkyl,
G particularly preferably represents hydrogen (a) or represents one of the groups

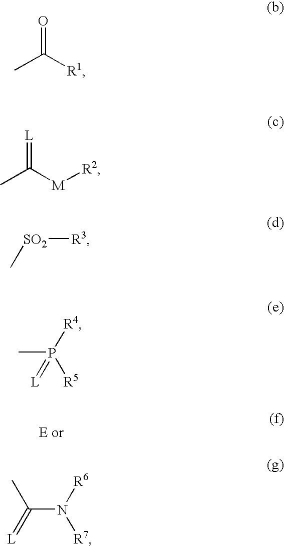

in which
E represents a metal ion or an ammonium ion,
L represents oxygen or sulphur and
M represents oxygen or sulphur,
R¹ particularly preferably represents C₁-C₁₆-alkyl, C₂-C₁₆-alkenyl, C₁-C₆-alkoxy-C₁-C₄-alkyl, C₁-C₆-alkylthio-C₁-C₄-alkyl or poly-C₁-C₆-alkoxy-C₁-C₄-alkyl, each of which is optionally mono- to trisubstituted by fluorine or chlorine, or represents C₃-C₂-cycloalkyl in which optionally one or two not directly adjacent methylene groups are replaced by oxygen and/or sulphur and which is optionally mono- or disubstituted by fluorine, chlorine, C₁-C₅-alkyl or C₁-C₅-alkoxy,
   represents phenyl which is optionally mono- to trisubstituted by fluorine, chlorine, bromine, cyano, nitro, C₁-C₄-alkyl, C₁-C₄-alkoxy, C₁-C₃-haloalkyl, C₁-C₃-haloalkoxy, C₁-C₄-alkylthio or C₁-C₄-alkylsulphonyl,
   represents phenyl-C₁-C₄-alkyl which is optionally mono- or disubstituted by fluorine, chlorine, bromine, C₁-C₄-alkyl, C₁-C₄-alkoxy, C₁-C₃-haloalkyl or C₁-C₃-haloalkoxy,
   represents pyrazolyl, thiazolyl, pyridyl, pyrimidyl, furanyl or thienyl, each of which is optionally mono- or disubstituted by fluorine, chlorine, bromine or C₁-C₄-alkyl,
   represents phenoxy-C₁-C₅-alkyl which is optionally mono- or disubstituted by fluorine, chlorine, bromine or C₁-C₄-alkyl or
   represents pyridyloxy-C₁-C₅-alkyl, pyrimidyloxy-C₁-C₅-alkyl or thiazolyloxy-C₁-C₅-alkyl, each of which is optionally mono- or disubstituted by fluorine, chlorine, bromine, amino or C₁-C₄-alkyl,
R² particularly preferably represents C₁-C₁₆-alkyl, C₂-C₁₆-alkenyl, C₁-C₆-alkoxy-C₂-C₆-alkyl or poly-C₁-C₆-alkoxy-C₂-C₆-alkyl, each of which is optionally mono- to trisubstituted by fluorine or chlorine,
   represents C₃-C₇-cycloalkyl which is optionally mono- or disubstituted by fluorine, chlorine, C₁-C₄-alkyl or C₁-C₄-alkoxy or
   represents phenyl or benzyl, each of which is optionally mono- to trisubstituted by fluorine, chlorine, bromine, cyano, nitro, C₁-C₄-alkyl, C₁-C₃-alkoxy, C₁-C₃-haloalkyl or C₁-C₃-haloalkoxy,
R³ particularly preferably represents C₁-C₆-alkyl which is optionally mono- to trisubstituted by fluorine or chlorine or represents phenyl or benzyl, each of which is optionally mono- or disubstituted by fluorine, chlorine, bromine, C₁-C₄-alkyl, C₁-C₄-alkoxy, C₁-C₂-haloalkoxy, C₁-C₂-haloalkyl cyano or nitro,
R⁴ and R⁵ independently of one another particularly preferably represent C₁-C₆-alkyl, C₁-C₆-alkoxy, C₁-C₆-alkylamino, di-(C₁-C₆-alkyl)amino, C₁-C₆-alkylthio or C₃-C₄-alkenylthio, each of which is optionally mono- to trisubstituted by fluorine or chlorine, or represent phenyl, phenoxy or phenylthio, each of which is optionally mono- or disubstituted by fluorine, chlorine, bromine, nitro, cyano, C₁-C₃-alkoxy, C₁-C₃-haloalkoxy, C₁-C₃-alkylthio, C₁-C₃-haloalkylthio, C₁-C₃-alkyl or C₁-C₃-haloalkyl,
R⁶ and R⁷ independently of one another particularly preferably represent hydrogen, represent C₁-C₆-alkyl, C₃-C₆-cycloalkyl, C₁-C₆-alkoxy, C₃-C₆-alkenyl or C₁-C₆-alkoxy-C₂-C₆-alkyl, each of which is optionally mono- to trisubstituted by fluorine or chlorine, represent phenyl or benzyl, each of which is optionally mono- to trisubstituted by fluorine, chlorine, bromine, C₁-C₅-haloalkyl, C₁-C₅-alkyl or C₁-C₅-alkoxy or together represent a C₃-C₆-alkylene radical in which optionally one methylene group is replaced by oxygen or sulphur and which is optionally substituted by C₁-C₄-alkyl.

In the radical definitions mentioned as being particularly preferred, halogen represents fluorine, chlorine and bromine, in particular fluorine and chlorine.
W very particularly preferably represents hydrogen, chlorine, bromine, methyl, ethyl, methoxy, ethoxy or trifluoromethyl,
X very particularly preferably represents chlorine, bromine, methyl, ethyl, methoxy, ethoxy, trifluoromethyl, difluoromethoxy, trifluoromethoxy or cyano,
Y and Z very particularly preferably independently of one another represent hydrogen, fluorine, chlorine, bromine, methyl, ethyl, methoxy, trifluoromethyl, trifluoromethoxy or cyano,
A and B and the carbon atom to which they are attached very particularly preferably represent a five- or six-membered ketal which is optionally mono- or disubstituted by methyl, ethyl, propyl, trifluoromethyl, monochloromethyl, methoxy, ethoxy, methoxymethyl or ethoxymethyl,
G very particularly preferably represents hydrogen (a) or represents one of the groups

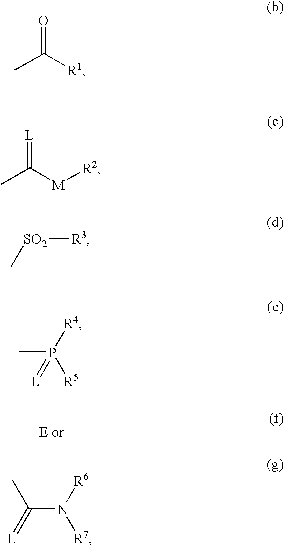

in which
E represents a metal ion or an ammonium ion,
L represents oxygen or sulphur and
M represents oxygen or sulphur,
R¹ very particularly preferably represents C₁-C₁₀-alkyl, C₇-C₁₀-alkenyl, C₁-C₄-alkoxy-C₁-C₂-alkyl, C₁-C₄-alkylthio-C₁-C₂-alkyl, each of which is optionally mono- to trisubstituted by fluorine or chlorine, or represents C₃-C₆-cycloalkyl which is optionally monosubstituted by fluorine, chlorine, methyl, ethyl or methoxy,
   represents phenyl which is optionally mono- or disubstituted by fluorine, chlorine, bromine, cyano, nitro, methyl, ethyl, n-propyl, isopropyl, methoxy, ethoxy, trifluoromethyl or trifluoromethoxy,
   represents furanyl, thienyl or pyridyl, each of which is optionally monosubstituted by chlorine, bromine or methyl,
R² very particularly preferably represents C₁-C₁₀-alkyl, C₂-C₁₀-alkenyl or C₁-C₄-alkoxy-C₂-C₄-alkyl, each of which is optionally mono- to trisubstituted by fluorine or chlorine,
   represents cyclopentyl or cyclohexyl
   or represents phenyl or benzyl, each of which is optionally mono- or disubstituted by fluorine, chlorine, cyano, nitro, methyl, ethyl, methoxy, trifluoromethyl or trifluoromethoxy,
R³ very particularly preferably represents methyl, ethyl, propyl or isopropyl, each of which is optionally mono- to trisubstituted by fluorine or chlorine, or represents phenyl which is optionally monosubstituted by fluorine, chlorine, bromine, methyl, ethyl, isopropyl, tert-butyl, methoxy, ethoxy, isopropoxy, trifluoromethyl, trifluoromethoxy, cyano or nitro,
R⁴ and R⁵ independently of one another very particularly preferably represent C₁-C₄-alkoxy or C₁-C₄-alkylthio or represent phenyl, phenoxy or phenylthio, each of which is optionally monosubstituted by fluorine, chlorine, bromine, nitro, cyano, methyl, methoxy, trifluoromethyl or trifluoromethoxy,
R⁶ and R⁷ independently of one another very particularly preferably represent hydrogen, represent C₁-C₄-alkyl, C₃-C₆-cycloalkyl, C₁-C₄-alkoxy, C₃-C₄-alkenyl or C₁-C₄-alkoxy-C₂-C₄-alkyl, represent phenyl which is optionally mono- or disubstituted by fluorine, chlorine, bromine, methyl, methoxy or trifluoromethyl, or together represent a C₅-C₆-alkylene radical in which optionally one methylene group is replaced by oxygen or sulphur.
W especially preferably represents hydrogen, chlorine, bromine, methyl, ethyl or methoxy,
X especially preferably represents chlorine, bromine, methyl, ethyl or methoxy,
Y and Z especially preferably independently of one another represent hydrogen, chlorine, bromine or methyl,
A and B and the carbon atom to which they are attached especially preferably represent a five- or six-membered ketal which is optionally mono- or disubstituted by methyl, ethyl, propyl, monochloromethyl or methoxymethyl,
G especially preferably represents hydrogen (a) or represents one of the groups

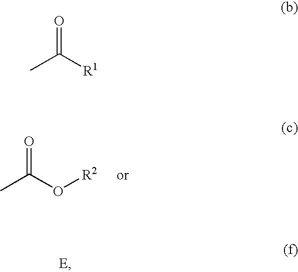

R¹ especially preferably represents C₁-C₁₀-alkyl, C₁-C₄-alkoxy-C₁-C₂-alkyl, C₃-C₆-cycloalkyl,
   represents phenyl which is optionally monosubstituted by chlorine, or represents thienyl,
R² especially preferably represents C₁-C₁₀-alkyl, C₂-C₁₀-alkenyl, or represents benzyl.

The general or preferred radical definitions or illustrations given above can be combined with one another as desired, i.e. including combinations between the respective ranges and preferred ranges.

Preference according to the invention is given to the compounds of the formula (I) which contain a combination of the meanings listed above as being preferred (preferable).

Particular preference according to the invention is given to the compounds of the formula (I) which contain a combination of the meanings listed above as being particularly preferred.

Very particularly preference according to the invention is given to the compounds of the formula (I) which contain a combination of the meanings listed above as being very particularly preferred.

Special preference according to the invention is given to the compounds of the formula (I) which contain a combination of the meanings listed above as being especially preferred.

Emphasis is given to compounds of the formula (I) in which G represents hydrogen.

In the case of the compounds of the formula (I), the phenyl ring is with emphasis trisubstituted, resulting in the following substitution patterns: 2,4,6-; 2,4,5- or 2,5,6-substitution. Moreover, in the case of the compounds of the formula (I) the phenyl ring is with emphasis tetrasubstituted, resulting in the following substitution pattern: 2,4,5,6-substitution. In the case of the compounds of the formula (I), the phenyl ring is with emphasis also disubstituted (2,4-; 2,5-position). In the case of the compounds of the formula (I), the phenyl ring is with emphasis also monosubstituted (ortho position). The other substituents W, X, Y, Z, G, A and B have the definitions mentioned in the text.

Saturated or unsaturated hydrocarbon radicals, such as alkyl, alkanediyl or alkenyl, may, as far as this is possible, in each case be straight-chain or branched, including in combination with heteroatoms, such as, for example, in alkoxy.

Optionally substituted radicals may, unless indicated otherwise, be mono- or polysubstituted, where in the case of polysubstitution the substituents may be identical or different.

Most preference is given to the compounds of the formula (I) where G=hydrogen

(I-a)

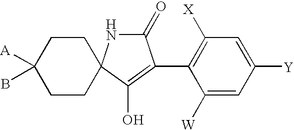

| | | | | | | |
|---|---|---|---|---|---|---|
| | | | | | | Known from |
| | | | | | | WO 06/089633; |
| Ex. No. | W | X | Y | A | B | Ex. No. |

| | | | | | |
|---|---|---|---|---|---|
| I-1 | CH₃ | CH₃ | CH₃ | —O—(CH₂)₂—O— | I-1-a-2 |
| I-2 | CH₃ | CH₃ | Cl | —O—(CH₂)₂—O— | I-1-a-4 |
| I-3 | CH₃ | CH₃ | Br | —O—(CH₂)₂—O— | I-1-a-26 |
| I-4 | CH₃ | CH₃ | CH₃ | —O—(CH₂)₃—O— | I-1-a-18 |
| I-5 | CH₃ | CH₃ | Cl | —O—(CH₂)₃—O— | I-1-a-14 |
| I-6 | CH₃ | CH₃ | Br | —O—(CH₂)₃—O— | I-1-a-19 |

Surprisingly, the insecticidal/acaricidal activity of the active compound compositions according to the invention is substantially higher than the sum of the activities of the individual active compounds. An unforeseeable true synergistic effect is present, and not just an addition of activities.

Preference is given to active compound combinations comprising at least one compound of the formulae (I-1) to (I-6) and at least one active compound of the formula (II).

Of particular interest are the following combinations:

I-1 + II-1A-1
I-1 + II-1A-2
I-1 + II-1A-3
I-1 + II-1A-4
I-1 + II-1A-5
I-1 + II-1A-6
I-1 + II-1A-7
I-1 + II-1A-8
I-1 + II-1A-9
I-1 + II-1A-10
I-1 + II-1A-11
I-1 + II-1A-12
I-1 + II-1A-13
I-1 + II-1A-14
I-1 + II-1A-15
I-1 + II-1A-16
I-1 + II-1A-17
I-1 + II-1A-18
I-1 + II-1A-19
I-1 + II-1A-20
I-1 + II-1A-21
I-1 + II-1A-22
I-1 + II-1A-23
I-1 + II-1A-24
I-1 + II-1A-25
I-1 + II-1A-26
I-1 + II-1A-27
I-1 + II-1A-28
I-1 + II-1A-29
I-1 + II-1A-30
I-1 + II-1A-31
I-1 + II-1A-32
I-1 + II-1A-33
I-1 + II-1A-34
I-1 + II-1A-35
I-1 + II-1B-1
I-1 + II-1B-2
I-1 + II-1B-3
I-1 + II-1B-4
I-1 + II-1B-5
I-1 + II-1B-6
I-1 + II-1B-7
I-1 + II-1B-8
I-1 + II-1B-9
I-1 + II-1B-10
I-1 + II-1B-11
I-1 + II-1B-12
I-1 + II-1B-13
I-1 + II-1B-14
I-1 + II-1B-15
I-1 + II-1B-16
I-1 + II-1B-17
I-1 + II-1B-18
I-1 + II-1B-19
I-1 + II-1B-20
I-1 + II-1B-21
I-1 + II-1B-22
I-1 + II-1B-23
I-1 + II-1B-24
I-1 + II-1B-25
I-1 + II-1B-26
I-1 + II-1B-27
I-1 + II-1B-28
I-1 + II-1B-29
I-1 + II-1B-30
I-1 + II-1B-31
I-1 + II-1B-32
I-1 + II-1B-33
I-1 + II-1B-34
I-1 + II-1B-35
I-1 + II-1B-36
I-1 + II-1B-37
I-1 + II-1B-38
I-1 + II-1B-39
I-1 + II-1B-40
I-1 + II-1B-41
I-1 + II-1B-42
I-1 + II-1B-43
I-1 + II-1B-44
I-1 + II-1B-45
I-1 + II-1B-46
I-1 + II-1B-47
I-1 + II-1B-48
I-1 + II-1B-49
I-1 + II-1B-50
I-1 + II-1B-51
I-1 + II-1B-52
I-1 + II-1B-53
I-1 + II-1B-54
I-1 + II-1B-55
I-1 + II-1B-56
I-1 + II-1B-57
I-1 + II-1B-58
I-1 + II-1B-59
I-1 + II-1B-60
I-1 + II-1B-61
I-1 + II-1B-62
I-1 + II-1B-63
I-1 + II-1B-64
I-1 + II-1B-65
I-1 + II-1B-66
I-1 + II-1B-67
I-1 + II-1B-68
I-1 + II-1B-69
I-1 + II-1B-70
I-1 + II-1B-71
I-1 + II-1B-72
I-1 + II-1B-73
I-1 + II-1B-74
I-1 + II-1B-75
I-1 + II-1B-76
I-1 + II-1B-77
I-1 + II-1B-78
I-1 + II-1B-79
I-1 + II-1B-80
I-1 + II-1B-81
I-1 + II-1B-82
I-1 + II-1B-83
I-1 + II-1B-84
I-1 + II-1B-85
I-1 + II-1B-86
I-1 + II-1B-87
I-1 + II-1B-88
I-1 + II-2A-1
I-1 + II-2A-2
I-1 + II-2A-3
I-1 + II-2A-4
I-1 + II-2A-5
I-1 + II-2A-6
I-1 + II-2A-7
I-1 + II-2A-8
I-1 + II-2B-1
I-1 + II-2B-2
I-1 + II-2B-3
I-1 + II-2B-4
I-1 + II-2B-5
I-1 + II-2B-6
I-1 + II-3-1
I-1 + II-3-2
I-1 + II-3-3
I-1 + II-3-4
I-1 + II-3-5
I-1 + II-3-6
I-1 + II-3-7
I-1 + II-3-8
I-1 + II-3-9
I-1 + II-3-10
I-1 + II-3-11
I-1 + II-3-12
I-1 + II-3-13
I-1 + II-3-14
I-1 + II-3-15
I-1 + II-3-16
I-1 + II-3-17
I-1 + II-3-18
I-1 + II-3-19
I-1 + II-3-20
I-1 + II-3-21
I-1 + II-3-22
I-1 + II-3-23
I-1 + II-3-24
I-1 + II-3-25
I-1 + II-3-26
I-1 + II-3-27
I-1 + II-3-28
I-1 + II-3-29
I-1 + II-3-30
I-1 + II-3-31
I-1 + II-3-32
I-1 + II-3-33
I-1 + II-3-34
I-1 + II-3-35
I-1 + II-3-36
I-1 + II-3-37
I-1 + II-3-38
I-1 + II-3-39
I-1 + II-3-40
I-1 + II-3-41
I-1 + II-3-42
I-1 + II-3-43
I-1 + II-3-44
I-1 + II-3-45
I-1 + II-3-46
I-1 + II-3-47
I-1 + II-3-48
I-1 + II-3-49
I-1 + II-3-50
I-1 + II-3-51
I-1 + II-3-52
I-1 + II-3-53
I-1 + II-3-54
I-1 + II-3-55
I-1 + II-3-56
I-1 + II-3-57
I-1 + II-3-58
I-1 + II-4A-1
I-1 + II-4A-2
I-1 + II-4A-3
I-1 + II-4A-4
I-1 + II-4A-5
I-1 + II-4A-6
I-1 + II-4A-7
I-1 + II-4A-8
I-1 + II-4A-9
I-1 + II-4A-10
I-1 + II-4A-11
I-1 + II-4B-1
I-1 + II-4B-2
I-1 + II-4B-3
I-1 + II-4B-4
I-1 + II-4C-4
I-1 + II-5-1
I-1 + II-5-2
I-1 + II-6-1
I-1 + II-6-2
I-1 + II-6-3
I-1 + II-6-4
I-1 + II-6-5
I-1 + II-6-6
I-1 + II-7A-1
I-1 + II-7A-2
I-1 + II-7A-3
I-1 + II-7A-4
I-1 + II-7A-5
I-1 + II-7B-1
I-1 + II-7C-1
I-1 + II-7C-2
I-1 + II-8A-1
I-1 + II-8B-1
I-1 + II-8C-1
I-1 + II-9A-1
I-1 + II-9B-1
I-1 + II-9B-2
I-1 + II-9C-1
I-1 + II-10A-1
I-1 + II-10A-2
I-1 + II-10B-1
I-1 + II-12A-1
I-1 + II-12B-1
I-1 + II-12B-2
I-1 + II-12B-3
I-1 + II-12C-1
I-1 + II-12C-2
I-1 + II-13-1
I-1 + II-13-2
I-1 + II-13-3
I-1 + II-13-4
I-1 + II-13-5
I-1 + II-13-6
I-1 + II-15-1
I-1 + II-15-2
I-1 + II-15-3
I-1 + II-15-4
I-1 + II-15-5
I-1 + II-15-6
I-1 + II-15-7
I-1 + II-15-8
I-1 + II-15-9
I-1 + II-15-10
I-1 + II-15-11
I-1 + II-15-12
I-1 + II-15-13
I-1 + II-16-1
I-1 + II-17-1
I-1 + II-18A-1
I-1 + II-18A-2
I-1 + II-18A-3
I-1 + II-18A-4
I-1 + II-18A-5
I-1 + II-18B-1
I-1 + II-19-1
I-1 + II-20A-1
I-1 + II-20B-1
I-1 + II-20C-1
I-1 + II-20D-1
I-1 + II-20D-2
I-1 + II-21-1
I-1 + II-21-2
I-1 + II-21-3
I-1 + II-21-4
I-1 + II-21-5
I-1 + II-21-6
I-1 + II-21-7
I-1 + II-22A-1
I-1 + II-22B-1
I-1 + II-23A-1
I-1 + II-23A-2
I-1 + II-23B-1
I-1 + II-25-1
I-1 + II-28-1
I-1 + II-28-2
I-1 + II-28-3
I-1 + II-28-4
I-1 + II-29-1
I-1 + II-29-2
I-1 + II-29-3
I-1 + II-29-4
I-1 + II-29-5
I-1 + II-29-6
I-1 + II-29-7
I-1 + II-29-8
I-1 + II-29-9
I-1 + II-29-10
I-1 + II-29-11
I-1 + II-29-12
I-1 + II-29-13
I-1 + II-29-14
I-1 + II-29-15
I-1 + II-29-16
I-1 + II-29-17
I-1 + II-29-18
I-1 + II-29-19
I-1 + II-29-20
I-1 + II-29-21
I-1 + II-29-22
I-1 + II-29-23
I-1 + II-29-24
I-1 + II-29-25
I-1 + II-29-26
I-1 + II-29-27
I-1 + II-29-28
I-1 + II-29-29
I-1 + II-29-30
I-1 + II-29-31
I-1 + II-30-1
I-2 + II-1A-1
I-2 + II-1A-2
I-2 + II-1A-3
I-2 + II-1A-4
I-2 + II-1A-5
I-2 + II-1A-6
I-2 + II-1A-7
I-2 + II-1A-8
I-2 + II-1A-9
I-2 + II-1A-10
I-2 + II-1A-11
I-2 + II-1A-12
I-2 + II-1A-13
I-2 + II-1A-14
I-2 + II-1A-15
I-2 + II-1A-16
I-2 + II-1A-17
I-2 + II-1A-18
I-2 + II-1A-19
I-2 + II-1A-20
I-2 + II-1A-21
I-2 + II-1A-22
I-2 + II-1A-23
I-2 + II-1A-24
I-2 + II-1A-25
I-2 + II-1A-26
I-2 + II-1A-27
I-2 + II-1A-28
I-2 + II-1A-29
I-2 + II-1A-30
I-2 + II-1A-31
I-2 + II-1A-32
I-2 + II-1A-33
I-2 + II-1A-34
I-2 + II-1A-35
I-2 + II-1B-1
I-2 + II-1B-2
I-2 + II-1B-3
I-2 + II-1B-4
I-2 + II-1B-5
I-2 + II-1B-6
I-2 + II-1B-7
I-2 + II-1B-8
I-2 + II-1B-9
I-2 + II-1B-10
I-2 + II-1B-11
I-2 + II-1B-12
I-2 + II-1B-13
I-2 + II-1B-14
I-2 + II-1B-15
I-2 + II-1B-16
I-2 + II-1B-17
I-2 + II-1B-18
I-2 + II-1B-19
I-2 + II-1B-20
I-2 + II-1B-21
I-2 + II-1B-22
I-2 + II-1B-23
I-2 + II-1B-24
I-2 + II-1B-25
I-2 + II-1B-26
I-2 + II-1B-27
I-2 + II-1B-28
I-2 + II-1B-29
I-2 + II-1B-30
I-2 + II-1B-31
I-2 + II-1B-32
I-2 + II-1B-33
I-2 + II-1B-34
I-2 + II-1B-35
I-2 + II-1B-36
I-2 + II-1B-37
I-2 + II-1B-38
I-2 + II-1B-39
I-2 + II-1B-40
I-2 + II-1B-41
I-2 + II-1B-42
I-2 + II-1B-43
I-2 + II-1B-44
I-2 + II-1B-45
I-2 + II-1B-46
I-2 + II-1B-47
I-2 + II-1B-48
I-2 + II-1B-49
I-2 + II-1B-50
I-2 + II-1B-51
I-2 + II-1B-52
I-2 + II-1B-53
I-2 + II-1B-54
I-2 + II-1B-55
I-2 + II-1B-56
I-2 + II-1B-57
I-2 + II-1B-58
I-2 + II-1B-59
I-2 + II-1B-60
I-2 + II-1B-61
I-2 + II-1B-62
I-2 + II-1B-63
I-2 + II-1B-64
I-2 + II-1B-65
I-2 + II-1B-66
I-2 + II-1B-67
I-2 + II-1B-68
I-2 + II-1B-69
I-2 + II-1B-70
I-2 + II-1B-71
I-2 + II-1B-72
I-2 + II-1B-73
I-2 + II-1B-74
I-2 + II-1B-75
I-2 + II-1B-76
I-2 + II-1B-77
I-2 + II-1B-78
I-2 + II-1B-79
I-2 + II-1B-80
I-2 + II-1B-81
I-2 + II-1B-82
I-2 + II-1B-83
I-2 + II-1B-84
I-2 + II-1B-85
I-2 + II-1B-86
I-2 + II-1B-87
I-2 + II-1B-88
I-2 + II-2A-1
I-2 + II-2A-2
I-2 + II-2A-3
I-2 + II-2A-4
I-2 + II-2A-5
I-2 + II-2A-6
I-2 + II-2A-7
I-2 + II-2A-8
I-2 + II-2B-1
I-2 + II-2B-2
I-2 + II-2B-3
I-2 + II-2B-4
I-2 + II-2B-5
I-2 + II-2B-6
I-2 + II-3-1
I-2 + II-3-2
I-2 + II-3-3
I-2 + II-3-4
I-2 + II-3-5
I-2 + II-3-6
I-2 + II-3-7
I-2 + II-3-8
I-2 + II-3-9
I-2 + II-3-10
I-2 + II-3-11
I-2 + II-3-12
I-2 + II-3-13
I-2 + II-3-14
I-2 + II-3-15
I-2 + II-3-16
I-2 + II-3-17
I-2 + II-3-18
I-2 + II-3-19
I-2 + II-3-20
I-2 + II-3-21
I-2 + II-3-22
I-2 + II-3-23
I-2 + II-3-24
I-2 + II-3-25
I-2 + II-3-26
I-2 + II-3-27
I-2 + II-3-28
I-2 + II-3-29
I-2 + II-3-30
I-2 + II-3-31
I-2 + II-3-32
I-2 + II-3-33
I-2 + II-3-34
I-2 + II-3-35
I-2 + II-3-36
I-2 + II-3-37
I-2 + II-3-38
I-2 + II-3-39
I-2 + II-3-40
I-2 + II-3-41
I-2 + II-3-42
I-2 + II-3-43
I-2 + II-3-44
I-2 + II-3-45
I-2 + II-3-46
I-2 + II-3-47
I-2 + II-3-48
I-2 + II-3-49
I-2 + II-3-50
I-2 + II-3-51
I-2 + II-3-52
I-2 + II-3-53
I-2 + II-3-54
I-2 + II-3-55
I-2 + II-3-56
I-2 + II-3-57
I-2 + II-3-58
I-2 + II-4A-1
I-2 + II-4A-2
I-2 + II-4A-3
I-2 + II-4A-4
I-2 + II-4A-5
I-2 + II-4A-6
I-2 + II-4A-7
I-2 + II-4A-8
I-2 + II-4A-9
I-2 + II-4A-10
I-2 + II-4A-11
I-2 + II-4B-1
I-2 + II-4B-2
I-2 + II-4B-3
I-2 + II-4B-4
I-2 + II-4C-4
I-2 + II-5-1
I-2 + II-5-2
I-2 + II-6-1
I-2 + II-6-2
I-2 + II-6-3
I-2 + II-6-4
I-2 + II-6-5
I-2 + II-6-6
I-2 + II-7A-1
I-2 + II-7A-2
I-2 + II-7A-3
I-2 + II-7A-4
I-2 + II-7A-5
I-2 + II-7B-1
I-2 + II-7C-1
I-2 + II-7C-2
I-2 + II-8A-1
I-2 + II-8B-1
I-2 + II-8C-1
I-2 + II-9A-1
I-2 + II-9B-1
I-2 + II-9B-2
I-2 + II-9C-1
I-2 + II-10A-1
I-2 + II-10A-2
I-2 + II-10B-1
I-2 + II-12A-1
I-2 + II-12B-1
I-2 + II-12B-2
I-2 + II-12B-3
I-2 + II-12C-1
I-2 + II-12C-2
I-2 + II-13-1
I-2 + II-13-2
I-2 + II-13-3
I-2 + II-13-4
I-2 + II-13-5
I-2 + II-13-6
I-2 + II-15-1
I-2 + II-15-2
I-2 + II-15-3
I-2 + II-15-4
I-2 + II-15-5
I-2 + II-15-6
I-2 + II-15-7
I-2 + II-15-8
I-2 + II-15-9
I-2 + II-15-10
I-2 + II-15-11
I-2 + II-15-12
I-2 + II-15-13
I-2 + II-16-1
I-2 + II-17-1
I-2 + II-18A-1
I-2 + II-18A-2
I-2 + II-18A-3
I-2 + II-18A-4
I-2 + II-18A-5
I-2 + II-18B-1
I-2 + II-19-1
I-2 + II-20A-1
I-2 + II-20B-1
I-2 + II-20C-1
I-2 + II-20D-1
I-2 + II-20D-2
I-2 + II-21-1
I-2 + II-21-2
I-2 + II-21-3
I-2 + II-21-4
I-2 + II-21-5
I-2 + II-21-6
I-2 + II-21-7
I-2 + II-22A-1
I-2 + II-22B-1
I-2 + II-23A-1
I-2 + II-23A-2
I-2 + II-23B-1
I-2 + II-25-1
I-2 + II-28-1
I-2 + II-28-2
I-2 + II-28-3
I-2 + II-28-4
I-2 + II-29-1
I-2 + II-29-2
I-2 + II-29-3
I-2 + II-29-4
I-2 + II-29-5
I-2 + II-29-6
I-2 + II-29-7
I-2 + II-29-8
I-2 + II-29-9
I-2 + II-29-10
I-2 + II-29-11
I-2 + II-29-12
I-2 + II-29-13
I-2 + II-29-14
I-2 + II-29-15
I-2 + II-29-16
I-2 + II-29-17
I-2 + II-29-18
I-2 + II-29-19
I-2 + II-29-20
I-2 + II-29-21
I-2 + II-29-22
I-2 + II-29-23
I-2 + II-29-24
I-2 + II-29-25
I-2 + II-29-26
I-2 + II-29-27
I-2 + II-29-28
I-2 + II-29-29
I-2 + II-29-30
I-2 + II-29-31
I-2 + II-30-1
I-3 + II-1A-1
I-3 + II-1A-2
I-3 + II-1A-3
I-3 + II-1A-4
I-3 + II-1A-5
I-3 + II-1A-6
I-3 + II-1A-7
I-3 + II-1A-8
I-3 + II-1A-9
I-3 + II-1A-10
I-3 + II-1A-11
I-3 + II-1A-12
I-3 + II-1A-13
I-3 + II-1A-14
I-3 + II-1A-15
I-3 + II-1A-16
I-3 + II-1A-17
I-3 + II-1A-18
I-3 + II-1A-19
I-3 + II-1A-20
I-3 + II-1A-21
I-3 + II-1A-22
I-3 + II-1A-23
I-3 + II-1A-24
I-3 + II-1A-25
I-3 + II-1A-26
I-3 + II-1A-27
I-3 + II-1A-28
I-3 + II-1A-29
I-3 + II-1A-30
I-3 + II-1A-31
I-3 + II-1A-32
I-3 + II-1A-33
I-3 + II-1A-34
I-3 + II-1A-35
I-3 + II-1B-1
I-3 + II-1B-2
I-3 + II-1B-3
I-3 + II-1B-4
I-3 + II-1B-5
I-3 + II-1B-6
I-3 + II-1B-7
I-3 + II-1B-8
I-3 + II-1B-9
I-3 + II-1B-10
I-3 + II-1B-11
I-3 + II-1B-12
I-3 + II-1B-13
I-3 + II-1B-14
I-3 + II-1B-15
I-3 + II-1B-16
I-3 + II-1B-17
I-3 + II-1B-18
I-3 + II-1B-19
I-3 + II-1B-20
I-3 + II-1B-21
I-3 + II-1B-22
I-3 + II-1B-23
I-3 + II-1B-24
I-3 + II-1B-25
I-3 + II-1B-26
I-3 + II-1B-27
I-3 + II-1B-28
I-3 + II-1B-29
I-3 + II-1B-30
I-3 + II-1B-31
I-3 + II-1B-32
I-3 + II-1B-33
I-3 + II-1B-34
I-3 + II-1B-35
I-3 + II-1B-36
I-3 + II-1B-37
I-3 + II-1B-38
I-3 + II-1B-39
I-3 + II-1B-40
I-3 + II-1B-41
I-3 + II-1B-42
I-3 + II-1B-43
I-3 + II-1B-44
I-3 + II-1B-45
I-3 + II-1B-46
I-3 + II-1B-47
I-3 + II-1B-48
I-3 + II-1B-49
I-3 + II-1B-50
I-3 + II-1B-51
I-3 + II-1B-52
I-3 + II-1B-53
I-3 + II-1B-54
I-3 + II-1B-55
I-3 + II-1B-56
I-3 + II-1B-57
I-3 + II-1B-58
I-3 + II-1B-59
I-3 + II-1B-60
I-3 + II-1B-61
I-3 + II-1B-62
I-3 + II-1B-63
I-3 + II-1B-64
I-3 + II-1B-65
I-3 + II-1B-66
I-3 + II-1B-67
I-3 + II-1B-68
I-3 + II-1B-69
I-3 + II-1B-70
I-3 + II-1B-71
I-3 + II-1B-72
I-3 + II-1B-73
I-3 + II-1B-74
I-3 + II-1B-75
I-3 + II-1B-76
I-3 + II-1B-77
I-3 + II-1B-78
I-3 + II-1B-79
I-3 + II-1B-80
I-3 + II-1B-81
I-3 + II-1B-82
I-3 + II-1B-83
I-3 + II-1B-84
I-3 + II-1B-85
I-3 + II-1B-86
I-3 + II-1B-87
I-3 + II-1B-88
I-3 + II-2A-1
I-3 + II-2A-2
I-3 + II-2A-3
I-3 + II-2A-4
I-3 + II-2A-5
I-3 + II-2A-6
I-3 + II-2A-7
I-3 + II-2A-8
I-3 + II-2B-1
I-3 + II-2B-2
I-3 + II-2B-3
I-3 + II-2B-4
I-3 + II-2B-5
I-3 + II-2B-6
I-3 + II-3-1
I-3 + II-3-2
I-3 + II-3-3
I-3 + II-3-4
I-3 + II-3-5
I-3 + II-3-6
I-3 + II-3-7
I-3 + II-3-8
I-3 + II-3-9
I-3 + II-3-10
I-3 + II-3-11
I-3 + II-3-12
I-3 + II-3-13
I-3 + II-3-14
I-3 + II-3-15
I-3 + II-3-16
I-3 + II-3-17
I-3 + II-3-18
I-3 + II-3-19
I-3 + II-3-20
I-3 + II-3-21
I-3 + II-3-22
I-3 + II-3-23
I-3 + II-3-24
I-3 + II-3-25
I-3 + II-3-26
I-3 + II-3-27
I-3 + II-3-28
I-3 + II-3-29
I-3 + II-3-30
I-3 + II-3-31
I-3 + II-3-32
I-3 + II-3-33
I-3 + II-3-34
I-3 + II-3-35
I-3 + II-3-36
I-3 + II-3-37
I-3 + II-3-38
I-3 + II-3-39
I-3 + II-3-40
I-3 + II-3-41
I-3 + II-3-42
I-3 + II-3-43
I-3 + II-3-44
I-3 + II-3-45
I-3 + II-3-46
I-3 + II-3-47
I-3 + II-3-48
I-3 + II-3-49
I-3 + II-3-50
I-3 + II-3-51
I-3 + II-3-52
I-3 + II-3-53
I-3 + II-3-54
I-3 + II-3-55
I-3 + II-3-56
I-3 + II-3-57
I-3 + II-3-58
I-3 + II-4A-1
I-3 + II-4A-2
I-3 + II-4A-3
I-3 + II-4A-4
I-3 + II-4A-5
I-3 + II-4A-6
I-3 + II-4A-7
I-3 + II-4A-8
I-3 + II-4A-9
I-3 + II-4A-10
I-3 + II-4A-11
I-3 + II-4B-1
I-3 + II-4B-2
I-3 + II-4B-3
I-3 + II-4B-4
I-3 + II-4C-4
I-3 + II-5-1
I-3 + II-5-2
I-3 + II-6-1
I-3 + II-6-2
I-3 + II-6-3
I-3 + II-6-4
I-3 + II-6-5
I-3 + II-6-6
I-3 + II-7A-1
I-3 + II-7A-2
I-3 + II-7A-3
I-3 + II-7A-4
I-3 + II-7A-5
I-3 + II-7B-1
I-3 + II-7C-1
I-3 + II-7C-2
I-3 + II-8A-1
I-3 + II-8B-1
I-3 + II-8C-1
I-3 + II-9A-1
I-3 + II-9B-1
I-3 + II-9B-2
I-3 + II-9C-1
I-3 + II-10A-1
I-3 + II-10A-2
I-3 + II-10B-1
I-3 + II-12A-1
I-3 + II-12B-1
I-3 + II-12B-2
I-3 + II-12B-3
I-3 + II-12C-1
I-3 + II-12C-2
I-3 + II-13-1
I-3 + II-13-2
I-3 + II-13-3
I-3 + II-13-4
I-3 + II-13-5
I-3 + II-13-6
I-3 + II-15-1
I-3 + II-15-2
I-3 + II-15-3
I-3 + II-15-4
I-3 + II-15-5
I-3 + II-15-6
I-3 + II-15-7
I-3 + II-15-8
I-3 + II-15-9
I-3 + II-15-10
I-3 + II-15-11
I-3 + II-15-12
I-3 + II-15-13
I-3 + II-16-1
I-3 + II-17-1
I-3 + II-18A-1
I-3 + II-18A-2
I-3 + II-18A-3
I-3 + II-18A-4
I-3 + II-18A-5
I-3 + II-18B-1
I-3 + II-19-1
I-3 + II-20A-1
I-3 + II-20B-1
I-3 + II-20C-1
I-3 + II-20D-1
I-3 + II-20D-2
I-3 + II-21-1
I-3 + II-21-2
I-3 + II-21-3
I-3 + II-21-4
I-3 + II-21-5
I-3 + II-21-6
I-3 + II-21-7
I-3 + II-22A-1
I-3 + II-22B-1
I-3 + II-23A-1
I-3 + II-23A-2
I-3 + II-23B-1
I-3 + II-25-1
I-3 + II-28-1
I-3 + II-28-2
I-3 + II-28-3
I-3 + II-28-4
I-3 + II-29-1
I-3 + II-29-2
I-3 + II-29-3
I-3 + II-29-4
I-3 + II-29-5
I-3 + II-29-6
I-3 + II-29-7
I-3 + II-29-8
I-3 + II-29-9
I-3 + II-29-10
I-3 + II-29-11
I-3 + II-29-12
I-3 + II-29-13
I-3 + II-29-14
I-3 + II-29-15
I-3 + II-29-16
I-3 + II-29-17
I-3 + II-29-18
I-3 + II-29-19
I-3 + II-29-20
I-3 + II-29-21
I-3 + II-29-22
I-3 + II-29-23
I-3 + II-29-24
I-3 + II-29-25
I-3 + II-29-26
I-3 + II-29-27
I-3 + II-29-28
I-3 + II-29-29
I-3 + II-29-30
I-3 + II-29-31
I-3 + II-30-1
I-4 + II-1A-1
I-4 + II-1A-2
I-4 + II-1A-3
I-4 + II-1A-4
I-4 + II-1A-5
I-4 + II-1A-6
I-4 + II-1A-7
I-4 + II-1A-8
I-4 + II-1A-9
I-4 + II-1A-10
I-4 + II-1A-11
I-4 + II-1A-12
I-4 + II-1A-13
I-4 + II-1A-14
I-4 + II-1A-15
I-4 + II-1A-16
I-4 + II-1A-17
I-4 + II-1A-18
I-4 + II-1A-19
I-4 + II-1A-20
I-4 + II-1A-21
I-4 + II-1A-22
I-4 + II-1A-23
I-4 + II-1A-24
I-4 + II-1A-25
I-4 + II-1A-26
I-4 + II-1A-27
I-4 + II-1A-28
I-4 + II-1A-29
I-4 + II-1A-30
I-4 + II-1A-31
I-4 + II-1A-32
I-4 + II-1A-33
I-4 + II-1A-34
I-4 + II-1A-35
I-4 + II-1B-1
I-4 + II-1B-2
I-4 + II-1B-3
I-4 + II-1B-4
I-4 + II-1B-5
I-4 + II-1B-6
I-4 + II-1B-7
I-4 + II-1B-8
I-4 + II-1B-9
I-4 + II-1B-10
I-4 + II-1B-11
I-4 + II-1B-12
I-4 + II-1B-13
I-4 + II-1B-14
I-4 + II-1B-15
I-4 + II-1B-16
I-4 + II-1B-17
I-4 + II-1B-18
I-4 + II-1B-19
I-4 + II-1B-20
I-4 + II-1B-21
I-4 + II-1B-22
I-4 + II-1B-23
I-4 + II-1B-24
I-4 + II-1B-25
I-4 + II-1B-26
I-4 + II-1B-27
I-4 + II-1B-28
I-4 + II-1B-29
I-4 + II-1B-30
I-4 + II-1B-31
I-4 + II-1B-32
I-4 + II-1B-33
I-4 + II-1B-34
I-4 + II-1B-35
I-4 + II-1B-36
I-4 + II-1B-37
I-4 + II-1B-38
I-4 + II-1B-39
I-4 + II-1B-40
I-4 + II-1B-41
I-4 + II-1B-42
I-4 + II-1B-43
I-4 + II-1B-44
I-4 + II-1B-45
I-4 + II-1B-46
I-4 + II-1B-47
I-4 + II-1B-48
I-4 + II-1B-49
I-4 + II-1B-50
I-4 + II-1B-51
I-4 + II-1B-52
I-4 + II-1B-53
I-4 + II-1B-54
I-4 + II-1B-55
I-4 + II-1B-56
I-4 + II-1B-57
I-4 + II-1B-58
I-4 + II-1B-59
I-4 + II-1B-60
I-4 + II-1B-61
I-4 + II-1B-62
I-4 + II-1B-63
I-4 + II-1B-64
I-4 + II-1B-65
I-4 + II-1B-66
I-4 + II-1B-67
I-4 + II-1B-68
I-4 + II-1B-69
I-4 + II-1B-70
I-4 + II-1B-71
I-4 + II-1B-72
I-4 + II-1B-73
I-4 + II-1B-74
I-4 + II-1B-75
I-4 + II-1B-76
I-4 + II-1B-77
I-4 + II-1B-78
I-4 + II-1B-79
I-4 + II-1B-80
I-4 + II-1B-81
I-4 + II-1B-82
I-4 + II-1B-83
I-4 + II-1B-84
I-4 + II-1B-85
I-4 + II-1B-86
I-4 + II-1B-87
I-4 + II-1B-88
I-4 + II-2A-1
I-4 + II-2A-2
I-4 + II-2A-3
I-4 + II-2A-4
I-4 + II-2A-5
I-4 + II-2A-6
I-4 + II-2A-7
I-4 + II-2A-8
I-4 + II-2B-1
I-4 + II-2B-2
I-4 + II-2B-3
I-4 + II-2B-4
I-4 + II-2B-5
I-4 + II-2B-6
I-4 + II-3-1
I-4 + II-3-2
I-4 + II-3-3
I-4 + II-3-4
I-4 + II-3-5
I-4 + II-3-6
I-4 + II-3-7
I-4 + II-3-8
I-4 + II-3-9
I-4 + II-3-10
I-4 + II-3-11
I-4 + II-3-12
I-4 + II-3-13
I-4 + II-3-14
I-4 + II-3-15
I-4 + II-3-16
I-4 + II-3-17
I-4 + II-3-18
I-4 + II-3-19
I-4 + II-3-20
I-4 + II-3-21
I-4 + II-3-22
I-4 + II-3-23
I-4 + II-3-24
I-4 + II-3-25
I-4 + II-3-26
I-4 + II-3-27
I-4 + II-3-28
I-4 + II-3-29
I-4 + II-3-30
I-4 + II-3-31
I-4 + II-3-32
I-4 + II-3-33
I-4 + II-3-34
I-4 + II-3-35
I-4 + II-3-36
I-4 + II-3-37
I-4 + II-3-38
I-4 + II-3-39
I-4 + II-3-40
I-4 + II-3-41
I-4 + II-3-42
I-4 + II-3-43
I-4 + II-3-44
I-4 + II-3-45
I-4 + II-3-46
I-4 + II-3-47
I-4 + II-3-48
I-4 + II-3-49
I-4 + II-3-50
I-4 + II-3-51
I-4 + II-3-52
I-4 + II-3-53
I-4 + II-3-54
I-4 + II-3-55
I-4 + II-3-56
I-4 + II-3-57
I-4 + II-3-58
I-4 + II-4A-1
I-4 + II-4A-2
I-4 + II-4A-3
I-4 + II-4A-4
I-4 + II-4A-5
I-4 + II-4A-6
I-4 + II-4A-7
I-4 + II-4A-8
I-4 + II-4A-9
I-4 + II-4A-10
I-4 + II-4A-11
I-4 + II-4B-1
I-4 + II-4B-2
I-4 + II-4B-3
I-4 + II-4B-4
I-4 + II-4C-4
I-4 + II-5-1
I-4 + II-5-2
I-4 + II-6-1
I-4 + II-6-2
I-4 + II-6-3
I-4 + II-6-4
I-4 + II-6-5
I-4 + II-6-6
I-4 + II-7A-1
I-4 + II-7A-2
I-4 + II-7A-3
I-4 + II-7A-4
I-4 + II-7A-5
I-4 + II-7B-1
I-4 + II-7C-1
I-4 + II-7C-2
I-4 + II-8A-1
I-4 + II-8B-1
I-4 + II-8C-1
I-4 + II-9A-1
I-4 + II-9B-1
I-4 + II-9B-2
I-4 + II-9C-1
I-4 + II-10A-1
I-4 + II-10A-2
I-4 + II-10B-1
I-4 + II-12A-1
I-4 + II-12B-1
I-4 + II-12B-2
I-4 + II-12B-3
I-4 + II-12C-1
I-4 + II-12C-2
I-4 + II-13-1
I-4 + II-13-2
I-4 + II-13-3
I-4 + II-13-4
I-4 + II-13-5
I-4 + II-13-6
I-4 + II-15-1
I-4 + II-15-2
I-4 + II-15-3
I-4 + II-15-4
I-4 + II-15-5
I-4 + II-15-6
I-4 + II-15-7
I-4 + II-15-8
I-4 + II-15-9
I-4 + II-15-10
I-4 + II-15-11
I-4 + II-15-12
I-4 + II-15-13
I-4 + II-16-1
I-4 + II-17-1
I-4 + II-18A-1
I-4 + II-18A-2
I-4 + II-18A-3
I-4 + II-18A-4
I-4 + II-18A-5
I-4 + II-18B-1
I-4 + II-19-1
I-4 + II-20A-1
I-4 + II-20B-1
I-4 + II-20C-1
I-4 + II-20D-1
I-4 + II-20D-2
I-4 + II-21-1
I-4 + II-21-2
I-4 + II-21-3
I-4 + II-21-4
I-4 + II-21-5
I-4 + II-21-6
I-4 + II-21-7
I-4 + II-22A-1
I-4 + II-22B-1
I-4 + II-23A-1
I-4 + II-23A-2
I-4 + II-23B-1
I-4 + II-25-1
I-4 + II-28-1
I-4 + II-28-2
I-4 + II-28-3
I-4 + II-28-4
I-4 + II-29-1
I-4 + II-29-2
I-4 + II-29-3
I-4 + II-29-4
I-4 + II-29-5
I-4 + II-29-6
I-4 + II-29-7
I-4 + II-29-8
I-4 + II-29-9
I-4 + II-29-10
I-4 + II-29-11
I-4 + II-29-12
I-4 + II-29-13
I-4 + II-29-14
I-4 + II-29-15
I-4 + II-29-16
I-4 + II-29-17
I-4 + II-29-18
I-4 + II-29-19
I-4 + II-29-20
I-4 + II-29-21
I-4 + II-29-22
I-4 + II-29-23
I-4 + II-29-24
I-4 + II-29-25
I-4 + II-29-26
I-4 + II-29-27
I-4 + II-29-28
I-4 + II-29-29
I-4 + II-29-30
I-4 + II-29-31
I-4 + II-30-1
I-5 + II-1A-1
I-5 + II-1A-2
I-5 + II-1A-3
I-5 + II-1A-4
I-5 + II-1A-5
I-5 + II-1A-6
I-5 + II-1A-7
I-5 + II-1A-8
I-5 + II-1A-9
I-5 + II-1A-10
I-5 + II-1A-11
I-5 + II-1A-12
I-5 + II-1A-13
I-5 + II-1A-14
I-5 + II-1A-15
I-5 + II-1A-16
I-5 + II-1A-17
I-5 + II-1A-18
I-5 + II-1A-19
I-5 + II-1A-20
I-5 + II-1A-21
I-5 + II-1A-22
I-5 + II-1A-23
I-5 + II-1A-24
I-5 + II-1A-25
I-5 + II-1A-26
I-5 + II-1A-27
I-5 + II-1A-28
I-5 + II-1A-29
I-5 + II-1A-30
I-5 + II-1A-31
I-5 + II-1A-32
I-5 + II-1A-33
I-5 + II-1A-34
I-5 + II-1A-35
I-5 + II-1B-1
I-5 + II-1B-2
I-5 + II-1B-3
I-5 + II-1B-4
I-5 + II-1B-5
I-5 + II-1B-6
I-5 + II-1B-7
I-5 + II-1B-8
I-5 + II-1B-9
I-5 + II-1B-10
I-5 + II-1B-11
I-5 + II-1B-12
I-5 + II-1B-13
I-5 + II-1B-14
I-5 + II-1B-15
I-5 + II-1B-16
I-5 + II-1B-17
I-5 + II-1B-18
I-5 + II-1B-19
I-5 + II-1B-20
I-5 + II-1B-21
I-5 + II-1B-22
I-5 + II-1B-23
I-5 + II-1B-24
I-5 + II-1B-25
I-5 + II-1B-26
I-5 + II-1B-27
I-5 + II-1B-28
I-5 + II-1B-29
I-5 + II-1B-30
I-5 + II-1B-31
I-5 + II-1B-32
I-5 + II-1B-33
I-5 + II-1B-34
I-5 + II-1B-35
I-5 + II-1B-36
I-5 + II-1B-37
I-5 + II-1B-38
I-5 + II-1B-39
I-5 + II-1B-40
I-5 + II-1B-41
I-5 + II-1B-42
I-5 + II-1B-43
I-5 + II-1B-44
I-5 + II-1B-45
I-5 + II-1B-46
I-5 + II-1B-47
I-5 + II-1B-48
I-5 + II-1B-49
I-5 + II-1B-50
I-5 + II-1B-51
I-5 + II-1B-52
I-5 + II-1B-53
I-5 + II-1B-54
I-5 + II-1B-55
I-5 + II-1B-56
I-5 + II-1B-57
I-5 + II-1B-58
I-5 + II-1B-59
I-5 + II-1B-60
I-5 + II-1B-61
I-5 + II-1B-62
I-5 + II-1B-63
I-5 + II-1B-64
I-5 + II-1B-65
I-5 + II-1B-66
I-5 + II-1B-67
I-5 + II-1B-68
I-5 + II-1B-69
I-5 + II-1B-70
I-5 + II-1B-71
I-5 + II-1B-72
I-5 + II-1B-73
I-5 + II-1B-74
I-5 + II-1B-75
I-5 + II-1B-76
I-5 + II-1B-77
I-5 + II-1B-78
I-5 + II-1B-79
I-5 + II-1B-80
I-5 + II-1B-81
I-5 + II-1B-82
I-5 + II-1B-83
I-5 + II-1B-84
I-5 + II-1B-85
I-5 + II-1B-86
I-5 + II-1B-87
I-5 + II-1B-88
I-5 + II-2A-1
I-5 + II-2A-2
I-5 + II-2A-3
I-5 + II-2A-4
I-5 + II-2A-5
I-5 + II-2A-6
I-5 + II-2A-7
I-5 + II-2A-8
I-5 + II-2B-1
I-5 + II-2B-2
I-5 + II-2B-3
I-5 + II-2B-4
I-5 + II-2B-5
I-5 + II-2B-6
I-5 + II-3-1
I-5 + II-3-2
I-5 + II-3-3
I-5 + II-3-4
I-5 + II-3-5
I-5 + II-3-6
I-5 + II-3-7
I-5 + II-3-8
I-5 + II-3-9
I-5 + II-3-10
I-5 + II-3-11
I-5 + II-3-12
I-5 + II-3-13
I-5 + II-3-14
I-5 + II-3-15
I-5 + II-3-16
I-5 + II-3-17
I-5 + II-3-18
I-5 + II-3-19
I-5 + II-3-20
I-5 + II-3-21
I-5 + II-3-22
I-5 + II-3-23
I-5 + II-3-24
I-5 + II-3-25
I-5 + II-3-26
I-5 + II-3-27
I-5 + II-3-28
I-5 + II-3-29
I-5 + II-3-30
I-5 + II-3-31
I-5 + II-3-32
I-5 + II-3-33
I-5 + II-3-34
I-5 + II-3-35
I-5 + II-3-36
I-5 + II-3-37
I-5 + II-3-38
I-5 + II-3-39
I-5 + II-3-40
I-5 + II-3-41
I-5 + II-3-42
I-5 + II-3-43
I-5 + II-3-44
I-5 + II-3-45
I-5 + II-3-46
I-5 + II-3-47
I-5 + II-3-48
I-5 + II-3-49
I-5 + II-3-50
I-5 + II-3-51
I-5 + II-3-52
I-5 + II-3-53
I-5 + II-3-54
I-5 + II-3-55
I-5 + II-3-56
I-5 + II-3-57
I-5 + II-3-58
I-5 + II-4A-1
I-5 + II-4A-2
I-5 + II-4A-3
I-5 + II-4A-4
I-5 + II-4A-5
I-5 + II-4A-6
I-5 + II-4A-7
I-5 + II-4A-8
I-5 + II-4A-9
I-5 + II-4A-10
I-5 + II-4A-11
I-5 + II-4B-1
I-5 + II-4B-2
I-5 + II-4B-3
I-5 + II-4B-4
I-5 + II-4C-4
I-5 + II-5-1
I-5 + II-5-2
I-5 + II-6-1
I-5 + II-6-2
I-5 + II-6-3
I-5 + II-6-4
I-5 + II-6-5
I-5 + II-6-6
I-5 + II-7A-1
I-5 + II-7A-2
I-5 + II-7A-3
I-5 + II-7A-4
I-5 + II-7A-5
I-5 + II-7B-1
I-5 + II-7C-1
I-5 + II-7C-2
I-5 + II-8A-1
I-5 + II-8B-1
I-5 + II-8C-1
I-5 + II-9A-1
I-5 + II-9B-1
I-5 + II-9B-2
I-5 + II-9C-1
I-5 + II-10A-1
I-5 + II-10A-2
I-5 + II-10B-1
I-5 + II-12A-1
I-5 + II-12B-1
I-5 + II-12B-2
I-5 + II-12B-3
I-5 + II-12C-1
I-5 + II-12C-2
I-5 + II-13-1
I-5 + II-13-2
I-5 + II-13-3
I-5 + II-13-4
I-5 + II-13-5
I-5 + II-13-6
I-5 + II-15-1
I-5 + II-15-2
I-5 + II-15-3
I-5 + II-15-4
I-5 + II-15-5
I-5 + II-15-6
I-5 + II-15-7
I-5 + II-15-8
I-5 + II-15-9
I-5 + II-15-10
I-5 + II-15-11
I-5 + II-15-12
I-5 + II-15-13
I-5 + II-16-1
I-5 + II-17-1
I-5 + II-18A-1
I-5 + II-18A-2
I-5 + II-18A-3
I-5 + II-18A-4
I-5 + II-18A-5
I-5 + II-18B-1
I-5 + II-19-1
I-5 + II-20A-1
I-5 + II-20B-1
I-5 + II-20C-1
I-5 + II-20D-1
I-5 + II-20D-2
I-5 + II-21-1
I-5 + II-21-2
I-5 + II-21-3
I-5 + II-21-4
I-5 + II-21-5
I-5 + II-21-6
I-5 + II-21-7
I-5 + II-22A-1
I-5 + II-22B-1
I-5 + II-23A-1
I-5 + II-23A-2
I-5 + II-23B-1
I-5 + II-25-1
I-5 + II-28-1
I-5 + II-28-2
I-5 + II-28-3
I-5 + II-28-4
I-5 + II-29-1
I-5 + II-29-2
I-5 + II-29-3
I-5 + II-29-4
I-5 + II-29-5
I-5 + II-29-6
I-5 + II-29-7
I-5 + II-29-8
I-5 + II-29-9
I-5 + II-29-10
I-5 + II-29-11
I-5 + II-29-12
I-5 + II-29-13
I-5 + II-29-14
I-5 + II-29-15
I-5 + II-29-16
I-5 + II-29-17
I-5 + II-29-18
I-5 + II-29-19
I-5 + II-29-20
I-5 + II-29-21
I-5 + II-29-22
I-5 + II-29-23
I-5 + II-29-24
I-5 + II-29-25
I-5 + II-29-26
I-5 + II-29-27
I-5 + II-29-28
I-5 + II-29-29
I-5 + II-29-30
I-5 + II-29-31
I-5 + II-30-1
I-6 + II-1A-1
I-6 + II-1A-2
I-6 + II-1A-3
I-6 + II-1A-4
I-6 + II-1A-5
I-6 + II-1A-6
I-6 + II-1A-7
I-6 + II-1A-8
I-6 + II-1A-9
I-6 + II-1A-10
I-6 + II-1A-11
I-6 + II-1A-12
I-6 + II-1A-13
I-6 + II-1A-14
I-6 + II-1A-15
I-6 + II-1A-16
I-6 + II-1A-17
I-6 + II-1A-18
I-6 + II-1A-19
I-6 + II-1A-20
I-6 + II-1A-21
I-6 + II-1A-22
I-6 + II-1A-23
I-6 + II-1A-24
I-6 + II-1A-25
I-6 + II-1A-26
I-6 + II-1A-27
I-6 + II-1A-28
I-6 + II-1A-29
I-6 + II-1A-30
I-6 + II-1A-31
I-6 + II-1A-32
I-6 + II-1A-33
I-6 + II-1A-34
I-6 + II-1A-35
I-6 + II-1B-1
I-6 + II-1B-2
I-6 + II-1B-3
I-6 + II-1B-4
I-6 + II-1B-5
I-6 + II-1B-6
I-6 + II-1B-7
I-6 + II-1B-8
I-6 + II-1B-9
I-6 + II-1B-10
I-6 + II-1B-11
I-6 + II-1B-12
I-6 + II-1B-13
I-6 + II-1B-14
I-6 + II-1B-15
I-6 + II-1B-16
I-6 + II-1B-17
I-6 + II-1B-18
I-6 + II-1B-19
I-6 + II-1B-20
I-6 + II-1B-21
I-6 + II-1B-22
I-6 + II-1B-23
I-6 + II-1B-24
I-6 + II-1B-25
I-6 + II-1B-26
I-6 + II-1B-27
I-6 + II-1B-28
I-6 + II-1B-29
I-6 + II-1B-30
I-6 + II-1B-31
I-6 + II-1B-32
I-6 + II-1B-33
I-6 + II-1B-34
I-6 + II-1B-35
I-6 + II-1B-36
I-6 + II-1B-37
I-6 + II-1B-38
I-6 + II-1B-39
I-6 + II-1B-40
I-6 + II-1B-41
I-6 + II-1B-42
I-6 + II-1B-43
I-6 + II-1B-44
I-6 + II-1B-45
I-6 + II-1B-46
I-6 + II-1B-47
I-6 + II-1B-48
I-6 + II-1B-49
I-6 + II-1B-50
I-6 + II-1B-51
I-6 + II-1B-52
I-6 + II-1B-53
I-6 + II-1B-54
I-6 + II-1B-55
I-6 + II-1B-56
I-6 + II-1B-57
I-6 + II-1B-58
I-6 + II-1B-59
I-6 + II-1B-60
I-6 + II-1B-61
I-6 + II-1B-62
I-6 + II-1B-63
I-6 + II-1B-64
I-6 + II-1B-65
I-6 + II-1B-66
I-6 + II-1B-67
I-6 + II-1B-68
I-6 + II-1B-69
I-6 + II-1B-70
I-6 + II-1B-71
I-6 + II-1B-72
I-6 + II-1B-73
I-6 + II-1B-74
I-6 + II-1B-75
I-6 + II-1B-76
I-6 + II-1B-77
I-6 + II-1B-78
I-6 + II-1B-79
I-6 + II-1B-80
I-6 + II-1B-81
I-6 + II-1B-82
I-6 + II-1B-83
I-6 + II-1B-84
I-6 + II-1B-85
I-6 + II-1B-86
I-6 + II-1B-87
I-6 + II-1B-88
I-6 + II-2A-1
I-6 + II-2A-2
I-6 + II-2A-3
I-6 + II-2A-4
I-6 + II-2A-5
I-6 + II-2A-6
I-6 + II-2A-7
I-6 + II-2A-8
I-6 + II-2B-1
I-6 + II-2B-2
I-6 + II-2B-3
I-6 + II-2B-4
I-6 + II-2B-5
I-6 + II-2B-6
I-6 + II-3-1
I-6 + II-3-2
I-6 + II-3-3
I-6 + II-3-4
I-6 + II-3-5
I-6 + II-3-6
I-6 + II-3-7
I-6 + II-3-8
I-6 + II-3-9
I-6 + II-3-10
I-6 + II-3-11
I-6 + II-3-12
I-6 + II-3-13
I-6 + II-3-14
I-6 + II-3-15
I-6 + II-3-16
I-6 + II-3-17
I-6 + II-3-18
I-6 + II-3-19
I-6 + II-3-20
I-6 + II-3-21
I-6 + II-3-22
I-6 + II-3-23
I-6 + II-3-24
I-6 + II-3-25
I-6 + II-3-26
I-6 + II-3-27
I-6 + II-3-28
I-6 + II-3-29
I-6 + II-3-30
I-6 + II-3-31
I-6 + II-3-32
I-6 + II-3-33
I-6 + II-3-34
I-6 + II-3-35
I-6 + II-3-36
I-6 + II-3-37
I-6 + II-3-38
I-6 + II-3-39
I-6 + II-3-40
I-6 + II-3-41
I-6 + II-3-42
I-6 + II-3-43
I-6 + II-3-44
I-6 + II-3-45
I-6 + II-3-46
I-6 + II-3-47
I-6 + II-3-48
I-6 + II-3-49
I-6 + II-3-50
I-6 + II-3-51
I-6 + II-3-52
I-6 + II-3-53
I-6 + II-3-54
I-6 + II-3-55
I-6 + II-3-56
I-6 + II-3-57
I-6 + II-3-58
I-6 + II-4A-1
I-6 + II-4A-2
I-6 + II-4A-3
I-6 + II-4A-4
I-6 + II-4A-5
I-6 + II-4A-6
I-6 + II-4A-7
I-6 + II-4A-8
I-6 + II-4A-9
I-6 + II-4A-10
I-6 + II-4A-11
I-6 + II-4B-1
I-6 + II-4B-2
I-6 + II-4B-3
I-6 + II-4B-4
I-6 + II-4C-4
I-6 + II-5-1
I-6 + II-5-2
I-6 + II-6-1
I-6 + II-6-2
I-6 + II-6-3
I-6 + II-6-4
I-6 + II-6-5
I-6 + II-6-6
I-6 + II-7A-1
I-6 + II-7A-2
I-6 + II-7A-3
I-6 + II-7A-4
I-6 + II-7A-5
I-6 + II-7B-1
I-6 + II-7C-1
I-6 + II-7C-2
I-6 + II-8A-1
I-6 + II-8B-1
I-6 + II-8C-1
I-6 + II-9A-1
I-6 + II-9B-1
I-6 + II-9B-2
I-6 + II-9C-1
I-6 + II-10A-1
I-6 + II-10A-2
I-6 + II-10B-1
I-6 + II-12A-1
I-6 + II-12B-1
I-6 + II-12B-2
I-6 + II-12B-3
I-6 + II-12C-1
I-6 + II-12C-2
I-6 + II-13-1
I-6 + II-13-2
I-6 + II-13-3
I-6 + II-13-4
I-6 + II-13-5
I-6 + II-13-6
I-6 + II-15-1
I-6 + II-15-2
I-6 + II-15-3
I-6 + II-15-4
I-6 + II-15-5
I-6 + II-15-6
I-6 + II-15-7
I-6 + II-15-8
I-6 + II-15-9
I-6 + II-15-10
I-6 + II-15-11
I-6 + II-15-12
I-6 + II-15-13
I-6 + II-16-1
I-6 + II-17-1
I-6 + II-18A-1
I-6 + II-18A-2
I-6 + II-18A-3
I-6 + II-18A-4
I-6 + II-18A-5
I-6 + II-18B-1
I-6 + II-19-1
I-6 + II-20A-1
I-6 + II-20B-1
I-6 + II-20C-1
I-6 + II-20D-1
I-6 + II-20D-2
I-6 + II-21-1
I-6 + II-21-2
I-6 + II-21-3
I-6 + II-21-4
I-6 + II-21-5
I-6 + II-21-6
I-6 + II-21-7
I-6 + II-22A-1
I-6 + II-22B-1
I-6 + II-23A-1
I-6 + II-23A-2
I-6 + II-23B-1
I-6 + II-25-1
I-6 + II-28-1
I-6 + II-28-2
I-6 + II-28-3
I-6 + II-28-4
I-6 + II-29-1
I-6 + II-29-2
I-6 + II-29-3
I-6 + II-29-4
I-6 + II-29-5
I-6 + II-29-6
I-6 + II-29-7
I-6 + II-29-8
I-6 + II-29-9
I-6 + II-29-10
I-6 + II-29-11
I-6 + II-29-12
I-6 + II-29-13
I-6 + II-29-14
I-6 + II-29-15
I-6 + II-29-16
I-6 + II-29-17
I-6 + II-29-18
I-6 + II-29-19
I-6 + II-29-20
I-6 + II-29-21
I-6 + II-29-22
I-6 + II-29-23
I-6 + II-29-24
I-6 + II-29-25
I-6 + II-29-26
I-6 + II-29-27
I-6 + II-29-28
I-6 + II-29-29
I-6 + II-29-30
I-6 + II-29-31
I-6 + II-30-1

Very particular preference is given to the following active compounds:
1. acrinathrin (II-3-1)

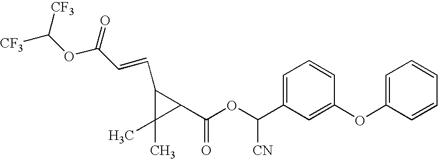

known from EP-A-048 186
and/or
2. alpha-cypermethrin (II-3-18)

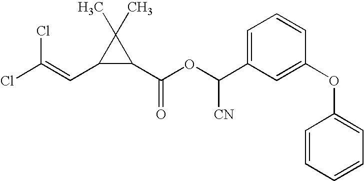

known from EP-A-067 461
and/or
3. betacyfluthrin (II-3-3)

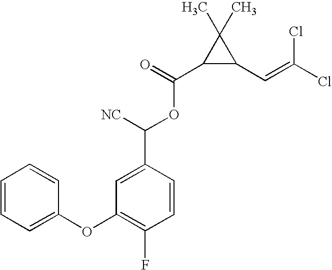

known from EP-A-206 149
and/or
4. cyhalothrin (II-3-17)

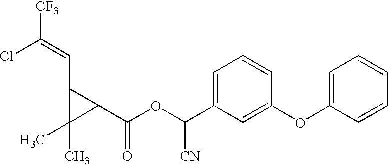

known from DE-A-2 802 962
and/or
5. cypermethrin (II-3-18)

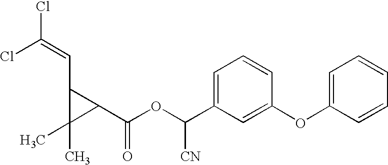

known from DE-A-2 326 077
and/or
6. deltamethrin (II-3-20)

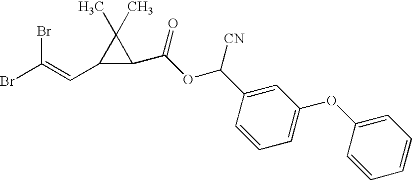

known from DE-A-2 326 077
and/or
7. esfenvalerate (II-3-22)

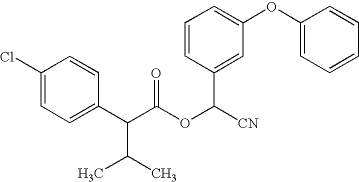

known from DE-A-2 737 297
and/or
8. etofenprox (II-3-23)

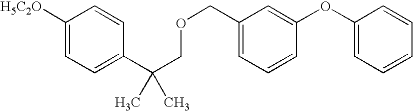

known from DE-A-3 117 510
and/or
9. fenpropathrin (II-3-25)

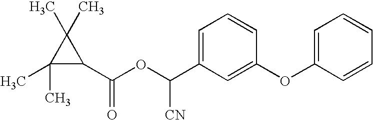

known from DE-A-2 231 312
and/or
10. fenvalerate (II-3-27)

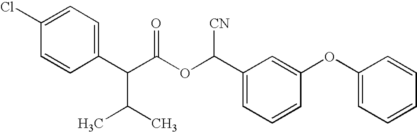

known from DE-A-2 335 347
and/or
11. flucythrinate (II-3-29)

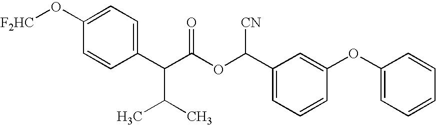

known from DE-A-2 757 066
and/or
12a. lambda-cyhalothrin (II-3-37)

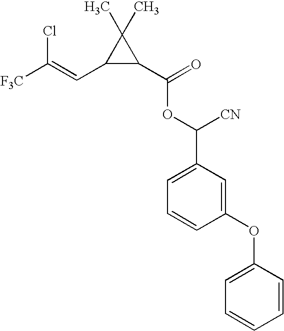

known from EP-A-106 469
and/or
12b. gamma-cyhalothrin (II-3-34)

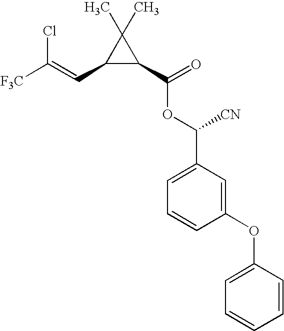

known from GB-A-02143823
and/or
13. permethrin (II-3-39)

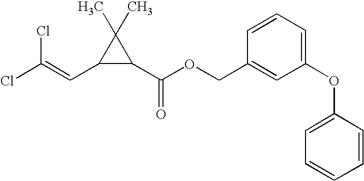

known from DE-A-2 326 077
and/or
14. tau-fluvalinate (II-3-48)

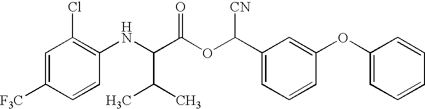

known from EP-A-038 617
and/or
15. tralomethrin (II-3-52)

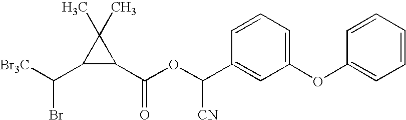

known from DE-A-2 742 546
and/or
16. zeta-cypermethrin (II-3-18)

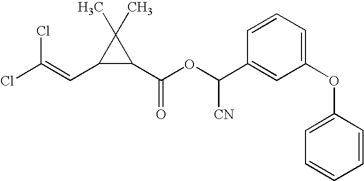

known from EP-A-026 542
and/or
17. cyfluthrin (II-3-16)

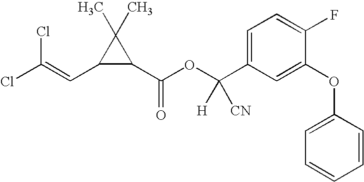

known from DE-A-27 09 264
and/or
18. bifenthrin (II-3-4)

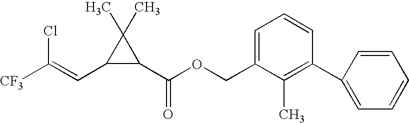

known from EP-A-049 977
and/or
19. cycloprothrin (II-3-15)

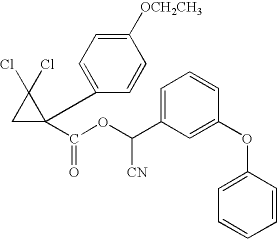

known from DE-A-2653189
and/or
20. eflusilanate (II-3-56)

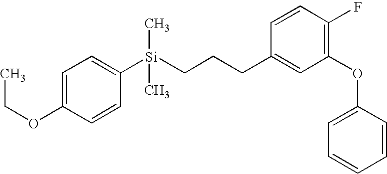

known from DE-A-36 04 781
and/or
21. fubfenprox (II-3-33)

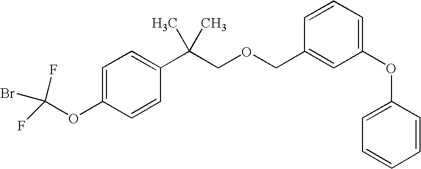

known from DE-A-37 08 231
and/or
22. pyrethrin (II-3-55)

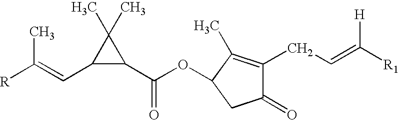

R=—CH₃ or —CO₂CH₃
R₁=—CH═CH₂ or —CH₃ or —CH₂CH₃
known from The Pesticide Manual, 1997, 11th Edition, p. 1056
and/or
23. resmethrin (II-3-45)

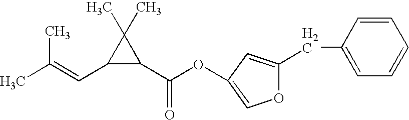

known from GB-A-1 168 797
and/or
24. imidacloprid (II-4A-4)

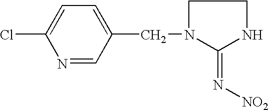

known from EP-A-00192060
and/or
25. acetamiprid (II-4A-1)

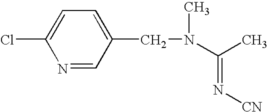

known from WO 91/04965
and/or
26. thiamethoxam (II-4A-9)

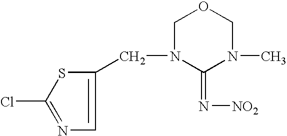

known from EP-A-00580553
and/or
27. nitenpyram (II-4A-6)

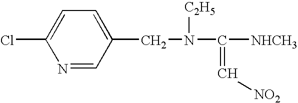

known from EP-A-00302389
and/or
28. thiacloprid (II-4A-8)

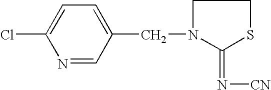

known from EP-A-00235725
and/or
29. dinotefuran (II-4A-3)

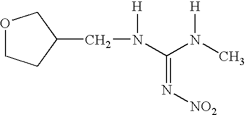

known from EP-A-00649845
and/or
30. clothianidin (II-4A-2)

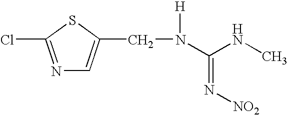

known from EP-A-00376279
and/or
31. imidaclothiz (II-4A-5)

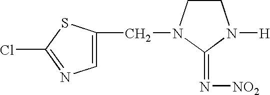

known from EP-A-00192060
and/or
32. chlorfluazuron (II-15-2)

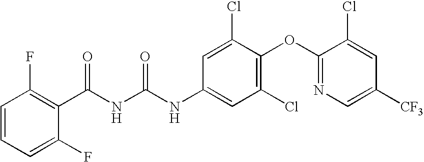

known from DE-A-2 818 830
and/or
33. diflubenzuron (II-15-3)

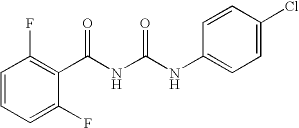

known from DE-A 2 123 236
and/or
34. lufenuron (II-15-8)

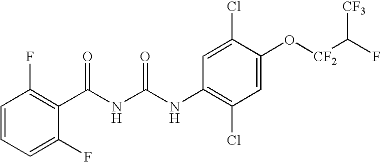

known from EP-A-179 022
and/or
35. teflubenzuron (II-15-12)

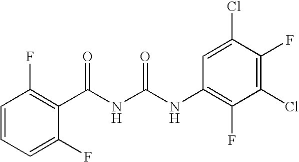

known from EP-A-052 833
and/or
36. triflumuron (II-15-13)

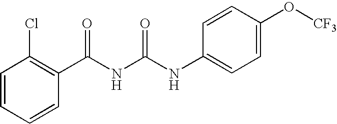

known from DE-A-2 601 780
and/or
37. novaluron (II-15-9)

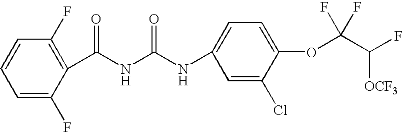

known from U.S. Pat. No. 4,980,376
and/or
38. flufenoxuron (II-15-6)

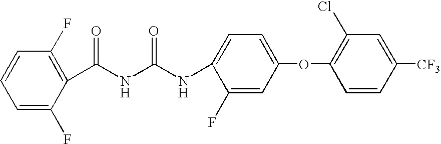

known from EP-A 161 019
and/or
39. hexaflumuron (II-15-7)

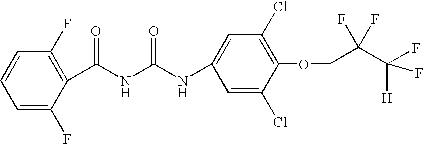

known from EP-A 71 279
and/or
40. bistrifluoron (II-15-1)

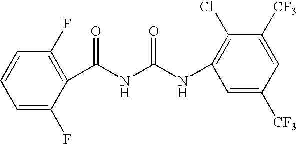

known from WO 98/00394
and/or
41. noviflumuron (II-15-10)

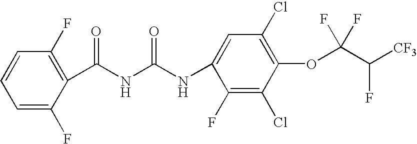

known from WO 98/19542
and/or
42. buprofezin (II-16-1)

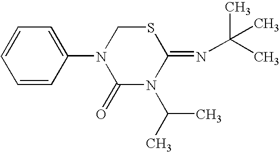

known from DE-A-2 824 126
and/or
43. cyromazine (II-17-1)

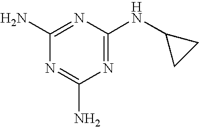

known from DE-A-2 736 876
and/or
44. methoxyfenozide (II-18A-3)

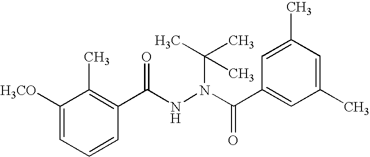

known from EP-A-639 559
and/or
45. tebufenozide (II-18A-4)

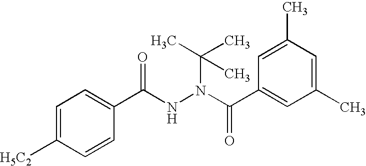

known from EP-A-339 854
and/or
46. halofenozide (II-18A-2)

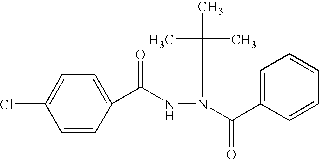

known from EP-A 228 564
and/or
47. JS-118 (II-18A-5)

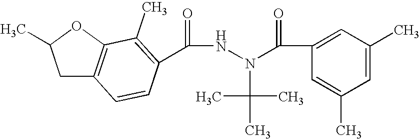

known from ZL 01108161.9, trade name Fu-Shen,
Modern Agrochemicals, Vol. 4, No. 3, 2005, 1-7
and/or
48. chromafenozide (II-18A-1)

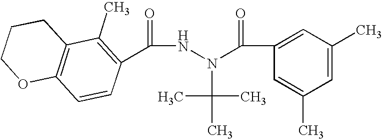

known from EP-A-496342
and/or
49. endosulfan (II-2A-3)

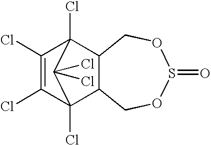

and/or
50. fipronil (II-2B-3)

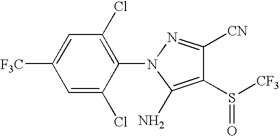

known from EP-A-295 117
and/or
51. ethiprole (II-2B-2)

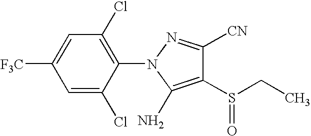

known from WO 97/22593
and/or
52. pyrafluprole (II-2B-4)

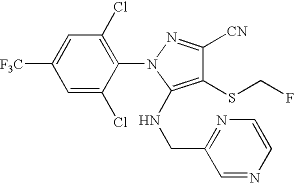

known from WO 01/00614
and/or
53. pyriprole (II-2B-5)

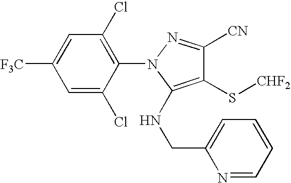

known from WO 02/10153
and/or
54. flubendiamide (II-28-1)

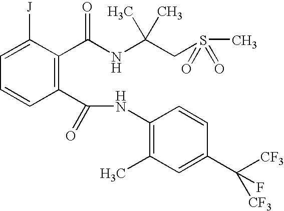

known from EP-A-01006107
and/or
55. the compound (II-28-2)

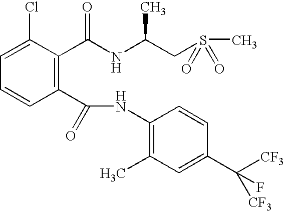

known from WO 06/022225
and/or
56. chlorantraniliprole (Rynaxapyr) (II-28-3)

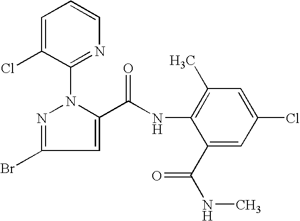

known from WO 03/015519
and/or
57. Cyazypyr (II-28-4)

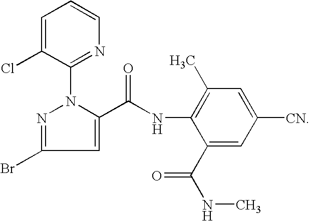

known from WO 04/067528
and/or
58. emamectin (II-6-2)
   known from EP-A-089 202
   and/or
59. emamectin benzoate (II-6-3)
   known from EP-A-089202
   and/or
60. abamectin (II-6-1)
   known from DE-A-27 17 040
   and/or
61. ivermectin (II-6-4)
   known from EP-A-001 689
   and/or
62. milbemectin (II-6-6)
   known from The Pesticide Manual, 11th Edition, 1997, p. 846
   and/or
63. lepimectin (II-6-5)
   known from EP-A-675 133
   and/or
64. tebufenpyrad (II-21-5)

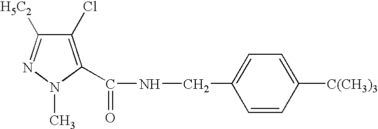

known from EP-A-289 879
and/or
65. fenpyroximate (II-21-2)

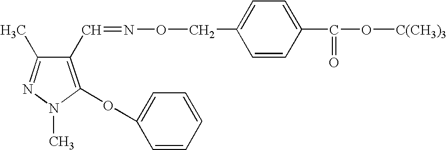

known from EP-A-234 045
and/or
66. pyridaben (II-21-4)

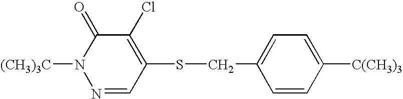

known from EP-A-134 439
and/or
67. fenazaquin (II-21-1)

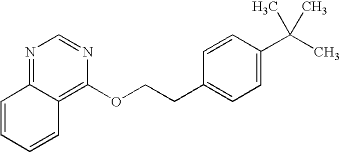

known from EP-A-326 329
and/or
68. pyrimidifen (II-21-3)

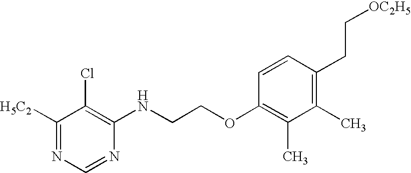

known from EP-A-196 524
and/or
69. tolfenpyrad (II-21-6)

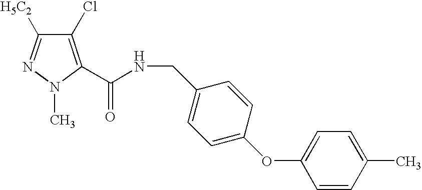

known from EP-A-365 925
and/or
70. dicofol (II-29-11)

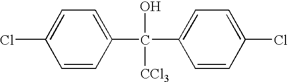

known from U.S. Pat. No. 2,812,280
and/or
71. cyenopyrafen (II-20D-2)
   (1E)-2-cyano-2-[4-(1,1-dimethylethyl)phenyl]-1-(1,3,4-trimethyl-1H-pyrazol-5-yl)ethenyl 2,2-dimethylpropanoate

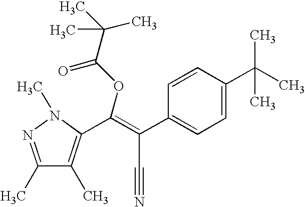

known from JP-A-2003 201 280
and/or
72. cyflumetofen (II-20D-1)
   2-methoxyethyl alpha-cyano-alpha-[4-(1,1-dimethylethyl)phenyl]-beta-oxo-2-(trifluoromethyl)benzenepropanoate

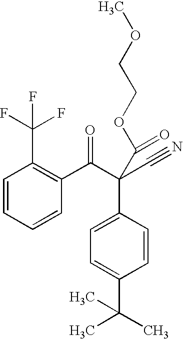

known from WO 2002/014263
and/or
73. acequinocyl (II-20B-1)

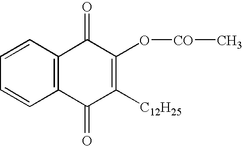

known from DE-A-26 41 343
and/or
74. fluacrypyrim (II-20C-1)

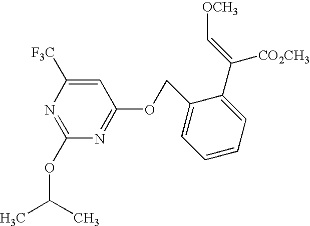

known from WO 96/16047
and/or
75. bifenazate (II-25-1)

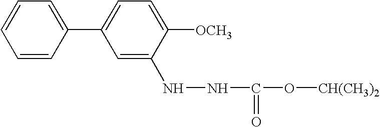

known from WO 93/10 083
and/or
76. diafenthiuron (II-12A-1)

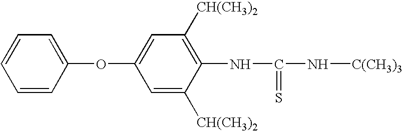

known from EP-A-210 487
and/or
77. etoxazole (II-10B-1)

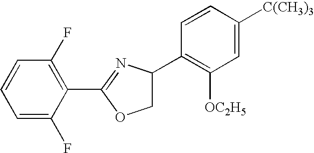

known from WO 93/22 297
and/or
78. clofentezine (II-10A-1)

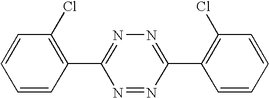

known from EP-A-005 912
and/or
79. the macrolide of the formula

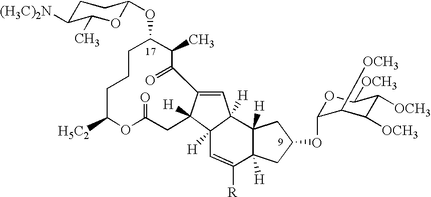

spinosad (II-5-1) a mixture of preferably
85 spinosyn A R=H
15% spinosyn B R=CH₃
known from EP-A-375 316
and/or
80. triarathen (II-29-26)

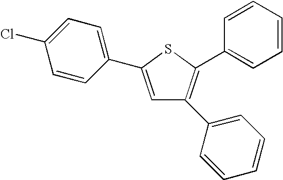

known from DE-A-2 724 494
and/or
81. tetradifon (II-12C-2)

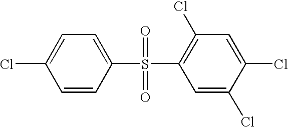

known from U.S. Pat. No. 2,812,281
and/or
82. propargite (II-12C-1)

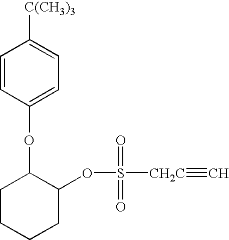

known from U.S. Pat. No. 3,272,854
and/or
83. hexythiazox (II-10A-2)

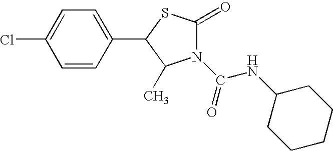

known from DE-A-3 037 105
and/or
84. bromopropylate (II-29-4)

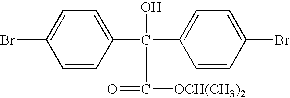

known from U.S. Pat. No. 3,784,696
and/or
85. chinomethionate (II-29-6)

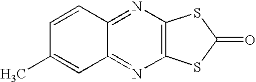

known from DE-A-1 100 372
and/or
86. amitraz (II-19-1)

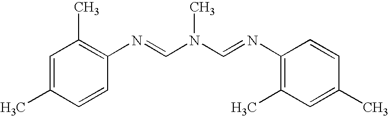

known from DE-A-2 061 132
and/or
87. NNI 0101 (II-9B-2)
   1-acetyl-3,4-dihydro-3-[(3-pyridinylmethyl)amino]-6-[1,2,2,2-tetrafluoro-1-(trifluoromethyl)ethyl-2(1H)-quinazolinone

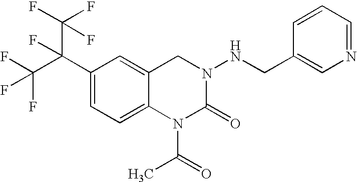

known from EP-A-01097932
and/or
88. pymetrozine (II-9B-1)

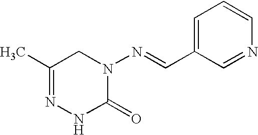

known from EP-A-314 615
and/or
89. flonicamid (II-9C-1)

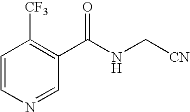

known from EP-A-00580374
and/or
90. pyriproxyfen (II-7C-1)

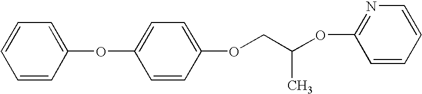

known from EP-A-128 648
and/or
91. diofenolan (II-7C-2)

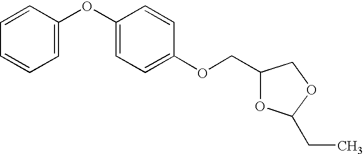

known from DE-A 2 655 910
and/or
92. chlorfenapyr (II-13-1)

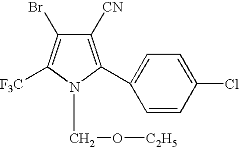

known from EP-A-347 488
and/or
93. metaflumizone (II-22B-1)

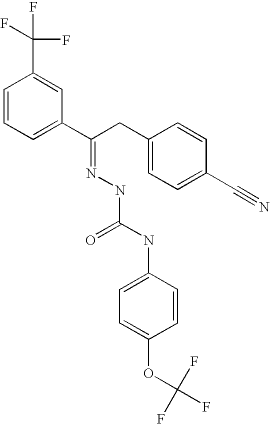

known from EP-A-00462456
and/or
94. indoxacarb (II-22A-1)

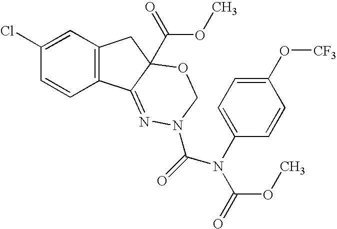

known from WO 92/11249 and also the +-enantiomer DPX-KN 128 known from ACS Symposium Series 800, p. 178
and/or
95. chlorpyrifos (II-1B-12)

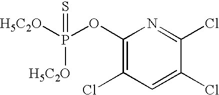

known from U.S. Pat. No. 3,244,586
and/or
96. spirodiclofen (II-23A-1)

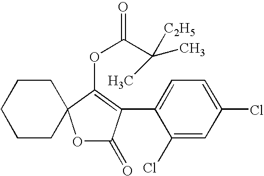

known from EP-A-528 156
and/or
97. spiromesifen (II-23A-2)

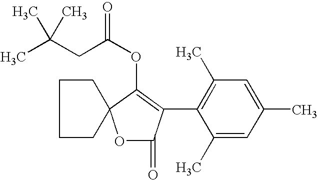

known from EP-A-528 156
and/or
98. spirotetramat (II-23B-1)

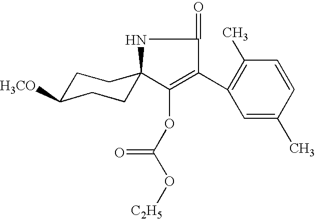

known from WO 04/007 448
and/or
99. pyridalyl (II-29-23)

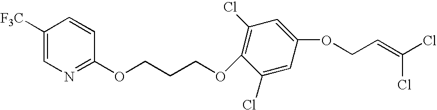

known from WO 96/11909
and/or
100. the compound (II-4A-10)

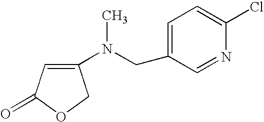

known from EP-A-0539588
and/or
101. the compound (II-4A-11)

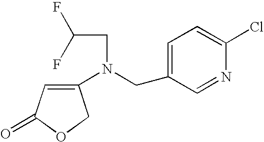

known from WO 2007/115644
and/or
102. spinetoram (II-5-2)

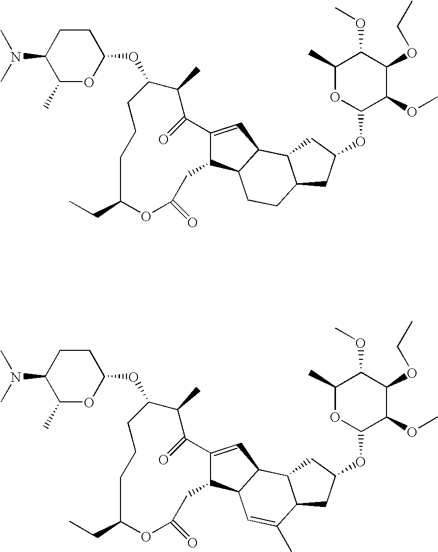

known from WO 97/00265, Crouse G D et al., Pest. Management Science 57, 177-185, (2001)
and/or
103. the compound (II-29-28)

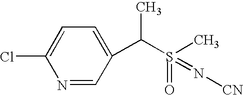

known from WO 2007/149134 and its diastereomers
and/or
104. the compound (II-29-29)

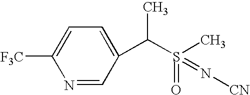

known from WO 2007/149134 and its diastereomers
and/or
105. the compound (II-29-30)

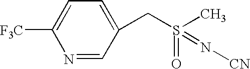

known from WO 2007/095229 and its enantiomers
and/or
106. the compound (II-29-31)

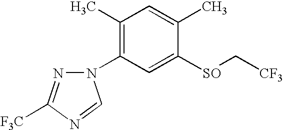

known from WO 99/55668
and/or
107. Bacillus thuringiensis strains (II-30-1)
   and/or
108. aldicarb (II-1.A-2)

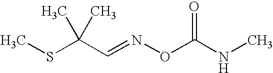

known from U.S. Pat. No. 3,217,037
and/or
109. carbosulfan (II-1.A-14)

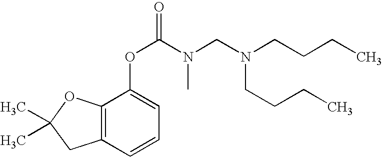

known from DE-A-02433680
and/or
110. methiocarb (H-1.A-24)

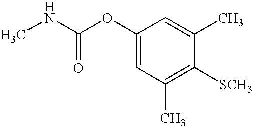

known from DE-A 11 62 352
and/or
111. thiodicarb (II-1.A-31)

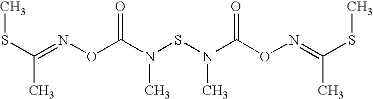

known from DE-A 25 30 439
and/or
112. acephate (II-1.B-1)

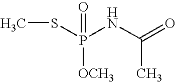

known from DE-A 20 14 027
and/or
113. methamidophos (II-1.B-53)

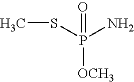

known from U.S. Pat. No. 3,309,266
and/or
114. profenophos (II-1.B-69)

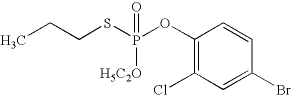

known from DE-A 22 49 462
and/or
115. triazophos (II-1.B-86)

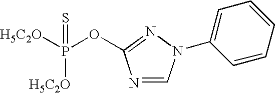

known from DE-A 12 99 924.

In addition, the active compound combinations may also comprise further fungicidally, acaricidally or insecticidally active additives.

The improved activity becomes evident when the active compounds in the active compound combinations according to the invention are present in certain weight ratios. However, the weight ratios of the active compounds in the active compound combinations can be varied within a relatively wide range. In general, the combinations according to the invention comprise active compounds of the formulae (I-1) to (I-6) and the mixing partner of the formula (II) in the preferred and particularly preferred mixing ratios stated in the table below:
the mixing ratios are based on weight ratios. The ratio is to be understood as active compound of the formula (I-1):mixing partner to formula (I-6):mixing partner

| | | | Particularly | Very particularly |
|---|---|---|---|---|
| | | Preferred mixing | preferred mixing | preferred mixing |
| | Mixing partner | ratio | ratio | ratio |
| 1. | acrinathrin | 125:1 to 1:125 | 25:1 to 1:25 | 5:1 to 1:5 |
| 2. | alpha-Cypermethrin | 125:1 to 1:125 | 25:1 to 1:25 | 5:1 to 1:5 |
| 3. | betacyfluthrin | 125:1 to 1:125 | 25:1 to 1:25 | 5:1 to 1:5 |
| 4. | cyhalothrin | 125:1 to 1:125 | 25:1 to 1:25 | 5:1 to 1:5 |
| 5. | cypermethrin | 125:1 to 1:125 | 25:1 to 1:25 | 5:1 to 1:5 |
| 6. | deltamethrin | 125:1 to 1:125 | 25:1 to 1:25 | 5:1 to 1:5 |
| 7. | esfenvalerate | 125:1 to 1:125 | 25:1 to 1:25 | 5:1 to 1:5 |
| 8. | etofenprox | 125:1 to 1:125 | 25:1 to 1:25 | 5:1 to 1:5 |
| 9. | fenpropathrin | 125:1 to 1:125 | 25:1 to 1:25 | 5:1 to 1:5 |
| 10. | fenvalerate | 125:1 to 1:125 | 25:1 to 1:25 | 5:1 to 1:5 |
| 11. | flucythrinate | 125:1 to 1:125 | 25:1 to 1:25 | 5:1 to 1:5 |
| 12.a | lambda-cyhalothrin | 125:1 to 1:125 | 25:1 to 1:25 | 5:1 to 1:5 |
| 12.b | gamma-cyhalothrin | 125:1 to 1:125 | 25:1 to 1:25 | 5:1 to 1:5 |
| 13. | permethrin | 125:1 to 1:125 | 25:1 to 1:25 | 5:1 to 1:5 |
| 14. | tau-fluvalinate | 125:1 to 1:125 | 25:1 to 1:25 | 5:1 to 1:5 |
| 15. | tralomethrin | 125:1 to 1:125 | 25:1 to 1:25 | 5:1 to 1:5 |
| 16. | zeta-cypermethrin | 125:1 to 1:125 | 25:1 to 1:25 | 5:1 to 1:5 |
| 17. | cyfluthrin | 125:1 to 1:125 | 25:1 to 1:25 | 5:1 to 1:5 |
| 18. | bifenthrin | 125:1 to 1:125 | 25:1 to 1:25 | 5:1 to 1:5 |
| 19. | cycloprothrin | 125:1 to 1:125 | 25:1 to 1:25 | 5:1 to 1:5 |
| 20. | eflusilanate | 125:1 to 1:125 | 25:1 to 1:25 | 5:1 to 1:5 |
| 21. | fubfenprox | 125:1 to 1:125 | 25:1 to 1:25 | 5:1 to 1:5 |
| 22. | pyrethrin | 125:1 to 1:125 | 25:1 to 1:25 | 5:1 to 1:5 |
| 23. | resmethrin | 125:1 to 1:125 | 25:1 to 1:25 | 5:1 to 1:5 |
| 24. | imidacloprid | 125:1 to 1:125 | 25:1 to 1:25 | 5:1 to 1:5 |
| 25. | acetamiprid | 125:1 to 1:125 | 25:1 to 1:25 | 5:1 to 1:5 |
| 26. | thiamethoxam | 125:1 to 1:125 | 25:1 to 1:25 | 5:1 to 1:5 |
| 27. | nitenpyram | 125:1 to 1:125 | 25:1 to 1:25 | 5:1 to 1:5 |
| 28. | thiacloprid | 125:1 to 1:125 | 25:1 to 1:25 | 5:1 to 1:5 |
| 29. | dinotefuran | 125:1 to 1:125 | 25:1 to 1:25 | 5:1 to 1:5 |
| 30. | clothianidin | 125:1 to 1:125 | 25:1 to 1:25 | 5:1 to 1:5 |
| 31. | imidaclothiz | 125:1 to 1:125 | 25:1 to 1:25 | 5:1 to 1:5 |
| 32. | chlorfluazuron | 125:1 to 1:125 | 25:1 to 1:25 | 5:1 to 1:5 |
| 33. | diflubenzuron | 125:1 to 1:125 | 25:1 to 1:25 | 5:1 to 1:5 |
| 34. | lufenuron | 125:1 to 1:125 | 25:1 to 1:25 | 5:1 to 1:5 |
| 35. | teflubenzuron | 125:1 to 1:125 | 25:1 to 1:25 | 5:1 to 1:5 |
| 36. | triflumuron | 125:1 to 1:125 | 25:1 to 1:25 | 5:1 to 1:5 |
| 37. | novaluron | 125:1 to 1:125 | 25:1 to 1:25 | 5:1 to 1:5 |
| 38. | flufenoxuron | 125:1 to 1:125 | 25:1 to 1:25 | 5:1 to 1:5 |
| 39. | hexaflumuron | 125:1 to 1:125 | 25:1 to 1:25 | 5:1 to 1:5 |
| 40. | bisfluoron | 125:1 to 1:125 | 25:1 to 1:25 | 5:1 to 1:5 |
| 41. | noviflumuron | 125:1 to 1:125 | 25:1 to 1:25 | 5:1 to 1:5 |
| 42. | buprofezin | 125:1 to 1:125 | 25:1 to 1:25 | 5:1 to 1:5 |
| 43. | cyromazine | 125:1 to 1:125 | 25:1 to 1:25 | 5:1 to 1:5 |
| 44. | methoxyfenozide | 125:1 to 1:125 | 25:1 to 1:25 | 5:1 to 1:5 |
| 45. | tebufenozide | 125:1 to 1:125 | 25:1 to 1:25 | 5:1 to 1:5 |
| 46. | halofenozide | 125:1 to 1:125 | 25:1 to 1:25 | 5:1 to 1:5 |
| 47. | JS-118 | 125:1 to 1:125 | 25:1 to 1:25 | 5:1 to 1:5 |
| 48. | chromafenozide | 125:1 to 1:125 | 25:1 to 1:25 | 5:1 to 1:5 |
| 49. | endosulfan | 125:1 to 1:125 | 25:1 to 1:25 | 5:1 to 1:5 |
| 50. | fipronil | 125:1 to 1:125 | 25:1 to 1:25 | 5:1 to 1:5 |
| 51. | ethiprole | 125:1 to 1:125 | 25:1 to 1:25 | 5:1 to 1:5 |
| 52. | pyrafluprole | 125:1 to 1:125 | 25:1 to 1:25 | 5:1 to 1:5 |
| 53. | pyriprole | 125:1 to 1:125 | 25:1 to 1:25 | 5:1 to 1:5 |
| 54. | flubendiamide | 125:1 to 1:125 | 25:1 to 1:25 | 5:1 to 1:5 |
| 55. | compound II-28-2 | 125:1 to 1:125 | 25:1 to 1:25 | 5:1 to 1:5 |
| 56. | chlorantraniliprole | 125:1 to 1:125 | 25:1 to 1:25 | 5:1 to 1:5 |
| | (Rynaxapyr) | | | |
| 57. | Cyazypyr | 125:1 to 1:125 | 25:1 to 1:25 | 5:1 to 1:5 |
| 58. | emamectin | 125:1 to 1:125 | 25:1 to 1:25 | 5:1 to 1:5 |
| 59. | emamectin benzoate | 125:1 to 1:125 | 25:1 to 1:25 | 5:1 to 1:5 |
| 60. | abamectin | 125:1 to 1:125 | 25:1 to 1:25 | 5:1 to 1:5 |
| 61. | ivermectin | 125:1 to 1:125 | 25:1 to 1:25 | 5:1 to 1:5 |
| 62. | milbemectin | 125:1 to 1:125 | 25:1 to 1:25 | 5:1 to 1:5 |
| 63. | lepimectin | 125:1 to 1:125 | 25:1 to 1:25 | 5:1 to 1:5 |
| 64. | tebufenpyrad | 125:1 to 1:125 | 25:1 to 1:25 | 5:1 to 1:5 |
| 65. | fenpyroximate | 125:1 to 1:125 | 25:1 to 1:25 | 5:1 to 1:5 |
| 66. | pyridaben | 125:1 to 1:125 | 25:1 to 1:25 | 5:1 to 1:5 |
| 67. | fenazaquin | 125:1 to 1:125 | 25:1 to 1:25 | 5:1 to 1:5 |
| 68. | pyrimidifen | 125:1 to 1:125 | 25:1 to 1:25 | 5:1 to 1:5 |
| 69. | tolfenpyrad | 125:1 to 1:125 | 25:1 to 1:25 | 5:1 to 1:5 |
| 70. | dicofol | 125:1 to 1:125 | 25:1 to 1:25 | 5:1 to 1:5 |
| 71. | cyenopyrafen | 125:1 to 1:125 | 25:1 to 1:25 | 5:1 to 1:5 |
| 72. | cyflumetofen | 125:1 to 1:125 | 25:1 to 1:25 | 5:1 to 1:5 |
| 73. | acequinocyl | 125:1 to 1:125 | 25:1 to 1:25 | 5:1 to 1:5 |
| 74. | fluacrypyrin | 125:1 to 1:125 | 25:1 to 1:25 | 5:1 to 1:5 |
| 75. | bifenazate | 125:1 to 1:125 | 25:1 to 1:25 | 5:1 to 1:5 |
| 76. | diafenthiuron | 125:1 to 1:125 | 25:1 to 1:25 | 5:1 to 1:5 |
| 77. | etoxazole | 125:1 to 1:125 | 25:1 to 1:25 | 5:1 to 1:5 |
| 78. | clofentezine | 125:1 to 1:125 | 25:1 to 1:25 | 5:1 to 1:5 |
| 79. | spinosad | 125:1 to 1:125 | 25:1 to 1:25 | 5:1 to 1:5 |
| 80. | triarathen | 125:1 to 1:125 | 25:1 to 1:25 | 5:1 to 1:5 |
| 81. | tetradifon | 125:1 to 1:125 | 25:1 to 1:25 | 5:1 to 1:5 |
| 82. | propargite | 125:1 to 1:125 | 25:1 to 1:25 | 5:1 to 1:5 |
| 83. | hexythiazox | 125:1 to 1:125 | 25:1 to 1:25 | 5:1 to 1:5 |
| 84. | bromopropylate | 125:1 to 1:125 | 25:1 to 1:25 | 5:1 to 1:5 |
| 85. | chinomethionate | 125:1 to 1:125 | 25:1 to 1:25 | 5:1 to 1:5 |
| 86. | amitraz | 125:1 to 1:125 | 25:1 to 1:25 | 5:1 to 1:5 |
| 87. | NNI 0101 | 125:1 to 1:125 | 25:1 to 1:25 | 5:1 to 1:5 |
| 88. | pymetrozine | 125:1 to 1:125 | 25:1 to 1:25 | 5:1 to 1:5 |
| 89. | flonicamid | 125:1 to 1:125 | 25:1 to 1:25 | 5:1 to 1:5 |
| 90. | pyriproxyfen | 125:1 to 1:125 | 25:1 to 1:25 | 5:1 to 1:5 |
| 91. | diofenolan | 125:1 to 1:125 | 25:1 to 1:25 | 5:1 to 1:5 |
| 92. | chlorfenapyr | 125:1 to 1:125 | 25:1 to 1:25 | 5:1 to 1:5 |
| 93. | metaflumizone | 125:1 to 1:125 | 25:1 to 1:25 | 5:1 to 1:5 |
| 94. | indoxacarb | 125:1 to 1:125 | 25:1 to 1:25 | 5:1 to 1:5 |
| 95. | chlorpyrifos | 125:1 to 1:125 | 25:1 to 1:25 | 5:1 to 1:5 |
| 96. | spirodiclofen | 125:1 to 1:125 | 25:1 to 1:25 | 5:1 to 1:5 |
| 97. | spiromesifen | 125:1 to 1:125 | 25:1 to 1:25 | 5:1 to 1:5 |
| 98. | spirotetramat | 125:1 to 1:125 | 25:1 to 1:25 | 5:1 to 1:5 |
| 99. | pyridalyl | 125:1 to 1:125 | 25:1 to 1:25 | 5:1 to 1:5 |
| 100. | compound II-4A-10 | 125:1 to 1:125 | 25:1 to 1:25 | 5:1 to 1:5 |
| 101. | compound II-4A-11 | 125:1 to 1:125 | 25:1 to 1:25 | 5:1 to 1:5 |
| 102. | spinetoram | 125:1 to 1:125 | 25:1 to 1:25 | 5:1 to 1:5 |
| 103. | compound II-29-28 | 125:1 to 1:125 | 25:1 to 1:25 | 5:1 to 1:5 |
| 104. | compound II-29-29 | 125:1 to 1:125 | 25:1 to 1:25 | 5:1 to 1:5 |
| 105. | compound II-29-30 | 125:1 to 1:125 | 25:1 to 1:25 | 5:1 to 1:5 |
| 106. | compound II-29-31 | 125:1 to 1:125 | 25:1 to 1:25 | 5:1 to 1:5 |
| 107. | compound II-30-1 | 125:1 to 1:125 | 25:1 to 1:25 | 5:1 to 1:5 |
| 108. | compound II-1.A-2 | 125:1 to 1:125 | 25:1 to 1:25 | 5:1 to 1:5 |
| 109. | compound II-1.A-14 | 125:1 to 1:125 | 25:1 to 1:25 | 5:1 to 1:5 |
| 110. | compound II-1.A-24 | 125:1 to 1:125 | 25:1 to 1:25 | 5:1 to 1:5 |
| 111. | compound II-1.A-31 | 125:1 to 1:125 | 25:1 to 1:25 | 5:1 to 1:5 |
| 112. | compound II-1.B-1 | 125:1 to 1:125 | 25:1 to 1:25 | 5:1 to 1:5 |
| 113. | compound II-1.B-53 | 125:1 to 1:125 | 25:1 to 1:25 | 5:1 to 1:5 |
| 114. | compound II-1.B-69 | 125:1 to 1:125 | 25:1 to 1:25 | 5:1 to 1:5 |
| 115. | compound II-1.B-86 | 125:1 to 1:125 | 25:1 to 1:25 | 5:1 to 1:5 |

The active compound combinations according to the invention are suitable for controlling animal pests, preferably arthropods and nematodes, in particular insects and arachnids, encountered in viticulture, in the cultivation of fruit, in agriculture, in animal health, in forests, in the protection of stored products and in the protection of materials and also in the hygiene sector. They are effective against normally sensitive and resistant species and against all or individual stages of development.

The abovementioned pests include:

From the order of the Isopoda, for example, Oniscus asellus, Armadillidium vulgare, Porcellio scaber.

From the order of the Diplopoda, for example, Blaniulus guttulatus.

From the order of the Chilopoda, for example, Geophilus carpophagus, Scutigera spp.

From the order of the Symphyla, for example, Scutigerella immaculata.

From the order of the Thysanura, for example, Lepisma saccharina.

From the order of the Collembola, for example, Onychiurus armatus.

From the order of the Orthoptera, for example, Acheta domesticus, Gryllotalpa spp., Locusta migratoria migratorioides, Melanoplus spp., Schistocerca gregaria.

From the order of the Blattaria, for example, Blatta orientalis, Periplaneta americana, Leucophaea maderae, Blattella germanica.

From the order of the Dermaptera, for example, Forficula auricularia.

From the order of the Isoptera, for example, Reticulitermes spp.

From the order of the Phthiraptera, for example, Pediculus humanus corporis, Haematopinus spp., Linognathus spp., Trichodectes spp., Damalinia spp.

From the order of the Thysanoptera, for example, Hercinothrips femoralis, Thrips tabaci, Thrips palmi, Frankliniella occidentalis.

From the order of the Heteroptera, for example, Eurygaster spp., Dysdercus intermedius, Piesma quadrata, Cimex lectularius, Rhodnius prolixus, Triatoma spp.

From the order of the Homoptera, for example, Aleurodes brassicae, Bemisia tabaci, Trialeurodes vaporariorum, Aphis gossypii, Brevicoryne brassicae, Cryptomyzus ribis, Aphis fabae, Aphis pomi, Eriosoma lanigerum, Hyalopterus arundinis, Phylloxera vastatrix, Pemphigus spp., Macrosiphum avenae, Myzus spp., Phorodon humuli, Rhopalosiphum padi, Empoasca spp., Euscelis bilobatus, Nephotettix cincticeps, Lecanium corni, Saissetia oleae, Laodelphax striatellus, Nilaparvata lugens, Aonidiella aurantii, Aspidiotus hederae, Pseudococcus spp., Psylla spp.

From the order of the Lepidoptera, for example, Pectinophora gossypiella, Bupalus piniarius, Chematobia brumata, Lithocolletis blancardella, Hyponomeuta padella, Plutella xylostella, Malacosoma neustria, Euproctis chrysorrhoea, Lymantria spp., Bucculatrix thurberiella, Phyllocnistis citrella, Agrotis spp., Euxoa spp., Feltia spp., Earias insulana, Heliothis spp., Mamestra brassicae, Panolis flammea, Spodoptera spp., Trichoplusia ni, Carpocapsa pomonella, Pieris spp., Chilo spp., Pyrausta nubilalis, Ephestia kuehniella, Galleria mellonella, Tineola bisselliella, Tinea pellionella, Hofmannophila pseudospretella, Cacoecia podana, Capua reticulana, Choristoneura fumiferana, Clysia ambiguella, Homona magnanima, Tortrix viridana, Cnaphalocerus spp., Oulema oryzae.

From the order of the Coleoptera, for example, Anobium punctatum, Rhizopertha dominica, Bruchidius obtectus, Acanthoscelides obtectus, Hylotrupes bajulus, Agelastica alni, Leptinotarsa decemlineata, Phaedon cochleariae, Diabrotica spp., Psylliodes chrysocephala, Epilachna varivestis, Atomaria spp., Oryzaephilus surinamensis, Anthonomus spp., Sitophilus spp., Otiorrhynchus sulcatus, Cosmopolites sordidus, Ceuthorrhynchus assimilis, Hypera postica, Dermestes spp., Trogoderma spp., Anthrenus spp., Attagenus spp., Lyctus spp., Meligethes aeneus, Ptinus spp., Niptus hololeucus, Gibbium psylloides, Tribolium spp., Tenebrio molitor, Agriotes spp., Conoderus spp., Melolontha melolontha, Amphimallon solstitialis, Costelytra zealandica, Lissorhoptrus oryzophilus.

From the order of the Hymenoptera, for example, Diprion spp., Hoplocampa spp., Lasius spp., Monomorium pharaonis, Vespa spp.

From the order of the Diptera, for example, Aedes spp., Anopheles spp., Culex spp., Drosophila melanogaster, Musca spp., Fannia spp., Calliphora erythrocephala, Lucilia spp., Chrysomyia spp., Cuterebra spp., Gastrophilus spp., Hyppobosca spp., Stomoxys spp., Oestrus spp., Hypoderma spp., Tabanus spp., Tannia spp., Bibio hortulanus, Oscinella frit, Phorbia spp., Pegomyia hyoscyami, Ceratitis capitata, Dacus oleae, Tipula paludosa, Hylemyia spp., Liriomyza spp.

From the order of the Siphonaptera, for example, Xenopsylla cheopis, Ceratophyllus spp.

From the class of the Arachnida, for example, Scorpio maurus, Latrodectus mactans, Acarus siro, Argas spp., Ornithodoros spp., Dermanyssus gallinae, Eriophyes ribis, Phyllocoptruta oleivora, Boophilus spp., Rhipicephalus spp., Amblyomma spp., Hyalomma spp., Ixodes spp., Psoroptes spp., Chorioptes spp., Sarcoptes spp., Tarsonemus spp., Bryobia praetiosa, Panonychus spp., Tetranychus spp., Hemitarsonemus spp., Brevipalpus spp.

The plant-parasitic nematodes include, for example, Pratylenchus spp., Radopholus similis, Ditylenchus dipsaci, Tylenchulus semipenetrans, Heterodera spp., Globodera spp., Meloidogyne spp., Aphelenchoides spp., Longidorus spp., Xiphinema spp., Trichodorus spp., Bursaphelenchus spp.

The active compound combinations can be converted into the customary formulations such as solutions, emulsions, wettable powders, suspensions, powders, dusts, pastes, soluble powders, granules, suspension-emulsion concentrates, natural and synthetic materials impregnated with active compound, and microencapsulations in polymeric materials.

These formulations are produced in a known manner, for example by mixing the active compounds with extenders, that is, liquid solvents and/or solid carriers, optionally with the use of surfactants, that is, emulsifiers and/or dispersants, and/or foam formers.

If the extender used is water, it is also possible, for example, to use organic solvents as cosolvents. The following are essentially suitable as liquid solvents: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example mineral oil fractions, mineral and vegetable oils, alcohols such as butanol or glycol and their ethers and esters, ketones such as acetone, methyl ethyl ketone, methyl isobutyl ketone or cyclohexanone, strongly polar solvents such as dimethylformamide and dimethyl sulphoxide, or else water.

Suitable solid carriers are:

for example ammonium salts and ground natural minerals such as kaolins, clays, talc, chalk, quartz, attapulgite, montmorillonite or diatomaceous earth, and ground synthetic materials such as highly disperse silica, alumina and silicates; suitable solid carriers for granules are: for example crushed and fractionated natural rocks such as calcite, marble, pumice, sepiolite and dolomite, or else synthetic granules of inorganic and organic meals, and granules of organic material such as sawdust, coconut shells, maize cobs and tobacco stalks; suitable emulsifiers and/or foam formers are: for example nonionic and anionic emulsifiers such as polyoxyethylene fatty acid esters, polyoxyethylene fatty alcohol ethers, for example alkylaryl polyglycol ethers, alkylsulphonates, alkyl sulphates, arylsulphonates, or else protein hydrolysates; suitable dispersants are: for example lignosulfite waste liquors and methylcellulose.

Tackifiers such as carboxymethylcellulose and natural and synthetic polymers in the form of powders, granules or latexes, such as gum arabic, polyvinyl alcohol and polyvinyl acetate, or else natural phospholipids such as cephalins and lecithins and synthetic phospholipids can be used in the formulations. Other possible additives are mineral and vegetable oils.

It is possible to use colorants such as inorganic pigments, for example iron oxide, titanium oxide and Prussian Blue, and organic colorants such as alizarin colorants, azo colorants and metal phthalocyanine colorants, and trace nutrients such as salts of iron, manganese, boron, copper, cobalt, molybdenum and zinc.

The formulations generally comprise between 0.1 and 95% by weight of active compound, preferably between 0.5 and 90%.

The active compound combinations according to the invention can be present in commercially available formulations and in the use forms, prepared from these formulations, as a mixture with other active compounds, such as insecticides, attractants, sterilants, bactericides, acaricides, nematicides, fungicides, growth-regulating substances or herbicides. The insecticides include, for example, phosphates, carbamates, carboxylates, chlorinated hydrocarbons, phenylureas and substances produced by microorganisms, inter alia.

Mixtures with other known active compounds such as herbicides or with fertilizers and growth regulators are also possible.

When used as insecticides, the active compound combinations according to the invention can furthermore be present in their commercially available formulations and in the use forms, prepared from these formulations, as a mixture with synergists. Synergists are compounds which increase the action of the active compounds, without it being necessary for the synergist added to be active itself.

The active compound content of the use forms prepared from the commercially available formulations can vary within wide limits. The active compound concentration of the use forms can be from 0.0000001 to 95% by weight of active compound, preferably between 0.0001 and 1% by weight.

The compounds are employed in a customary manner appropriate for the use forms.

According to the invention, it is possible to treat all plants and parts of plants. Plants are to be understood here as meaning all plants and plant populations such as desired and undesired wild plants or crop plants (including naturally occurring crop plants). Crop plants can be plants which can be obtained by conventional breeding and optimization methods or by biotechnological and genetic engineering methods or combinations of these methods, including the transgenic plants and including the plant cultivars which can or cannot be protected by plant breeders' certificates. Parts of plants are to be understood as meaning all above-ground and below-ground parts and organs of plants, such as shoot, leaf, flower and root, examples which may be mentioned being leaves, needles, stems, trunks, flowers, fruit-bodies, fruits and seeds and also roots, tubers and rhizomes. Parts of plants also include harvested plants and vegetative and generative propagation material, for example seedlings, tubers, rhizomes, cuttings and seeds.

The treatment according to the invention of the plants and parts of plants with the active compounds is carried out directly or by action on their environment, habitat or storage area according to customary treatment methods, for example by dipping, spraying, evaporating, atomizing, broadcasting, brushing-on and, in the case of propagation material, in particular in the case of seeds, furthermore by one- or multi-layer coating.

As already mentioned above, it is possible to treat all plants and their parts according to the invention. In a preferred embodiment, wild plant species and plant cultivars, or those obtained by conventional biological breeding methods, such as crossing or protoplast fusion, and parts thereof, are treated. In a further preferred embodiment, transgenic plants and plant cultivars obtained by genetic engineering methods, if appropriate in combination with conventional methods (Genetic Modified Organisms), and parts thereof are treated. The terms “parts”, “parts of plants” and “plant parts” have been explained above.

Particularly preferably, plants of the plant cultivars which are in each case commercially available or in use are treated according to the invention.

Depending on the plant species or plant cultivars, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the substances and compositions which can be used according to the invention, better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products are possible which exceed the effects which were actually to be expected.

The transgenic plants or plant cultivars (i.e. those obtained by genetic engineering) which are preferred and to be treated according to the invention include all plants which, in the genetic modification, received genetic material which imparts particularly advantageous useful traits to these plants. Examples of such traits are better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products. Further and particularly emphasized examples of such properties are a better defense of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), maize, soya beans, potatoes, cotton, oilseed rape and also fruit plants (with the fruits apples, pears, citrus fruits and grapes), and particular emphasis is given to maize, soya beans, potatoes, cotton and oilseed rape. Traits that are particularly emphasized are the increased defense of the plants against insects by toxins formed in the plants, in particular those formed by the genetic material from Bacillus Thuringiensis (for example by the genes CryIA(a), CryIA(b), CryIA(c), CryIIA, CryIIIA, CryIIIB2, Cry9c, Cry2Ab, Cry3Bb and CryIF and also combinations thereof) (hereinbelow referred to as “Bt plants”). Traits that are furthermore particularly emphasized are the increased tolerance of the plants to certain herbicidally active compounds, for example imidazolinones, sulphonylureas, glyphosate or phosphinotricin (for example the “PAT” gene). The genes in question which impart the desired traits can also be present in combination with one another in the transgenic plants. Examples of “Bt plants” which may be mentioned are maize varieties, cotton varieties, soya bean varieties and potato varieties which are sold under the trade names YIELD GARD® (for example maize, cotton, soya beans), KnockOut® (for example maize), StarLink® (for example maize), Bollgard® (cotton), Nucotn® (cotton) and NewLeaf® (potato). Examples of herbicide-tolerant plants which may be mentioned are maize varieties, cotton varieties and soya bean varieties which are sold under the trade names Roundup Ready® (tolerance to glyphosate, for example maize, cotton, soya bean), Liberty Link® (tolerance to phosphinotricin, for example oilseed rape), IMI© (tolerance to imidazolinones) and STS® (tolerance to sulphonylureas, for example maize). Herbicide-resistant plants (plants bred in a conventional manner for herbicide tolerance) which may be mentioned include the varieties sold under the name Clearfield® (for example maize). Of course, these statements also apply to plant cultivars having these or still-to-be-developed genetic traits, which plants will be developed and/or marketed in the future.

The plants listed can be treated according to the invention in a particularly advantageous manner with the active compound mixture according to the invention. The preferred ranges stated above for the mixtures also apply to the treatment of these plants. Particular emphasis is given to the treatment of plants with the mixtures specifically mentioned in the present text.

The good insecticidal and acaricidal action of the active compound combination according to the invention can be seen from the examples which follow. While the individual active compounds show weaknesses in their action, the combinations show an action which exceeds a simple sum of actions.

A synergistic effect in insecticides and acaricides is always present when the action of the active compound combinations exceeds the total of the actions of the active compounds when applied individually.

The expected action for a given combination of two active compounds can be calculated as follows, according to S. R. Colby, Weeds 15 (1967), 20-22:

If
X is the kill rate, expressed as a percentage of the untreated control, when employing active compound A at an application rate of m g/ha or in a concentration of m ppm,
Y is the kill rate, expressed as a percentage of the untreated control, when employing active compound B at an application rate of n g/ha or in a concentration of n ppm and
E is the kill rate, expressed as a percentage of the untreated control, when employing active compounds A and B at application rates of m and n g/ha or in a concentration of m and n ppm,
   then

$$E = X + Y - \frac{X \cdot Y}{100}$$

If the actual insecticidal kill rate exceeds the calculated value, the kill of the combination is superadditive, i.e. a synergistic effect is present. In this case, the actually observed kill rate must exceed the value calculated using the above formula for the expected kill rate (E).

### EXAMPLE A

### Aphis gossypii Test

| | |
|---|---|
| solvent: | 7 parts by weight of dimethylformamide |
| emulsifier: | 2 parts by weight of alkylaryl polyglycol ether |

To produce a suitable preparation of active compound, 1 part by weight of active compound is mixed with the stated amounts of solvent and emulsifier, and the concentrate is diluted with emulsifier-containing water to the desired concentration.

Cotton leaves (Gossypium herbaceum) which are heavily infested by the cotton aphid (Aphis gossypii) are sprayed with the active compound preparation of the desired concentration.

After the desired period of time, the kill in % is determined. 100% means that all aphids have been killed; 0% means that none of the aphids have been killed. The kill rates determined are entered into Colby's formula.

In this test, for example, the following active compound combinations in accordance with the present application show a synergistically enhanced activity compared to the active compounds applied individually:

TABLE A-1
Aphis gossypii test

| | Concentration | Kill | |
|---|---|---|---|
| Active compound | in ppm | in % after 6^{d} | |
| compound (I-2) | 20 | 25 | |
| gamma-cyhalothrin (12b) | 0.16 | 0 | |
| | | found* | calc.** |
| compound (I-2) + gamma- | 20 + 0.16 | 75 | 25 |
| cyhalothrin (12b) (125:1) | | | |
| according to the invention | | | |

*found = activity found
**calc. = activity calculated using Colby's formula

### EXAMPLE B

### Bemisia tabaci Test

| | |
|---|---|
| solvent: | 7 parts by weight of dimethylformamide |
| emulsifier: | 2 parts by weight of alkylaryl polyglycol ether |

To produce a suitable preparation of active compound, 1 part by weight of active compound is mixed with the stated amounts of solvent and emulsifier, and the concentrate is diluted with emulsifier-containing water to the desired concentration.

Cotton leaves (Gossypium herbaceum) which are heavily infested by the larval stages of the white fly (Bemisia tabaci) are sprayed with the active compound preparation of the desired concentration.

After the desired period of time, the kill in % is determined. 100% means that all white flies have been killed; 0% means that none of the white flies have been killed. The kill rates determined are entered into Colby's formula.

In this test, for example, the following active compound combinations in accordance with the present application show a synergistically enhanced activity compared to the active compounds applied individually:

TABLE B-1
Bemisia tabaci test

| | Concentration | Kill | |
|---|---|---|---|
| Active compound | in g/ha | in % after 10^{d} | |
| compound (I-2) | 4 | 45 | |
| buprofezin (42) | 4 | 30 | |
| | | found* | calc.** |
| compound (I-2) + buprofezin | 4 + 4 | 85 | 61.5 |
| (42) (1:1) | | | |
| according to the invention | | | |

*found = activity found
**calc. = activity calculated using Colby's formula

### EXAMPLE C

### Myzus persicae Test

| | |
|---|---|
| solvents: | 78 parts by weights of acetone |
| | 1.5 parts by weight of dimethylformamide |
| emulsifier: | 0.5 part by weight of alkylaryl polyglycol ether |

To produce a suitable preparation of active compound, 1 part by weight of active compound is mixed with the stated amounts of solvents and emulsifier, and the concentrate is diluted with emulsifier-containing water to the desired concentration.

Cabbage leaves (Brassica oleracea) which are heavily infested by the green peach aphid (Myzus persicae) are treated by spraying with the active compound preparation of the desired concentration.

After the desired period of time, the kill in % is determined. 100% means that all aphids have been killed; 0% means that none of the aphids have been killed. The kill rates determined are entered into Colby's formula.

In this test, for example, the following active compound combinations in accordance with the present application show a synergistically enhanced activity compared to the active compounds applied individually:

TABLE C-1
Myzus persicae test

| | Concentration | Kill | |
|---|---|---|---|
| Active compound | in g/ha | in % after 1^{d} | |
| compound (I-2) | 100 | 55 | |
| | 20 | 0 | |
| | 4 | 0 | |
| | 0.8 | 0 | |
| abamectin (60) | 20 | 5 | |
| | | found* | calc.** |
| compound (I-2) + abamectin | 100 + 20 | 75 | 57.25 |
| (60) (5:1) | | | |
| according to the invention | | | |
| aldicarb (108) | 4 | 30 | |
| | | found* | calc.** |
| compound (I-2) + aldicarb (108) | 4 + 4 | 60 | 30 |
| (1:1) | | | |
| according to the invention | | | |
| buprofezin (42) | 4 | 0 | |
| | | found* | calc.** |
| compound (I-2) + buprofezin | 4 + 4 | 40 | 0 |
| (42) (1:1) | | | |
| according to the invention | | | |
| carbosulfan (109) | 4 | 0 | |
| | | found* | calc.** |
| compound (I-2) + carbosulfan | 4 + 4 | 60 | 0 |
| (109) (1:1) | | | |
| according to the invention | | | |
| Cyazypr (57) | 4 | 5 | |
| | | found* | calc.** |
| compound (I-2) + Cyazypyr (57) | 20 + 4 | 20 | 5 |
| (5:1) | | | |
| according to the invention | | | |
| deltamethrin (6) | 0.16 | 40 | |
| | | found* | calc.** |
| compound (I-2) + deltamethrin | 4 + 0.16 | 70 | 40 |
| (6) (25:1) | | | |
| according to the invention | | | |
| esfenvalerate(7) | 0.16 | 0 | |
| | | found* | calc.** |
| compound (I-2) + esfenvalerate | 4 + 0.16 | 60 | 0 |
| (7) (25:1) | | | |
| according to the invention | | | |
| profenofos (114) | 0.8 | 0 | |
| | | found* | calc.** |
| compound (I-2) + profenofos | 0.8 + 0.8 | 20 | 0 |
| (114) (1:1) | | | |
| according to the invention | | | |
| pymetrozine (88) | 20 | 20 | |
| | | found* | calc.** |
| compound (I-2) + pymetrozine | 20 + 20 | 80 | 20 |
| (88) (1:1) | | | |
| according to the invention | | | |
| triazophos (115) | 4 | 30 | |
| | | found* | calc.** |
| compound (I-2) + triazophos | 4 + 4 | 90 | 30 |
| (115) (1:1) | | | |
| according to the invention | | | |

*found = activity found
**calc. = activity calculated using Colby's formula

TABLE C-2

| | Concentration | Kill | |
|---|---|---|---|
| Active compound | in g/ha | in % after 6^{d} | |
| compound (I-2) | 4 | 70 | |
| | 0.8 | 30 | |
| | 0.16 | 0 | |
| compound (106) | 4 | 0 | |
| | | found* | calc.** |
| compound (I-2) + compound (106) | 4 + 4 | 99 | 70 |
| (1:1) | | | |
| according to the invention | | | |
| acephate (112) | 0.8 | 0 | |
| | | found* | calc.** |
| compound (I-2) + acephate (112) | 0.8 + 0.8 | 90 | 30 |
| (1:1) | | | |
| according to the invention | | | |
| chlorpyrifos (95) | 0.8 | 0 | |
| | | found* | calc.** |
| compound (I-2) + chlorpyrifos (95) | 0.8 + 0.8 | 90 | 30 |
| (1:1) | | | |
| according to the invention | | | |
| methamidophos (113) | 4 | 0 | |
| | | found* | calc.** |
| compound (I-2) + methamidophos | 4 + 4 | 100 | 70 |
| (113) (1:1) | | | |
| according to the invention | | | |
| endosulfan (49) | 4 | 0 | |
| | | found* | calc.** |
| compound (I-2) + endosulfan (49) | 4 + 4 | 90 | 70 |
| (1:1) | | | |
| according to the invention | | | |
| pyriproxifen (90) | 0.8 | 0 | |
| | | found* | calc.** |
| compound (I-2) + pyriproxifen | 0.8 + 0.8 | 60 | 30 |
| (90) (1:1) | | | |
| according to the invention | | | |
| alpha-cypermethrin (2) | 0.16 | 0 | |
| | | found* | calc.** |
| compound (I-2) + alpha- | 4 + 0.16 | 100 | 70 |
| cypermethrin (2) (25:1) | | | |
| according to the invention | | | |
| beta-cyfluthrin (3) | 0.16 | 0 | |
| | | found* | calc.** |
| compound (I-2) + beta-cyfluthrin | 4 + 0.16 | 100 | 70 |
| (3) (25:1) | | | |
| according to the invention | | | |
| cypermethrin (5) | 0.16 | 0 | |
| | | found* | calc.** |
| compound (I-2) + cypermethrin | 0.8 + 0.16 | 70 | 30 |
| (5) (5:1) | | | |
| according to the invention | | | |
| L-cyhalothrin (12a) | 0.032 | 0 | |
| | | found* | calc.** |
| compound (I-2) + L-cyhalothrin | 0.8 + 0.032 | 80 | 30 |
| (12a) (25:1) | | | |
| according to the invention | | | |
| indoxacarb (94) | 4 | 0 | |
| | | found* | calc.** |
| compound (I-2) + indoxacarb (94) | 0.8 + 4 | 80 | 30 |
| (1:5) | | | |
| according to the invention | | | |
| acetamiprid (25) | 0.16 | 0 | |
| | | found* | calc.** |
| compound (I-2) + acetamiprid | 4 + 0.16 | 100 | 85 |
| (25) (25:1) | | | |
| according to the invention | | | |
| clothianidin (30) | 0.032 | 0 | |
| | | found* | calc.** |
| compound (I-2) + clothianidin | 0.8 + 0.032 | 70 | 30 |
| (30) (25:1) | | | |
| according to the invention | | | |
| imidacloprid (24) | 0.032 | 0 | |
| | | found* | calc.** |
| compound (I-2) + imidacloprid | 0.8 + 0.032 | 60 | 30 |
| (24) (25:1) | | | |
| according to the invention | | | |
| thiacloprid (28) | 0.032 | 0 | |
| | | found* | calc.** |
| compound (I-2) + thiacloprid | 0.8 + 0.032 | 90 | 30 |
| (28) (25:1) | | | |
| according to the invention | | | |
| thiamethoxam (26) | 0.032 | 0 | |
| | | found* | calc.** |
| compound (I-2) + thiamethoxam | 0.8 + 0.032 | 70 | 30 |
| (26) (25:1) | | | |
| according to the invention | | | |
| compound (100) | 0.16 | 0 | |
| | | found* | calc.** |
| compound (I-2) + compound | 0.16 + 0.16 | 50 | 0 |
| (100) (1:1) | | | |
| according to the invention | | | |
| compound (101) | 0.8 | 50 | |
| | | found* | calc.** |
| compound (I-2) + compound | 0.8 + 0.8 | 80 | 65 |
| (101) (1:1) | | | |
| according to the invention | | | |
| spinosad (79) | 0.8 | 0 | |
| | | found* | calc.** |
| compound (I-2) + spinosad | 4 + 0.8 | 99 | 70 |
| (79) (5:1) | | | |
| according to the invention | | | |
| spirodiclofen (96) | 0.8 | 0 | |
| | | found* | calc.** |
| compound (I-2) + spirodiclofen | 0.8 + 0.8 | 100 | 30 |
| (96) (1:1) | | | |
| according to the invention | | | |
| spiromesifen (97) | 0.8 | 0 | |
| | | found* | calc.** |
| compound (I-2) + spiromesifen | 0.8 + 0.8 | 70 | 30 |
| (97) (1:1) | | | |
| according to the invention | | | |
| cyenopyrafen (71) | 0.8 | 0 | |
| | | found* | calc.** |
| compound (I-2) + cyenopyrafen | 0.8 + 0.8 | 90 | 30 |
| (71) (1:1) | | | |
| according to the invention | | | |
| cyflumetofen (72) | 4 | 0 | |
| | | found* | calc.** |
| compound (I-2) + cyflumetofen | 4 + 4 | 100 | 70 |
| (72) (1:1) | | | |
| according to the invention | | | |
| diafenthiuron (76) | 0.8 | 0 | |
| | | found* | calc.** |
| compound (I-2) + diafenthiuron | 0.8 + 0.8 | 90 | 30 |
| (76) (1:1) | | | |
| according to the invention | | | |
| fenpyroximate (65) | 0.8 | 0 | |
| | | found* | calc.** |
| compound (I-2) + fenpyroximate | 0.8 + 0.8 | 90 | 30 |
| (65) (1:1) | | | |
| according to the invention | | | |
| pyridaben (66) | 0.8 | 0 | |
| | | found* | calc.** |
| compound (I-2) + pyridaben | 0.8 + 0.8 | 90 | 30 |
| (66) (1:1) | | | |
| according to the invention | | | |
| tebufenpyrad (64) | 0.8 | 0 | |
| | | found* | calc.** |
| compound (I-2) + tebufenpyrad | 0.8 + 0.8 | 80 | 30 |
| (64) (1:1) | | | |
| according to the invention | | | |
| amitraz (86) | 0.8 | 0 | |
| | | found* | calc.** |
| compound (I-2) + amitraz | 0.8 + 0.8 | 90 | 30 |
| (86) (1:1) | | | |
| according to the invention | | | |
| chlorfenapyr (92) | 0.8 | 0 | |
| | | found* | calc.** |
| compound (I-2) + chlorfenapyr | 0.8 + 0.8 | 90 | 30 |
| (92) (1:1) | | | |
| according to the invention | | | |
| cyromazine (43) | 0.8 | 0 | |
| | | found* | calc.** |
| compound (I-2) + cyromazine | 0.8 + 0.8 | 70 | 30 |
| (43) (1:1) | | | |
| according to the invention | | | |
| fipronil (50) | 4 | 0 | |
| | | found* | calc.** |
| compound (I-2) + fipronil | 0.8 + 4 | 80 | 30 |
| (50) (1:5) | | | |
| according to the invention | | | |
| compound (55) | 0.16 | 0 | |
| | | found* | calc.** |
| compound (I-2) + compound | 0.8 + 0.16 | 80 | 30 |
| (55) (5:1) | | | |
| according to the invention | | | |
| flubendiamide (54) | 0.8 | 0 | |
| | | found* | calc.** |
| compound (I-2) + flubendiamide | 0.8 + 0.8 | 70 | 30 |
| (54) (1:1) | | | |
| according to the invention | | | |
| Rynaxapyr (56) | 0.16 | 0 | |
| | | found* | calc.** |
| compound (1-2) + Rynaxapyr | 0.8 + 0.16 | 80 | 30 |
| (56) (5:1) | | | |
| according to the invention | | | |
| methoxyfenozide (44) | 0.8 | 0 | |
| | | found* | calc.** |
| compound (I-2) + | 0.8 + 0.8 | 90 | 30 |
| methoxyfenozide (44) (1:1) | | | |
| according to the invention | | | |
| lufenuron (34) | 0.8 | 0 | |
| | | found* | calc.** |
| compound (I-2) + lufenuron | 0.8 + 0.8 | 80 | 30 |
| (34) (1:1) | | | |
| according to the invention | | | |
| triflumuron (36) | 4 | 0 | |
| | | found* | calc.** |
| compound (I-2) + triflumuron | 4 + 4 | 100 | 70 |
| (36) (1:1) | | | |
| according to the invention | | | |

*found = activity found
**calc. = activity calculated using Colby's formula

### EXAMPLE D

Nilaparvata lugens Test

| | |
|---|---|
| solvent: | 7 parts by weight of dimethylformamide |
| emulsifier: | 2 parts by weight of alkylaryl polyglycol ether |

To produce a suitable preparation of active compound, 1 part by weight of active compound is mixed with the stated amounts of solvent and emulsifier, and the concentrate is diluted with emulsifier-containing water to the desired concentration.

Rice plants (Oryza sativa) are treated by spraying with the active compound preparation of the desired concentration and are populated with brown plant hoppers (Nilaparvata lugens) while the leaves are still moist.

After the desired period of time, the kill in % is determined. 100% means that all brown plant hoppers have been killed; 0% means that none of the brown plant hoppers have been killed. The kill rates determined are entered into Colby's formula.

In this test, for example, the following active compound combinations in accordance with the present application show a synergistically enhanced activity compared to the active compounds applied individually:

TABLE D-1
Nilaparvata lugens test

| | Concentration | Kill | |
|---|---|---|---|
| Active compound | in g/ha | in % after 6^{d} | |
| compound (I-2) | 0.8 | 0 | |
| buprofezin (42) | 0.8 | 10 | |
| | | found* | calc.** |
| compound (I-2) + buprofezin (42) | 0.8 + 0.8 | 65 | 10 |
| (1:1) | | | |
| according to the invention | | | |

*found = activity found
**calc. = activity calculated using Colby's formula

### EXAMPLE E

### Phaedon cochleariae Larvae Test

| | |
|---|---|
| solvents: | 78 parts by weight of acetone |
| | 1.5 parts by weight of dimethylformamide |
| emulsifier: | 0.5 part by weight of alkylaryl polyglycol ether |

To produce a suitable preparation of active compound, 1 part by weight of active compound is mixed with the stated amounts of solvents and emulsifier, and the concentrate is diluted with emulsifier-containing water to the desired concentration.

Cabbage leaves (Brassica oleracea) are treated by spraying with the active compound preparation of the desired concentration and are populated with larvae of the mustard beetle (Phaedon cochleariae) while the leaves are still moist.

After the desired period of time, the kill in % is determined. 100% means that all beetle larvae have been killed; 0% means that none of the beetle larvae have been killed. The kill rates determined are entered into Colby's formula.

In this test, for example, the following active compound combinations in accordance with the present application show a synergistically enhanced activity compared to the active compounds applied individually:

TABLE E-1
Phaedon cochleariae larvae test

| | Concentration | Kill | |
|---|---|---|---|
| Active compound | in g/ha | in % after 2^{d} | |
| compound (I-2) | 100 | 17 | |
| | 20 | 0 | |
| methamidophos (113) | 100 | 0 | |
| | | found* | calc.** |
| compound (I-2) + methamidophos | 100 + 100 | 67 | 17 |
| (113) (1:1) | | | |
| according to the invention | | | |
| thiacloprid (28) | 4 | 0 | |
| | | found* | calc.** |
| compound (I-2) + thiacloprid | 100 + 4 | 50 | 17 |
| (28) (25:1) | | | |
| according to the invention | | | |
| triflumuron (36) | 20 | 17 | |
| | | found* | calc.** |
| compound (I-2) + triflumuron | 20 + 20 | 50 | 17 |
| (36) (1:1) | | | |
| according to the invention | | | |
| pyridaben (66) | 20 | 33 | |
| | | found* | calc.** |
| compound (I-2) + pyridaben | 20 + 20 | 50 | 33 |
| (66) (1:1) | | | |
| according to the invention | | | |

TABLE E-2

| | Concentration | Kill | |
|---|---|---|---|
| Active compound | in g/ha | in % after 6^{d} | |
| compound (I-2) | 100 | 17 | |
| | 20 | 0 | |
| | 4 | 0 | |
| | 0.8 | 0 | |
| alpha-cypermethrin (2) | 0.8 | 0 | |
| | | found* | calc.** |
| compound (I-2) + alpha- | 20 + 0.8 | 67 | 0 |
| cypermethrin (2) (25:1) | | | |
| according to the invention | | | |
| beta-cyfluthrin (3) | 0.8 | 17 | |
| | | found* | calc.** |
| compound (I-2) + beta-cyfluthrin | 20 + 0.8 | 83 | 17 |
| (3) (25:1) | | | |
| according to the invention | | | |
| cypermethrin (5) | 4 | 67 | |
| | | found* | calc.** |
| compound (I-2) + cypermethrin | 20 + 4 | 83 | 67 |
| (5) (5:1) | | | |
| according to the invention | | | |
| deltamethrin (6) | 0.8 | 50 | |
| | | found* | calc.** |
| compound (I-2) + deltamethrin | 20 + 0.8 | 100 | 50 |
| (6) (25:1) | | | |
| according to the invention | | | |
| esfenvalerate (7) | 4 | 83 | |
| | | found* | calc.** |
| compound (I-2) + esfenvalerate | 100 + 4 | 100 | 85.89 |
| (7) (25:1) | | | |
| according to the invention | | | |
| L-cyhalothrin (12a) | 0.16 | 0 | |
| | | found* | calc.** |
| compound (I-2) + L-cyhalothrin | 4 + 0.16 | 33 | 0 |
| (12a) (25:1) | | | |
| according to the invention | | | |
| acetamiprid (25) | 0.8 | 0 | |
| | | found* | calc.** |
| compound (I-2) + acetamiprid | 20 + 0.8 | 17 | 0 |
| (25) (25:1) | | | |
| according to the invention | | | |
| spinosad (79) | 0.8 | 0 | |
| | | found* | calc.** |
| compound (I-2) + spinosad | 4 + 0.8 | 50 | 0 |
| (79) (5:1) | | | |
| according to the invention | | | |
| diafenthiuron (76) | 20 | 0 | |
| | | found* | calc.** |
| compound (I-2) + diafenthiuron | 20 + 20 | 33 | 0 |
| (76) (1:1) | | | |
| according to the invention | | | |
| amitraz (86) | 100 | 0 | |
| | | found* | calc.** |
| compound (I-2) + amitraz | 100 + 100 | 33 | 17 |
| (86) (1:1) | | | |
| according to the invention | | | |
| buprofezin (42) | 100 | 0 | |
| | | found* | calc.** |
| compound (I-2) + buprofezin | 100 + 100 | 50 | 17 |
| (42) (1:1) | | | |
| according to the invention | | | |
| endosulfan (49) | 20 | 33 | |
| | | found* | calc.** |
| compound (I-2) + endosulfan | 20 + 20 | 67 | 33 |
| (49) (1:1) | | | |
| according to the invention | | | |
| pyriproxifen (90) | 100 | 0 | |
| | | found* | calc.** |
| compound (I-2) + pyriproxifen | 100 + 100 | 67 | 17 |
| (90) (1:1) | | | |
| according to the invention | | | |
| methiocarb (110) | 4 | 0 | |
| | | found* | calc.** |
| compound (I-2) + methiocarb | 4 + 4 | 83 | 0 |
| (110) (1:1) | | | |
| according to the invention | | | |
| thiodicarb (111) | 100 | 0 | |
| | | found* | calc.** |
| compound (I-2) + thiodicarb | 100 + 100 | 50 | 17 |
| (111) (1:1) | | | |
| according to the invention | | | |
| cyromazine (43) | 100 | 0 | |
| | | found* | calc.** |
| compound (I-2) + cyromazine | 100 + 100 | 50 | 17 |
| (43) (1:1) | | | |
| according to the invention | | | |
| pymetrozine (88) | 100 | 0 | |
| | | found* | calc.** |
| compound (I-2) + pymetrozine | 100 + 100 | 67 | 17 |
| (88) (1:1) | | | |
| according to the invention | | | |
| spirodiclofen (96) | 100 | 0 | |
| | | found* | calc.** |
| compound (I-2) + spirodiclofen | 100 + 100 | 67 | 17 |
| (96) (1:1) | | | |
| according to the invention | | | |
| spirotetramat (98) | 20 | 50 | |
| | | found* | calc.** |
| compound (I-2) + spirotetramat | 20 + 20 | 67 | 50 |
| (98) (1:1) | | | |
| according to the invention | | | |
| compound (55) | 0.8 | 0 | |
| | | found* | calc.** |
| compound (I-2) + compound | 4 + 0.8 | 50 | 0 |
| (55) (5:1) | | | |
| according to the invention | | | |
| Cyazypyr (57) | 0.16 | 0 | |
| | | found* | calc.** |
| compound (I-2) + Cyazypyr | 0.8 + 0.16 | 33 | 0 |
| (57) (5:1) | | | |
| according to the invention | | | |
| flubendiamide (54) | 20 | 0 | |
| | | found* | calc.** |
| compound (I-2) + flubendiamide | 20 + 20 | 33 | 0 |
| (54) (1:1) | | | |
| according to the invention | | | |
| flufenoxuron (38) | 4 | 0 | |
| | | found* | calc.** |
| compound (I-2) + flufenoxuron | 4 + 4 | 33 | 0 |
| (38) (1:1) | | | |
| according to the invention | | | |
| novaluron (37) | 4 | 83 | |
| | | found* | calc.** |
| compound (I-2) + novaluron | 4 + 4 | 100 | 83 |
| (37) (1:1) | | | |
| according to the invention | | | |

*found = activity found
**calc. = activity calculated using Colby's formula

### EXAMPLE F

Spodoptera frugiperda Larvae Test

| | |
|---|---|
| solvents: | 78 parts by weight of acetone |
| | 1.5 parts by weight of dimethylformamide |
| emulsifier: | 0.5 part by weight of alkylaryl polyglycol ether |

To produce a suitable preparation of active compound, 1 part by weight of active compound is mixed with the stated amounts of solvents and emulsifier, and the concentrate is diluted with emulsifier-containing water to the desired concentration.

Cabbage leaves (Brassica oleracea) are treated by spraying with the active compound preparation of the desired concentration and are populated with larvae of the army worm (Spodoptera frugiperda) while the leaves are still moist.

After the desired period of time, the kill in % is determined. 100% means that all caterpillars have been killed; 0% means that none of the caterpillars have been killed. The kill rates determined are entered into Colby's formula.

In this test, for example, the following active compound combinations in accordance with the present application show a synergistically enhanced activity compared to the active compounds applied individually:

TABLE F-1
Spodoptera frugiperda larvae test

| | Concentration | Kill | |
|---|---|---|---|
| Active compound | in g/ha | in % after 2^{d} | |
| compound (I-2) | 100 | 0 | |
| | 20 | 0 | |
| | 4 | 0 | |
| alpha-cypermethrin (2) | 0.8 | 33 | |
| | | found* | calc.** |
| compound (I-2) + alpha- | 20 + 0.8 | 83 | 33 |
| cypermethrin (2) (25:1) | | | |
| according to the invention | | | |
| gamma-cyhalothrin (12b) | 0.032 | 5 | |
| | | found* | calc.** |
| compound (I-2) + gamma- | 4 + 0.032 | 40 | 5 |
| cyhalothrin (12b) (125:1) | | | |
| according to the invention | | | |
| lufenuron (34) | 100 | 0 | |
| | | found* | calc.** |
| compound (I-2) + lufenuron | 100 + 100 | 50 | 0 |
| (34) (1:1) | | | |
| according to the invention | | | |
| methamidophos (113) | 100 | 67 | |
| | | found* | calc.** |
| compound (I-2) + methamidophos | 100 + 100 | 100 | 67 |
| (113) (1:1) | | | |
| according to the invention | | | |
| spinosad (79) | 0.8 | 0 | |
| | | found* | calc.** |
| compound (I-2) + spinosad | 4 + 0.8 | 50 | 0 |
| (79) (5:1) | | | |
| according to the invention | | | |

TABLE F-2

| | Concentration | Kill | |
|---|---|---|---|
| Active compound | in g/ha | in % after 6^{d} | |
| compound (I-2) | 100 | 0 | |
| | 20 | 0 | |
| | 4 | 0 | |
| | 0.8 | 0 | |
| | 0.16 | 0 | |
| acephate (112) | 20 | 33 | |
| | | found* | calc.** |
| compound (I-2) + acephate (112) | 20 + 20 | 67 | 33 |
| (1:1) | | | |
| according to the invention | | | |
| bifenthrin (18) | 0.8 | 0 | |
| | | found* | calc.** |
| compound (I-2) + bifenthrin | 20 + 0.8 | 33 | 0 |
| (18) (25:1) | | | |
| according to the invention | | | |
| cypermethrin (5) | 0.8 | 17 | |
| | | found* | calc.** |
| compound (I-2) + cypermethrin | 4 + 0.8 | 33 | 17 |
| (5) (5:1) | | | |
| according to the invention | | | |
| L-cyhalothrin (12a) | 4 | 50 | |
| | | found* | calc.** |
| compound (I-2) + L-cyhalothrin | 100 + 4 | 83 | 50 |
| (12a) (25:1) | | | |
| according to the invention | | | |
| indoxacarb (94) | 4 | 0 | |
| | | found* | calc.** |
| compound (I-2) + indoxacarb | 0.8 + 4 | 80 | 0 |
| (94) (1:5) | | | |
| according to the invention | | | |
| compound (55) | 0.8 | 50 | |
| | | found* | calc.** |
| compound (I-2) + compound | 4 + 0.8 | 100 | 50 |
| (55) (5:1) | | | |
| according to the invention | | | |
| flubendiamide (54) | 0.8 | 0 | |
| | | found* | calc.** |
| compound (I-2) + flubendiamide | 0.8 + 0.8 | 33 | 0 |
| (54) (1:1) | | | |
| according to the invention | | | |
| spirotetramat (98) | 20 | 0 | |
| | | found* | calc.** |
| compound (I-2) + spirotetramat | 20 + 20 | 50 | 0 |
| (98) (1:1) | | | |
| according to the invention | | | |
| thiodicarb (111) | 4 | 67 | |
| | | found* | calc.** |
| compound (I-2) + thiodicarb (111) | 4 + 4 | 100 | 67 |
| (1:1) | | | |
| according to the invention | | | |
| triflumuron (36) | 0.16 | 0 | |
| | | found* | calc.** |
| compound (I-2) + triflumuron | 0.16 + 0.16 | 50 | 0 |
| (36) (1:1) | | | |
| according to the invention | | | |

*found = activity found
**calc. = activity calculated using Colby's formula

### EXAMPLE G

Tetranychus urticae Test (OP-Resistant/Spray Treatment)

| | |
|---|---|
| solvents: | 78 parts by weight of acetone |
| | 1.5 parts by weight of dimethylformamide |
| emulsifier: | 0.5 part by weight of alkylaryl polyglycol ether |

To produce a suitable preparation of active compound, 1 part by weight of active compound is mixed with the stated amounts of solvents and emulsifier, and the concentrate is diluted with emulsifier-containing water to the desired concentration.

Disks of bean leaves (Phaseolus vulgaris) which are infested by all stages of the greenhouse red spider mite (Tetranychus urticae) are sprayed with an active compound preparation of the desired concentration.

After the desired period of time, the activity in % is determined. 100% means that all spider mites have been killed; 0% means that none of the spider mites have been killed.

In this test, the following active compound combination in accordance with the present application showed a synergistically enhanced activity compared to the active compounds applied individually:

TABLE G-1
Tetranychus urticae test

| | Concentration | Kill | |
|---|---|---|---|
| Active compound | in g/ha | in % after 2^{d} | |
| compound (I-2) | 100 | 0 | |
| | 4 | 0 | |
| | 0.8 | 0 | |
| amitraz (86) | 4 | 0 | |
| | | found* | calc.** |
| compound (I-2) + amitraz (86) | 4 + 4 | 40 | 0 |
| (1:1) | | | |
| according to the invention | | | |
| buprofezin (42) | 100 | 0 | |
| | | found* | calc.** |
| compound (I-2) + buprofezin | 100 + 100 | 30 | 0 |
| (42) (1:1) | | | |
| according to the invention | | | |
| endosulfan (49) | 100 | 0 | |
| | | found* | calc.** |
| compound (I-2) + endosulfan | 100 + 100 | 50 | 0 |
| (49) (1:1) | | | |
| according to the invention | | | |
| fenpyroximate (65) | 0.8 | 10 | |
| | | found* | calc.** |
| compound (I-2) + fenpyroximate | 0.8 + 0.8 | 60 | 10 |
| (65) (1:1) | | | |
| according to the invention | | | |
| flonicamid (89) | 100 | 0 | |
| | | found* | calc.** |
| compound (I-2) + flonicamid | 100 + 100 | 50 | 0 |
| (89) (1:1) | | | |
| according to the invention | | | |

TABLE G-2

| | Concentration | Kill | |
|---|---|---|---|
| Active compound | in g/ha | in % after 6^{d} | |
| compound (I-2) | 100 | 70 | |
| | 20 | 0 | |
| | 4 | 0 | |
| | 0.8 | 0 | |
| acephate (112) | 100 | 0 | |
| | | found* | calc.** |
| compound (I-2) + acephate | 100 + 100 | 90 | 70 |
| (112) (1:1) | | | |
| according to the invention | | | |
| chlorpyrifos (95) | 20 | 0 | |
| | | found* | calc.** |
| compound (I-2) + chlorpyrifos (95) | 20 + 20 | 90 | 0 |
| (1:1) | | | |
| according to the invention | | | |
| methamidophos (113) | 20 | 0 | |
| | | found* | calc.** |
| compound (I-2) + methamidophos | 20 + 20 | 90 | 0 |
| (113) (1:1) | | | |
| according to the invention | | | |
| profenofos (114) | 20 | 0 | |
| | | found* | calc.** |
| compound (I-2) + profenofos | 20 + 20 | 50 | 0 |
| (114) (1:1) | | | |
| according to the invention | | | |
| pyriproxifen (90) | 20 | 0 | |
| | | found* | calc.** |
| compound (I-2) + pyriproxifen | 20 + 20 | 20 | 0 |
| (90) (1:1) | | | |
| according to the invention | | | |
| triazophos (115) | 20 | 0 | |
| | | found* | calc.** |
| compound (I-2) + triazophos | 20 + 20 | 90 | 0 |
| (115) (1:1) | | | |
| according to the invention | | | |
| thiodicarb (111) | 20 | 0 | |
| | | found* | calc.** |
| compound (I-2) + thiodicarb | 20 + 20 | 40 | 0 |
| (111) (1:1) | | | |
| according to the invention | | | |
| alpha-cypermethrin (2) | 0.8 | 0 | |
| | | found* | calc.** |
| compound (I-2) + alpha- | 20 + 0.8 | 50 | 0 |
| cypermethrin (2) (25:1) | | | |
| according to the invention | | | |
| beta-cyfluthrin (3) | 0.8 | 0 | |
| | | found* | calc.** |
| compound (I-2) + beta-cyfluthrin | 20 + 0.8 | 80 | 0 |
| (3) (25:1) | | | |
| according to the invention | | | |
| cypermethrin (5) | 4 | 0 | |
| | | found* | calc.** |
| compound (I-2) + cypermethrin | 20 + 4 | 40 | 0 |
| (5) (5:1) | | | |
| according to the invention | | | |
| deltamethrin (6) | 0.8 | 0 | |
| | | found* | calc.** |
| compound (I-2) + deltamethrin | 20 + 0.8 | 60 | 0 |
| (6) (25:1) | | | |
| according to the invention | | | |
| esfenvalerate (7) | 0.8 | 0 | |
| | | found* | calc.** |
| compound (I-2) + esfenvalerate | 20 + 0.8 | 50 | 0 |
| (7) (25:1) | | | |
| according to the invention | | | |
| dinotefuran (29) | 4 | 0 | |
| | | found* | calc.** |
| compound (I-2) + dinotefuran | 100 + 4 | 90 | 70 |
| (29) (25:1) | | | |
| according to the invention | | | |
| emamectin-benzoate (59) | 0.8 | 65 | |
| | | found* | calc.** |
| compound (I-2) + emamectin- | 4 + 0.8 | 95 | 65 |
| benzoate (59) (5:1) | | | |
| according to the invention | | | |
| indoxacarb (94) | 100 | 0 | |
| | | found* | calc.** |
| compound (I-2) + indoxacarb | 20 + 100 | 90 | 0 |
| (94) (1:5) | | | |
| according to the invention | | | |
| acetamiprid (25) | 0.8 | 0 | |
| | | found* | calc.** |
| compound (I-2) + acetamiprid | 20 + 0.8 | 50 | 0 |
| (25) (25:1) | | | |
| according to the invention | | | |
| clothianidin (30) | 0.8 | 0 | |
| | | found* | calc.** |
| compound (I-2) + clothianidin | 20 + 0.8 | 40 | 0 |
| (30) (25:1) | | | |
| according to the invention | | | |
| imidacloprid (24) | 0.8 | 0 | |
| | | found* | calc.** |
| compound (I-2) + imidacloprid | 20 + 0.8 | 70 | 0 |
| (24) (25:1) | | | |
| according to the invention | | | |
| thiacloprid (28) | 0.8 | 0 | |
| | | found* | calc.** |
| compound (I-2) + thiacloprid | 20 + 0.8 | 60 | 0 |
| (28) (25:1) | | | |
| according to the invention | | | |
| compound (101) | 20 | 0 | |
| | | found* | calc.** |
| compound (I-2) + compound | 20 + 20 | 80 | 0 |
| (101) (1:1) | | | |
| according to the invention | | | |
| spinosad (79) | 4 | 80 | |
| | | found* | calc.** |
| compound (I-2) + spinosad | 20 + 4 | 95 | 80 |
| (79) (5:1) | | | |
| according to the invention | | | |
| cyflumetofen (72) | 4 | 80 | |
| | | found* | calc.** |
| compound (I-2) + cyflumetofen | 4 + 4 | 100 | 80 |
| (72) (1:1) | | | |
| according to the invention | | | |
| diafenthiuron (76) | 0.8 | 30 | |
| | | found* | calc.** |
| compound (I-2) + diafenthiuron | 0.8 + 0.8 | 90 | 30 |
| (76) (1:1) | | | |
| according to the invention | | | |
| pymetrozine (88) | 20 | 0 | |
| | | found* | calc.** |
| compound (I-2) + pymetrozine | 20 + 20 | 30 | 0 |
| (88) (1:1) | | | |
| according to the invention | | | |
| spirotetramat (98) | 4 | 50 | |
| | | found* | calc.** |
| compound (I-2) + spirotetramat | 4 + 4 | 90 | 50 |
| (98) (1:1) | | | |
| according to the invention | | | |
| chlorfenapyr (92) | 4 | 70 | |
| | | found* | calc.** |
| compound (I-2) + chlorfenapyr | 4 + 4 | 99 | 70 |
| (92) (1:1) | | | |
| according to the invention | | | |
| cyromazine (43) | 20 | 0 | |
| | | found* | calc.** |
| compound (I-2) + cyromazine | 20 + 20 | 70 | 0 |
| (43) (1:1) | | | |
| according to the invention | | | |
| ethiprole (51) | 100 | 0 | |
| | | found* | calc.** |
| compound (I-2) + ethiprole | 20 + 100 | 90 | 0 |
| (51) (1:5) | | | |
| according to the invention | | | |
| pyridalyl (99) | 20 | 0 | |
| | | found* | calc.** |
| compound (I-2) + pyridalyl | 20 + 20 | 60 | 0 |
| (99) (1:1) | | | |
| according to the invention | | | |
| compound (104) | 20 | 0 | |
| | | found* | calc.** |
| compound (I-2) + compound | 20 + 4 | 30 | 0 |
| (104) (1:1) | | | |
| according to the invention | | | |
| compound (55) | 4 | 0 | |
| | | found* | calc.** |
| compound (I-2) + compound | 20 + 4 | 90 | 0 |
| (55) (5:1) | | | |
| according to the invention | | | |
| flubendiamide (54) | 20 | 0 | |
| | | found* | calc.** |
| compound (I-2) + flubendiamide | 20 + 20 | 95 | 0 |
| (54) (1:1) | | | |
| according to the invention | | | |
| Rynaxapyr (56) | 4 | 0 | |
| | | found* | calc.** |
| compound (I-2) + Rynaxapyr | 20 + 4 | 80 | 0 |
| (56) (5:1) | | | |
| according to the invention | | | |
| methoxyfenozide (44) | 20 | 0 | |
| | | found* | calc.** |
| compound (I-2) + | 20 + 20 | 70 | 0 |
| methoxyfenozide (44) (1:1) | | | |
| according to the invention | | | |
| flufenoxuron (38) | 20 | 0 | |
| | | found* | calc.** |
| compound (I-2) + flufenoxuron | 20 + 20 | 90 | 0 |
| (38) (1:1) | | | |
| according to the invention | | | |
| lufenuron (34) | 20 | 0 | |
| | | found* | calc.** |
| compound (I-2) + lufenuron | 20 + 20 | 80 | 0 |
| (34) (1:1) | | | |
| according to the invention | | | |
| triflumuron (36) | 20 | 0 | |
| | | found* | calc.** |
| compound (I-2) + triflumuron | 20 + 20 | 60 | 0 |
| (36) (1:1) | | | |
| according to the invention | | | |

*found = activity found
**alc. = activity calculated using Colby's formula

### EXAMPLE H

### Critical Concentration Test/Soil Insects

### Treatment of the Transgenic Plants

| | |
|---|---|
| test insect: | Diabrotica balteata - larvae in the soil |
| solvent: | 7 parts by weight of acetone |
| emulsifier: | 2 parts by weight of alkylaryl polyglycol ether |

To produce a suitable preparation of active compound, 1 part by weight of active compound is mixed with the stated amount of solvent, the stated amount of emulsifier is added and the concentrate is diluted with water to the desired concentration.

The preparation of active compound is poured onto the soil. Here, the concentration of the active compound in the preparation is virtually immaterial, only the amount by weight of active compound per volume unit of soil, which is stated in ppm (mg/l), matters. The soil is filled into 0.25 l pots, and these are allowed to stand at 20° C.

Immediately after the preparation, 5 pre-germinated maize corns of the cultivar YIELD GUARD (trademark of Monsanto Comp., USA) are placed into each pot. After 2 days, the appropriate test insects are placed into the treated soil. After a further 7 days, the efficacy of the active compound is determined by counting the maize plants that have emerged (all plants emerged=100% activity).

### EXAMPLE I

### Heliothis virescens Test

### Treatment of Transgenic Plants

| | |
|---|---|
| solvent: | 7 parts by weight of dimethylformamide |
| emulsifier: | 2 parts by weight of alkylaryl polyglycol ether |

To produce a suitable preparation of active compound, 1 part by weight of active compound is mixed with the stated amount of solvent and the stated amount of emulsifier, and the concentrate is diluted with water to the desired concentration.

Soybean shoots (Glycine max) of the cultivar Roundup Ready (trademark of Monsanto Comp. USA) are treated by spraying with the preparation of active compound of the desired concentration and are populated with the tobacco budworm in Heliothis virescens while the leaves are still moist.

After the desired period of time, the kill of the insects is determined.

### EXAMPLE J

### Myzus persicae Test

### Treatment of Transgenic Plants

| | |
|---|---|
| solvent: | 7 parts by weight of acetone |
| emulsifier: | 2 parts by weight of alkylaryl polyglycol ether |

To produce a suitable preparation of active compound, 1 part by weight of active compound is mixed with the stated amount of solvent and the stated amount of emulsifier, and the concentrate is diluted with water to the desired concentration.

Transgenic cabbage plants (Brassica oleracea) which are heavily infested by the green peach aphid Myzus persicae are treated by spraying with the active compound preparation of the desired concentration.

After the desired period of time, the kill of the insects is determined.

1. Active compound combinations comprising at least one compound of the formula (I) 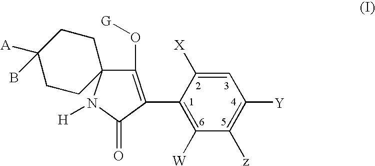
in which
W represents hydrogen, alkyl, alkenyl, alkynyl, halogen, alkoxy, haloalkyl, haloalkoxy or cyano,
X represents halogen, alkyl, alkenyl, alkynyl, alkoxy, haloalkyl, haloalkoxy, nitro or cyano,
Y and Z independently of one another represent hydrogen, alkyl, alkenyl, alkynyl, alkoxy, halogen, haloalkyl, haloalkoxy, cyano or nitro,
A, B and the carbon atom to which they are attached represent five- to seven-membered ketal, thioketal or dithioketal which may optionally be interrupted by a further heteroatom and which is in each case optionally substituted by alkyl, haloalkyl, alkoxy, alkoxyalkyl or optionally substituted phenyl,
G represents hydrogen (a) or represents one of the groups 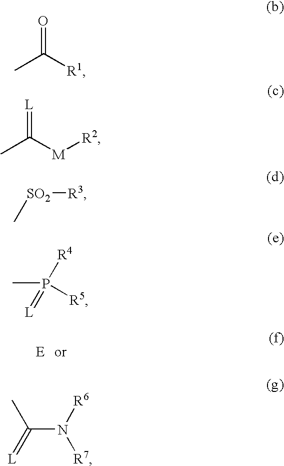
in which
E represents a metal ion or an ammonium ion,
L represents oxygen or sulphur,
M represents oxygen or sulphur,
R¹ represents in each case optionally halogen- or cyano-substituted alkyl, alkenyl, alkoxyalkyl, alkylthioalkyl or polyalkoxyalkyl or represents in each case optionally halogen-, alkyl- or alkoxy-substituted cycloalkyl or heterocyclyl or represents in each case optionally substituted phenyl, phenylalkyl, hetaryl, phenoxyalkyl or hetaryloxyalkyl,
R² represents in each case optionally halogen- or cyano-substituted alkyl, alkenyl, alkoxyalkyl or polyalkoxyalkyl or represents in each case optionally substituted cycloalkyl, phenyl or benzyl,
R³, R⁴ and R⁵ independently of one another represent in each case optionally halogen-substituted alkyl, alkoxy, alkylamino, dialkylamino, alkylthio, alkenylthio or cycloalkylthio or represents in each case optionally substituted phenyl, benzyl, phenoxy or phenylthio,
R⁶ and R⁷ independently of one another represent hydrogen, represent in each case optionally halogen- or cyano-substituted alkyl, cycloalkyl, alkenyl, alkoxy, alkoxyalkyl, represent in each case optionally substituted phenyl or benzyl, or together with the nitrogen atom to which they are attached form an optionally substituted cycle which optionally contains oxygen or sulphur
and one or more further insecticides and/or acaricides of the formula (II):
acetylcholinesterase (AChE) inhibitors II-1
II-1.A carbamates,
alanycarb aldicarb (II-1.A-2), aldoxycarb (II-1.A-3), allyxycarb (II-1.A-4), aminocarb (II-1.A-5), bendiocarb (II-1.A-6), benfuracarb (II-1.A-7), bufencarb (II-1.A-8), butacarb (II-1.A-9), butocarboxim (II-1.A-10), butoxycarboxim (II-1.A-11), carbaryl (II-1.A-12), carbofuran (II-1.A-13), carbosulfan (II-1.A-14), cloethocarb (II-1.A-15), dimetilan (II-1.A-16), ethiofencarb (II-1.A-17), fenobucarb (II-1.A-18), fenothiocarb (II-1.A-19), formetanate (II-1.A-20), furathiocarb (II-1.A-21), isoprocarb (II-1.A-22), metam-sodium (II-1.A-23), methiocarb (II-1.A-24), methomyl (II-1.A-25), metolcarb (II-1.A-26), oxamyl (II-1.A-27), pirimicarb (II-1.A-28), promecarb (II-1.A-29), propoxur (II-1.A-30), thiodicarb (II-1.A-31), thiofanox (II-1.A-32), trimethacarb (II-1.A-33), XMC (II-1.A-34), xylylcarb (II-1.A-35)
II-1.B organophosphates,
acephate (II-1.B-1), azamethiphos (II-1.B-2), azinphos (-methyl, -ethyl) (II-1.B-3), bromophos-ethyl (II-1.B-4), bromfenvinfos (-methyl) (II-1.B-5), butathiofos (II-1.B-6), cadusafos (II-1.B-7), carbophenothion (II-1.B-8), chlorethoxyfos (II-1.B-9), chlorfenvinphos (II-1.B-10), chlormephos (II-1.B-11), chlorpyrifos (-methyl/-ethyl) (II-1.B-12), coumaphos (II-1.B-13), cyanofenphos (H-1.B-14), cyanophos (II-1.B-15), chlorfenvinphos (II-1.B-16), demeton-5-methyl (II-1.B-17), demeton-S-methylsulphone (II-1.B-18), dialifos (II-1.B-19), diazinon (II-1.B-20), dichlofenthion (II-1.B-21), dichlorvos/DDVP (II-1.B-22), dicrotophos (II-1.B-23), dimethoate (II-1.B-24), dimethylvinphos dioxabenzofos (II-1.B-26), disulfoton (H-1.B-27), EPN (II-1.B-28), ethion (II-1.B-29), ethoprophos (H-1.B-30), etrimfos (II-1.B-31), famphur (II-1.B-32), fenamiphos (II-1.B-33), fenitrothion (II-1.B-34), fensulfothion (II-1.B-35), fenthion (II-1.B-36), flupyrazofos (II-1.B-37), fonofos (II-1.B-38), formothion (II-1.B-39), fosmethilan (II-1.B-40), fosthiazate (II-1.B-41), heptenophos (II-1.B-42), iodofenphos (II-1.B-43), iprobenfos (II-1.B-44), isazofos (II-1.B-45), isofenphos (H-1.B-46), isopropyl (II-1.B-47), O-salicylate (II-1.B-48), isoxathion (II-1.B-49), malathion (II-1.B-50), mecarbam (II-1.B-51), methacrifos (II-1.B-52), methamidophos (II-1.B-53), methidathion (II-1.B-54), mevinphos (II-1.B-55), monocrotophos (II-1.B-56), naled (II-1.B-57), omethoate (II-1.B-58), oxydemeton-methyl (II-1.B-59), parathion (-methyl/-ethyl) (II-1.B-60), phenthoate phorate (II-1.B-62), phosalone (II-1.B-63), phosmet (II-1.B-64), phosphamidon (II-1.B-65), phosphocarb (II-1.B-66), phoxim (II-LB-67), pirimiphos (-methyl/-ethyl) (II-1.B-68), profenofos (II-1.B-69), propaphos (II-1.B-70), propetamphos (II-1.B-71), prothiofos (II-1.B-72), prothoate (II-1.B-73), pyraclofos (II-1.B-74), pyridaphenthion (II-1.B-75), pyridathion (II-1.B-76), quinalphos (II-1.B-77), sebufos (II-1.B-78), sulfotep (II-1.B-79), sulprofos (II-1.B-80), tebupirimfos (II-1.B-81), temephos (II-1.B-82), terbufos (II-1.B-83), tetrachlorvinphos (II-1.B-84), thiometon (II-1.B-85), triazophos (II-1.B-86), triclorfon (II-LB-87), vamidothion (II-1.B-88)
antagonists of GABA-gated chloride channels II-2
II-2A organochlorines,
camphechlor (II-2A-1), chlordane (II-2A-2), endosulfan (II-2A-3), gamma-HCH (II-2A-4), HCH (II-2A-5), heptachlor (II-2A-6), lindane (II-2A-7), methoxychlor (II-2A-8)
II-2B fiproles (phenylpyrazoles),
acetoprole (II-2B-1), ethiprole (II-2B-2), fipronil (II-2B-3), pyrafluprole (II-2B-4), pyriprole (II-2B-5), vaniliprole (II-2B-6)
sodium channel modulators/blockers of voltage-gated sodium channels II-3
II-3 pyrethroids,
acrinathrin (II-3-1), allethrin (d-cis-trans, d-trans) (II-3-2), beta-cyfluthrin (II-3-3), bifenthrin (II-3-4), bioallethrin (II-3-5), bioallethrin S-cyclopentyl isomer (II-3-6), bioethanomethrin (II-3-7), biopermethrin (II-3-8), bioresmethrin (II-3-9), chlovaporthrin (II-3-10), cis-cypermethrin (II-3-11), cis-resmethrin (II-3-12), cis-permethrin (II-3-13), clocythrin (II-3-14), cycloprothrin (II-3-15), cyfluthrin (II-3-16), cyhalothrin (II-3-17), cypermethrin (alpha-, beta-, theta-, zeta-)(II-3-18), cyphenothrin (II-3-19), deltamethrin (II-3-20), empenthrin (1R isomer) (II-3-21), esfenvalerate (II-3-22), etofenprox (II-3-23), fenfluthrin (II-3-24), fenpropathrin (II-3-25), fenpyrithrin (II-3-26), fenvalerate (II-3-27), flubrocythrinate (II-3-28), flucythrinate (II-3-29), flufenprox (II-3-30), flumethrin (II-3-31), fluvalinate (II-3-32), fubfenprox (II-3-33), gamma-cyhalothrin (II-3-34), imiprothrin (II-3-35), kadethrin (II-3-36), lambda-cyhalothrin (II-3-37), metofluthrin (II-3-38), permethrin (cis-, trans-) (II-3-39), phenothrin (1R-trans isomer) (II-3-40), prallethrin (II-3-41), profluthrin (II-3-42), protrifenbute (II-3-43), pyresmethrin (II-3-44), resmethrin (II-3-45), RU 15525 (II-3-46), silafluofen (II-3-47), tau-fluvalinate (II-3-48), tefluthrin (II-3-49), terallethrin (II-3-50), tetramethrin (−1R isomer) (II-3-51), tralomethrin (II-3-52), transfluthrin (II-3-53), ZXI 8901 (II-3-54), pyrethrin (pyrethrum) (II-3-55), eflusilanate (II-3-56), DDT (II-3-57), methoxychlor (II-3-58),
agonists/antagonists of the nicotinergic acetylcholine receptor II-4
II-4A chloronicotinyls,
acetamiprid (II-4A-1), clothianidin (II-4A-2), dinotefuran (II-4A-3), imidacloprid (II-4A-4), imidaclothiz (II-4A-5), nitenpyram (II-4A-6), nithiazine (II-4A-7), thiacloprid (II-4A-8), thiamethoxam (II-4A-9), 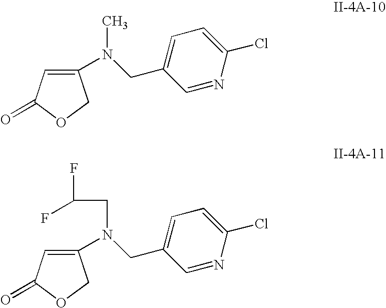
II-4B nicotine (II-4B-1), bensultap (II-4B-2), cartap (II-4B-3), thiosulfap-sodium (II-4B-4), thiocylam (II-4C-4)
allosteric modulators of the acetylcholine receptor (agonists)
II-5 spinosyns,
spinosad (II-5-1), spinetoram (II-5-2)
chloride channel activators
II-6 mectins/macrolides,
abamectin (II-6-1), emamectin (II-6-2), emamectin-benzoate (II-6-3), ivermectin (II-6-4), lepimectin (II-6-5), milbemectin (II-6-6)
II-7A juvenile hormone analogues,
hydroprene (II-7A-1), kinoprene (II-7A-2), methoprene (II-7A-3), epofenonane (II-7A-4), triprene (II-7A-5), fenoxycarb (II-7B-1),
pyriproxifen (II-7C-1), diofenolan (II-7C-2)
active compounds having unknown or non-specific mechanisms of action
II-8 fumigants,
methylbromide (II-8A-1), chloropicrin (II-8B-1), sulphuryl fluoride (II-8C-1)
II-9 selective antifeedants,
cryolite (II-9A-1), pymetrozine (II-9B-1), NNI0101 (II-9B-2), flonicamid (II-9C-1)
II-10 mite growth inhibitors
clofentezine (II-10A-1), hexythiazox (II-10A-2), etoxazole (II-10B-1)
inhibitors of oxidative phosphorylation, ATP disruptors II-12
II-12A diafenthiuron (II-12A-1)
II-12B organotin compounds,
azocyclotin (II-12B-1), cyhexatin (II-12B-2), fenbutatin oxide (II-12B-3)
II-12C propargite (II-12C-1), tetradifon (II-12C-2)
decouplers of oxidative phosphorylation by interruption of the H-proton gradient II-13
chlorfenapyr (II-13-1)
binapacyrl (II-13-2), dinobuton (II-13-3), dinocap (II-13-4), DNOC (II-13-5)
microbial disruptors of the insect gut membrane
Bacillus thuringiensis strains (II-13-6)
inhibitors of chitin biosynthesis
II-15 benzoylureas,
bistrifluoron (II-15-1), chlorfluazuron (II-15-2), diflubenzuron (II-15-3), fluazuron (II-15-4), flucycloxuron (II-15-5), flufenoxuron (II-15-6), hexaflumuron (II-15-7), lufenuron (II-15-8), novaluron (II-15-9), noviflumuron (II-15-10), penfluoron (II-15-11), teflubenzuron (II-15-12), triflumuron (II-15-13)
II-16 buprofezin (II-16-1)
moulting disruptors cyromazine (II-17-1)
ecdysone agonists/disruptors (II-18)
II-18A diacylhydrazines,
chromafenozide (II-18A-1), halofenozide (II-18A-2), methoxyfenozide (II-18A-3), tebufenozide (II-18A-4), JS-118 (II-18A-5)
azadirachtin (II-18B-1)
octopaminergic agonists
amitraz (II-19-1)
II-20 site III electron transport inhibitors/site II electron transport inhibitors
hydramethylnon (II-20A-1)
acequinocyl (II-20B-1)
fluacrypyrim (II-20C-1)
cyflumetofen (II-20D-1), cyenopyrafen (II-20D-2)
electron transport inhibitors
II-21 site I electron transport inhibitors
from the group of the METI acaricides,
fenazaquin (II-21-1), fenpyroximate (II-21-2), pyrimidifen (II-21-3), pyridaben (II-21-4), tebufenpyrad (II-21-5), tolfenpyrad (II-21-6), rotenone (II-21-7)
II-22 blockers of voltage-gated sodium channels
indoxacarb (II-22A-1)
metaflumizone (BAS 3201) (II-22B-1)
II-23 inhibitors of fatty acid biosynthesis
II-23A tetronic acid derivatives
spirodiclofen (II-23A-1), spiromesifen (II-23A-2)
II-23B tetramic acid derivatives,
spirotetramat (II-23B-1)
II-25 neuronal inhibitors having an unknown mechanism of action
bifenazate (II-25-1)
ryanodine receptor effectors
II-28 diamides,
flubendiamide (II-28-1), 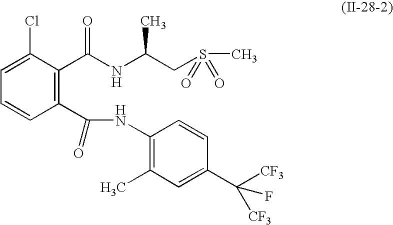
chlorantraniliprole (Rynaxapyr) (II-28-3), Cyazypyr 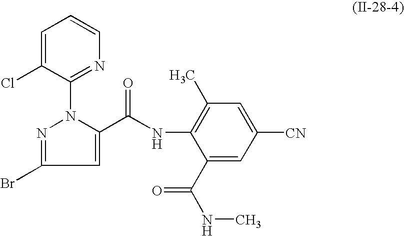
II-29 active compounds having an unknown mechanism of action
amidoflumet (II-29-1), benclothiaz (II-29-2), benzoximate (II-29-3), bromopropylate (II-29-4), buprofezin (II-29-5), chinomethionat (II-29-6), chlordimeform (II-29-7), chlorobenzilate (II-29-8), clothiazoben (II-29-9), cycloprene (II-29-10), dicofol (II-29-11), dicyclanil (II-29-12), fenoxacrim (II-29-13), fentrifanil (II-29-14), flubenzimine (II-29-15), flufenerim (II-29-16), flutenzin (II-29-17), gossyplure (II-29-18), japonilure (II-29-19), metoxadiazone (II-29-20), petroleum (II-29-21), potassium oleate (II-29-22), pyridalyl (II-29-23), sulfluramid (II-29-24), tetrasul (II-29-25), triarathene (II-29-26), verbutin (II-29-27), 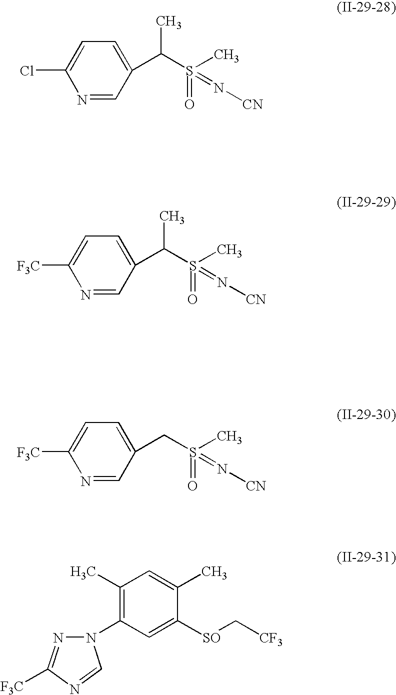
II-30 microbial disruptors of the insect gut membrane
II-30-1 Bacillus thuringiensis strains.

2. Active compound combinations according to claim 1, comprising at least one compound of the formulae (I-1), (I-2), (I-3), (I-4), (I-5), (I-6).

3. Use of active compound combinations as defined in claim 1 for controlling animal pests.

4. Method for controlling animal pests, characterized in that active compound combinations as defined in claim 1 are allowed to act on animal pests and/or their habitat.

5. Process for preparing insecticidal and/or acaricidal compositions, characterized in that active compound combinations as defined in claim 1 are mixed with extenders and/or surfactants.

6. Compositions comprising active compound combinations as defined in claim 1 for controlling animal pests.
